(19) United States
(12) Patent Application Publication
(10) Pub. No.: US 2006/0064223 A1
(43) Pub. Date: Mar. 23, 2006

(54) Vehicle systems and method

(76) Inventor: Darrell Voss, Vancouver, WA (US)

Correspondence Address: Law Office of Jim Zegeer, Suite 108, 801 North Pitt Street, Alexandria, VA, 22314, US

(21) Appl. No.: 11/228,473

(22) Filed: Sep. 19, 2005

Related U.S. Application Data
(60) Provisional application No. 60/610,944, filed on Sep. 20, 2004.
(60) Provisional application No. 60/622,846, filed on Oct. 29, 2004.

(51) Int. Cl. G06F 17/00

(52) U.S. Cl. 701/52

(57) ABSTRACT

A multiple parameter control system for a vehicle includes sensors to measure the control parameter shifts in relation to the vehicle, a controller to determine outputs, a dynamically adjustable vehicle system with controllable functions, and a power supply. The sensors measure the control parameter shifts and create representative input signals that are sent to the controller. The controller determines the appropriate outputs in response to the relative control parameter shift input signals received. The dynamically adjustable vehicle system with controllable functions receives the controller output and performs a dynamic control function adjustment to improve a vehicle ride characteristic.

### REFERENCE TO RELATED APPLICATION

The present application claims the priority of provisional application No. 60/610,944 filed Sep. 20, 2004 entitled BICYCLE SYSTEMS AND METHOD.

The present application is related to pending application Ser. No. 10/113,931, filed Apr. 2, 2002 entitled VEHICLES AND METHODS USING CENTER OF GRAVITY AND MASS SHIFT CONTROL SYSTEM and to provisional application No. 60/622,846 filed Oct. 29, 2004 entitled METHODS FOR MANUFACTURING A GEAR and RESULTING GEAR PRODUCTS.

The present application is also related to an application filed Sep. 19, 2005 by the same inventor entitled TRANSMISSION SYSTEM AND METHOD.

### BACKGROUND OF THE INVENTION

1. Field of the Invention

This invention relates to vehicles, specifically to improve user and/or payload ride characteristics by using a multiple parameter control system to make adjustments to two or more attached dynamically controllable vehicle functions such as geometry adjust and suspension functions.

2. Description of the Prior Art

Prior art has focused on controlling the vehicle characteristics by making static or passive adjustments to the vehicle operating systems. Vehicle operating systems are described as steering systems, braking systems, suspension systems, power systems, transmission systems, power storage systems, geometry adjustment systems, lighting systems, information systems, and safety systems. A majority of prior art systems make changes to the vehicle operating system prior to operation and are not possible to adjust during operation of the vehicle. The prior art vehicle operating systems of steering and braking have minimal controls except for brake/suspension fork attachment arms or discs to prevent anti-dive. Geometry adjustable features have been primarily limited to small manual changes in attached components—adjustable stem angles, multiple mounting holes on frames for shock mounts, such as U.S. Pat. No. 5,285,697 Clausen, and U.S. Pat. No. 5,253,544 Allsop et al. Another example is U.S. Pat. No. 6,688,626 Felsl, which notes an adjustable height device for a suspension system. The system is a pre-set system and does not allow for separation of controllable geometry adjust and suspension functions.

Motorcycle ride height setups for road-off-road and for mounting-dismounting have been developed to make static position changes that are controlled while the vehicle is not moving. U.S. Pat. No. 6,708,803 Jensen discloses a “gravity” valve in a self-contained suspension device without a controllable interface used as a “self-leveling” suspension device for a multi-wheeled vehicle noted as a dual spring rate device. Prior art has focused on the effect the regular and irregular surfaces of the ground has on the vehicle and thus to the user through the vehicle to user contact points. Prior art focuses on adjusting the vehicle systems alignment to the ground to reduce abrupt changes in position of the vehicle to user contact points. Prior art attempts to directly control the user by indirect methods.

Prior art consists of motorcycle, bicycle and similar vehicles, designs that react after contacting an irregular surface in the vehicle path by releasing stored energy in suspension systems. Examples are the bicycle suspension systems disclosed in U.S. Pat. No. 4,881,750 Hartmann, U.S. Pat. Nos. 5,445,401 and 5,509,677 to Bradbury, U.S. Pat. Nos. 5,456,480 and 5,580,075 to Turner et al. The prior suspension systems during use are preset and not adjustable so these are considered passive or static suspension systems. The suspension may be too harsh or too soft for the surface conditions.

Prior art consists of motorcycle and bicycle suspension designs that react to the contact of an irregular surface, such as a suspension system with an inertia valve disclosed in U.S. Pat. Nos. 6,267,400 and 6,722,678 to McAndrews. Prior art designs controlled by measuring the rate of travel or the distance traveled by the device itself and are not measuring parameters related to the user. Examples are the front bicycle suspension shocks that operate valves based on the speed of the shock piston shaft as disclosed in U.S. Pat. No. 6,026,939 to Girvin and Jones and as disclosed in U.S. Pat. No. 6,149,174 to Bohn. The above-cited systems are considered semi-active systems limited to the switching between two positions of hard and soft.

Prior art consist of designs that measure movement and timing of the suspension device after contacting an irregular surface then calculate the reaction with a preprogrammed controller that is limited in scope and without user input. Example of this system is disclosed in U.S. Pat. No. 5,911,768 to Sasaki. The above cited system is an active system and yet still limited by the preprogrammed controller.

Prior art of the suspension systems disclosed earlier are based on the relationship of the contact points between the vehicle and the ground, then the vehicle contact points to the passenger/payload are measured last or ignored all together. The range of motion of the user in relationship to the constraints of the vehicle's users contact points has not been considered. Prior art of the control systems disclosed earlier focused on the measurement of the distance traveled or the rate of speed of the suspension devices themselves. The ride characteristics encountered by the user is two systems or linkages away from the attempted control points.

Prior art active suspension systems based on ground induced input systems are not active in relationship to the actual user position. All the prior active systems have focused on measuring the velocity or stroke, the travel delta, of the suspension and then creating an output signal. The inputs have been limited to velocity or travel measuring device signals sent to a control circuit that outputs back to the original suspension devices. The advantage of the multi parameter control system controlling the dynamically attached vehicle system controllable functions is the active adjustments improve the relationship of the vehicle ride characteristics in relation to the user.

### SUMMARY OF THE INVENTION

The present invention provides a control system for improving the ride characteristics for a vehicle transporting a user and or payload by:

(a) obtaining from a set of sensors, signals to send information to the control system;

(b) determining from the sensors signal inputs a set of estimated parameter control values in relation to the vehicle;

(c) deriving an output control signal from the control system based on parameter control values; and

(d) applying the output control signal to dynamically adjustable vehicle controllable functions to effect an improvement in vehicle ride characteristics.

The advantages of this control system is the ability to adjust selected controllable functions within a single vehicle operating system and selected controllable functions within two or more vehicle operating systems.

Sensors measure the parameter shift information used by the control system control parameters. The sensors actively measure the control system parameters in relation to the vehicle wherein the sensor signals will be input into the control system to comprise estimated values for output signals. Sensors may be located on the user, in the same manner as a wristwatch, on or in the vehicle, or external to the vehicle. Sensors may be of different forms including but not limited to accelerometers, strain gauges, single axis gyroscopes, multi axis gyroscopes, inclinometers, fluid flow gauges, viscosity gauges, altimeters, humidity sensors, timers, counters, load cells, pressure gauges, rotational gages, positional gages, magnetic devices, optical sensors, laser sensors, sonar sensors, ultrasonic sensors, temperature sensors, infrared sensors, velocity sensors, light emitting diode sensors, Hall's effect magnetic field sensors, vibration gages, temperature gauges, transducers, user input switches, preprogrammed computer programs, voice activated sensors, programmable voice command sensors, and satellite global positioning system sensors. Sensors may be electric or non-electric, wired, and wireless sensor systems are included.

How the Control System Works

The Control System monitors shifts in multiple parameters via sensors, then the control adjusts one or more dynamically adjustable device functions attached to a vehicle to enhance the ride characteristics of the vehicle for the benefit of the user and or payload.

Summary of the Functional Formula:

Sensor Devices [A] monitor shifts in Parameters “Xp1” and “Xp2” and send signals to Control System [B] that outputs commands to attached dynamically adjustable device functions [C] to improve the ride characteristics of vehicle [D].
Step 1: Xp1a-Xp1b shift and Xp2a-Xp2b shift are detected by [A]
Step 2: [A] sends shift values to [B]
Step 3: [B] computes & outputs command signals to [C]
Step 4: [C] dynamically adjusts to modify ride characteristics of [D]

List of Parameter Shifts Capable of Being Sensored:

User or payload mass shift (from reference application), center of gravity of the user or payload shift (from reference application), velocity shifts, terrain and suspension control loop shifts, pre-programmed baseline shifts, angle of inclination of device shifts, angle of inclination of the user shifts, user contact point to vehicle shifts, vehicle frame geometry shifts, interactive dynamic function feedback loop shifts, weather condition shifts, length of operation shifts, group or individual use shifts, ground surface condition shifts, physical training guideline shifts, time shifts; includes seconds, minutes, hours, day of week, and month, torque load shifts, frame load shifts, energy output shifts, braking energy shifts, wheel loading shifts; as in cornering, vehicle geometry shifts, ride height shifts; suspension and or vehicle geometry changes, vibration shifts, training program system shifts, external temperature shifts, internal temperature shifts, light intensity shifts; includes day, night, shade, dusk, and additional parameter shifts that are obviously possible to sensor.

Controllable Functions on Adjustable Devices Examples

Controllable functions of dynamic vehicle operating systems include but are not limited to the following; safety restraint devices, visual safety warning devices, audible safety warning devices, tactile safety warning devices, internal light system devices, external light system devices, frame geometry adjust devices, imaging output devices, drive ratio devices, drive force devices, drive clutch devices, braking system devices, power generation devices, power assist devices, power storage devices, and suspension device functions which include spring rate, spring travel length, damping rate, and damping travel length.

A vehicle transmission system by obtaining from sensors mounted on or off the vehicle to sense control system parameter values. A set of relative parameter control signals based on the determined change in the parameter values can produce signals for a transmission drive ratio device to provide efficient drive ratio shifts. The above vehicle drive ratio system may include manual shifting systems, mechanical indexing systems, hydraulic indexing systems, or automatic control shifting systems.

A vehicle braking system by obtaining from sensors, mounted on or off the vehicle to sense the control system parameter values, a set of relative signals; determine from the set of relative signals a set of parameter values; and control a brake system responsive to the determined set of parameter control signals. The above braking system may utilize leverages from other devices to increase braking control. The braking system may incorporate regenerative energy systems to transfer the heat generated by the braking process into energy usable by other vehicle systems.

A vehicle adjustable geometry system by obtaining from sensors, mounted on or off the vehicle to sense the control system parameter signals; determine from the set of relative signals a set of estimated control system parameters; and control an adjustable vehicle geometry system responsive to the determined set of control system parameters. Adjustable geometry systems may include mechanisms using adjustable rods, eccentric mechanisms, air or hydraulic tubes, ratchet mechanisms, or gear devices. Adjustable geometry systems may be integral to the vehicle frame, mounted on the frame, or mounted on devices external to the frame.

A vehicle adjustable suspension system by obtaining from sensors, mounted on or off the vehicle to sense the control system parameter set of signals, determine from the set of relative signals a set of estimated control system parameter values: and control the adjustable suspension system. Examples: An air system to adjust tire inflation pressures based on control parameter signals, front and rear suspension system controllable functions adjusted and controlled independently and/or in combination with parameter control inputs.

A vehicle power system by obtaining from sensors, mounted on or off the vehicle to sense the control system parameter set of signals; determine from the set of relative signals a set of estimated control system parameter values; and control an adjustable power system responsive to the determined set of estimated control system parameter signals. Vehicle power systems include but are not limited to motor powered devices, comprised of electric, internal combustion, or combinations, or manual devices; including but not limited to manually adjusted pedal, crank, or eccentric drive devices.

A vehicle safety system by obtaining from sensors, mounted on or off the vehicle to sense the control system parameter set of signals; determine from the set of relative signals a set of control system parameter values; and control a safety system responsive to the determined set of control system parameter signals. The above safety system include but are not limited to physical restraint and retention systems, crash activated airbags, power system override devices known as speed governors, warning lights such as maintenance notifications, warning siren, external lights, anti-lock brake circuit, and external cornering wheels.

A vehicle steering control system by obtaining from sensors, mounted on or off the vehicle to sense the control system parameters, a set of control system parameter value signals; determine from the set of relative signals a set of estimated control system parameter values; and control a steering control system responsive to the determined set of control system parameter signals.

A vehicle information and data acquisition system by obtaining from sensors, mounted on or off the vehicle to sense the control system parameters, a set of control system parameter signals; determine from the set of relative signals a set of control system parameter values; and control a data acquisition system responsive to the determined set of control system parameter signals. The data acquisition system can be used to develop virtual reality game data, interactivity with group of other units for team or race monitoring, inputs from professional riders for training evaluations, inputs from professional riders for downloading to interactive personal computer programs, and amusement or destination vehicle park interactive packages. The control system has the ability to be an interactive system from many sources:

a) The user is able to input variable data into the base control program (BCG).

b) The control parameter shift sensors on the vehicle can input data into the BCG.

c) The control parameter shift sensors located off the vehicle can input data into the BCG via telemetry. Combinations of these inputs are also possible.

The present invention enables the use of a control system using a control module that has the ability to be preprogrammed, re-programmed, adjusted during use, have multiple programs installed, have program levels that can be changed and upgraded as user skills increase, have a learn mode, an interactive mode with other control modules, and have an indeterminate number of variables available for user selection. The present invention attains an interactive process through the control system controller module to:
enable pre-programmed input data, enable adjusting to interactive data during use, enable for external variables to be considered during operation of the device, establish parameters that can be modified while in use, create parameters based on changing weather, preset parameters for travel or speed limits,
create parameters biased for safety based on ability level of user, monitor parameters that can activate a warning light, safety restraints, and other safety systems, and interface with visual systems including video games, video broadcasting data, video surveillance, and video data acquisition. The control system design also enables the use of multiple control parameter values to control dynamically attached vehicle controllable functions on multiple vehicles interactively during vehicle operation.

The advantages of the control system is to use the control system parameters to control the vehicle systems, regardless of the limitations of the contact points to the vehicle, or the vehicle to ground contact points. Example: A control parameter shift related to the user and/or payload is monitored, user has a free range of motion within the constraints of the contact points to the vehicle, and the vehicle has contact points to a regular or irregular surface. A control system based on two or more control parameter shifts sends outputs to two or more of the vehicle controllable function systems.

Many dynamic applications are possible as the benefits of the control system are applied to novel adjustable device controllable functions.

### BRIEF DESCRIPTION OF THE DRAWINGS

FIG. 1 is a graphical illustration of a simplified control system,

FIG. 2 is a graphical representation of the control system operation formula,

FIG. 3 is a graphical representation of parameters used for control outputs,

FIG. 4 is a block diagram representation of parameter interactions & override control,

FIG. 5 is a graphical illustration of parameter information from control function feedback,

FIG. 6 is a block diagram illustration of sensor types,

FIG. 7-A is a side elevational view of sensors on and around a vehicle (referenced from FIG. 19 of U.S. Nonprovisional patent application Ser. No. 10/113,931—Filed Apr. 2, 2002, Vehicles and Methods Using Center of Gravity and Mass Shift Control System, Inventor: Darrell W. Voss),

FIG. 7-B is a side elevational view of specific sensors on and around a vehicle,

FIG. 7-C is a graphical illustration of sensor locations on a vehicle users' apparel,

FIG. 8 is a graphical representation of manual inputs, including override adjustments,

FIG. 9 is a graphical representation of manual inputs, parameter selectors, and potentiometer examples,

FIG. 10 is a block diagram of control functions descriptions,

FIG. 11 is a graphical representation of control function interaction,

FIG. 12 is a graphical representation of connections list,

FIG. 13 is a graphical representation of power supply types,

FIG. 14 is a graphical representation of a visual display,

FIG. 15 is a side elevational view of controller locations—central, regional, backup, and or multiple,

FIG. 16 is an isometric view of multiple controllers,

FIG. 17 is a graphical representation of control function set with individual controls,

FIG. 18 is a graphical representation of control function with a ratio of individual controls,

FIG. 19 is a graphical representation of control function with individual sets and with a ratio,

FIG. 20 is a graphical representation of control function with individual sets and with a ratio set with minimal parameters,

FIG. 21 is a graphical representation of control function with two sensors and minimal parameters,

FIG. 22 is a graphical representation of a large sensor group for multiple parameters to control functions,

FIG. 23 is a graphical representation of comparative data from vehicle for output to a portable storage device,

FIG. 24 is a graphical representation of comparative interactive game inputs into a control system,

FIG. 25 is a graphical representation of sensor inputs and data from attached devices,

FIG. 26 is a graphical representation of sensor inputs and data from attached devices,

FIG. 27 is a chart representation of sensor inputs and data from attached devices,

FIG. 28 is a block diagram of parameters to multiple control functions,

FIG. 29 is a block diagram of parameters applied to control functions (referenced from FIG. 58 of U.S. Nonprovisional patent application Ser. No. 10/113,931—Filed Apr. 2, 2002, Vehicles and Methods Using Center of Gravity and Mass Shift Control System, Inventor: Darrell W. Voss),

FIG. 30 is a graphical representation of a control board, bus, and multiple control functions,

FIG. 31 is a graphical representation of a control board, bus, and multiple control functions—geometry adjust and spring specific functions,

FIG. 32 is a flow diagram of a control system and housing assembly (referenced from FIG. 16 of U.S. Provisional Patent Application: Ser. No. 60/610,944—Filed Sep. 20, 2004, IMPROVEMENTS IN BICYCLE SYSTEMS AND METHODS, Inventor: Darrell W. Voss),

FIG. 33 is a graphical representation of a read sequence for controller—output data values to two control functions,

FIG. 34 is a graphical representation of a decision tree example for controller and two parameters,

FIG. 35 is a graphical representation of a controller run sequence with manual input,

FIG. 36 is a chart representation of a replay program for second pass alterations,

FIG. 37 is a chart representation of a replay program for comparative to other event,

FIG. 38 is a chart representation of a replay program for comparative to other rider,

FIG. 39 is an isometric view representation of location parameter sensor inputs such as GPS and field sensors,

FIG. 40 is an isometric view representation of a location for an athletic event, dual user racing format, with inputs for controller and output,

FIG. 41 is an isometric view of a location event providing inputs for controller and outputs for media, and spectators,

FIG. 42 is a top elevational view of a topographical chart for a course-race-event route map,

FIG. 43 is a chart representation of an event matrix of route with key measures,

FIG. 44 is a chart representation of a groups usage-team training, team development, team interaction data,

FIG. 45 is a chart representation of a matrix of control functions, categories, vehicles,

FIG. 46 is a graphic illustration of vehicle systems overview defined,

FIG. 47 is a graphic chart of drive ratio data,

FIG. 48 is a representative block diagram of controlled power generation and power storage functions,

FIG. 49 is a graphical illustration of power input control,

FIG. 50 is a block diagram of brake system controllable functions,

FIG. 51-A is a side elevation view of geometrically adjustable dimensions on a bicycle (referenced from FIG. 7 of U.S. Provisional Patent Application: Ser. No. 60/610,944—Filed Sep. 20, 2004, IMPROVEMENTS IN BICYCLE SYSTEMS AND METHODS, Inventor: Darrell W. Voss),

FIG. 51-B is a block diagram of a control system for the control of geometrically adjustable dimensions on a bicycle,

FIG. 52 is an isometric view of bicycle with geometry adjust functions attached,

FIG. 53 is a graphical representation of an un-sprung mass diagram,

FIG. 54-A1 is a multiple control function block diagram,

FIG. 54-A2 is a block diagram of a control system using the multiple control functions of FIG. 42-A1,

FIG. 54-A3 is a multiple control function device block diagram,

FIG. 54-A4 is a block diagram of a control system using the multiple control function devices of FIG. 54-A3,

FIG. 54-B is a multiple control function block diagram of suspension functions,

FIG. 54-C is a multiple control function block diagram of geometry adjust ratios,

FIG. 54-D is a multiple control function block diagram of suspension functions and geometry adjust functions combined,

FIG. 55-A is a graphical illustration of a spring rate control function,

FIG. 55-B is a graphical illustration of a damping rate control function,

FIG. 56 is a chart representation of spring rate control functions,

FIG. 57 is a chart representation of a damping rate control function,

FIG. 58-A is a graphical representation of a spring travel length control function,

FIG. 58-B is a graphical representation of a damping travel length control function,

FIG. 59 is a chart representation of a spring travel length control function,

FIG. 60 is a chart representation of a damping travel length control function,

FIG. 61 is a block diagram of compression control function types,

FIG. 62 is a block diagram of rebound control function types,

FIG. 63 is a graphical illustration of compression and rebound damping rate control functions,

FIG. 64 is a chart representation of compression and rebound rates,

FIG. 65 is a block diagram of compression damping rate control function types,

FIG. 66 is a graphical illustration of rebound damping rate control function types,

FIG. 67 is a graphical illustration of compression and rebound damping length control function,

FIG. 68 is a block diagram of compression and rebound damping length control function types,

FIG. 69-A is a schematic diagram of an air and/or fluid pump system function,

FIG. 69-B is a schematic diagram of simplified open fluid pump system function,

FIG. 69-C is a schematic diagram of a simplified closed air and/or fluid pump system function,

FIG. 69-D is a schematic diagram of a combined open and closed air and/or fluid pump system function,

FIG. 69-E is a side elevational view of a bicycle assembly with a logic control system and with dynamically adjustable functions attached,

FIG. 70 is a block diagram of the control functions for an air and/or fluid pump system,

FIG. 71 is a simplified electrical schematic of a control system,

FIG. 72 is an electrical schematic of a control system for a single central processor,

FIG. 73 is an electrical schematic of a control system using two processors,

FIG. 74 is a block diagram of the control system applicable vehicles,

FIG. 75 is a side elevational view of a road bicycle with dynamically adjustable functions,

FIG. 76 is a side elevational view of a full suspension bicycle with dynamically adjustable functions,

FIG. 77 is a side elevational view of a recumbent bicycle with dynamically adjustable functions (referenced from FIG. 81 of U.S. Nonprovisional patent application: Ser. No. 10/113,931—Filed Apr. 2, 2002, Vehicles and Methods Using Center of Gravity and Mass Shift Control System, Inventor: Darrell W. Voss),

FIG. 78 is a side elevational view of a tandem bicycle with dynamically adjustable functions (referenced from FIG. 82 of U.S. Nonprovisional patent application: Ser. No. 10/113,931—Filed Apr. 2, 2002, Vehicles and Methods Using Center of Gravity and Mass Shift Control System, Inventor: Darrell W. Voss),

FIG. 79 is a side elevational view of a motorcycle with dynamically adjustable functions (referenced from FIG. 72 of U.S. Nonprovisional patent application: Ser. No. 10/113,931—Filed Apr. 2, 2002, Vehicles and Methods Using Center of Gravity and Mass Shift Control System, Inventor: Darrell W. Voss),

FIG. 80-A is an exploded view of geometry adjustable full suspension bicycle,

FIG. 80-B is an exploded view of geometry adjustable full suspension bicycle,

FIG. 81 is a side elevational view of geometry adjustable full suspension bicycle,

FIG. 82 is a side elevational view of rear and front suspension blocks,

FIG. 83 is a side elevational view of vehicle frame with adjustable head tube angle-strut to frame,

FIG. 84 is a side elevational view of vehicle frame with adjustable head tube angle,

FIG. 85 is an isometric view of adjustable seat pillar and rear arm assembly on a bicycle frame,

FIG. 86-A is a side elevational view of adjustable seat pillar and rear arm assembly on a bicycle frame,

FIG. 86-B is a side elevational view of adjustable seat pillar and rear arm assembly on a bicycle frame,

FIG. 87 is an isometric view of adjustable seat pillar and drive assembly on a bicycle frame,

FIG. 88-A is a side elevational view of adjustable seat pillar and drive assembly on a bicycle frame,

FIG. 88-B is a side elevational view of adjustable seat pillar and drive assembly on a bicycle frame,

FIG. 89 is an isometric view of adjustable seat pillar on a bicycle frame,

FIG. 90-A is a side elevational view of an adjustable rear arm assembly and drive assembly on a bicycle,

FIG. 90-B is a side elevational view of an adjustable rear arm assembly and drive assembly on a bicycle,

FIG. 91 is a side elevational view of an adjustable rear arm and with pivot for drive assembly on a bicycle,

FIG. 92-A is a side elevational view of an adjustable seat pillar, rear arm assembly, and drive assembly on a bicycle frame,

FIG. 92-B is an isometric view of a bicycle with a geometry adjustable steering assembly,

FIG. 93-A is an isometric view of a drive assembly with pedals,

FIG. 93-B is an isometric view of a drive assembly with pedals and a motor,

FIG. 93-C is an isometric view of a drive assembly with a motor,

FIG. 94 is a side elevational view of moped vehicle with control system attached,

FIG. 95 is a side elevational view of motorcycle with control system attached,

FIG. 96 is a side elevational view of a small automobile with control system attached, and

FIG. 97 is a block diagram of a power generator control circuit for a vehicle.

FIG. 98-A is a side elevational cross-section view of a dynamically adjustable gas piston/cylinder suspension assembly,

FIG. 98-B is a side elevational cross-section view of a dynamically adjustable gas piston/cylinder suspension assembly,

FIG. 98-C is a side elevational cross-section view of a dynamically adjustable gas piston/cylinder suspension assembly,

FIG. 98-D is a side elevational cross-section view of a dynamically adjustable gas piston/cylinder suspension assembly,

FIG. 99-A is a side elevational cross-section view of a dynamically adjustable fluid piston/cylinder suspension assembly,

FIG. 99-B is a side elevational cross-section view of a dynamically adjustable fluid piston/cylinder suspension assembly,

FIG. 99-C is a side elevational cross-section view of a dynamically adjustable fluid piston/cylinder suspension assembly,

FIG. 99-D is a side elevational cross-section view of a dynamically adjustable fluid piston/cylinder suspension assembly,

FIG. 100 is a side elevational cross-section view of a dynamically adjustable gas and fluid piston/cylinder suspension assembly,

FIG. 101-A is a block diagram of a logic control assembly, and

FIG. 101-B is a block diagram of a logic control assembly.

### DETAILED DESCRIPTION OF THE PREFERRED EMBODIMENT

Referring now to the drawings for the purpose of illustrating a preferred embodiment of the present invention only, and not for purposes of limiting the same:

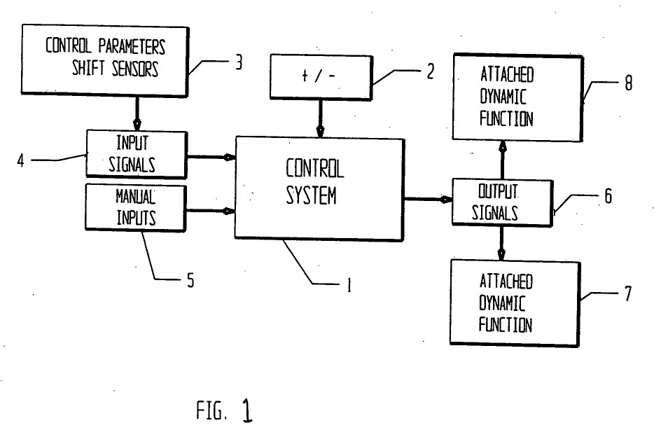

FIG. 1 depicts a multiple parameter control system apparatus, which functions as a control system for a two-wheeled personal vehicle with attached dynamically controllable vehicular system functions. Control system 1 receives input signals 4 from control parameter shift sensor devices 3. Control system 1 processes the input signals 4 and provides output signals 6 to an attached dynamic controllable function 7 and to an attached dynamic controllable function 8 of a vehicle. The control system 1 has a power supply 2. Manual input devices 5 send data for modification of the control parameters of control system 1.

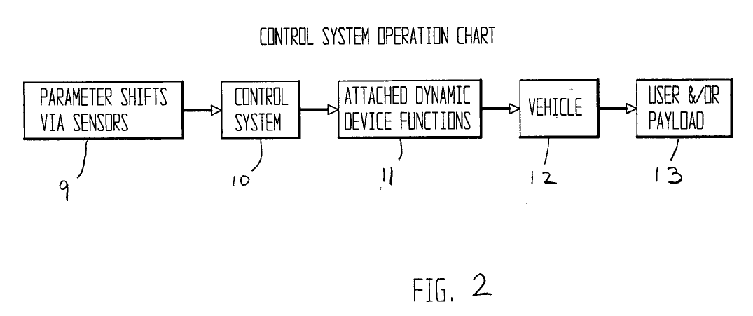

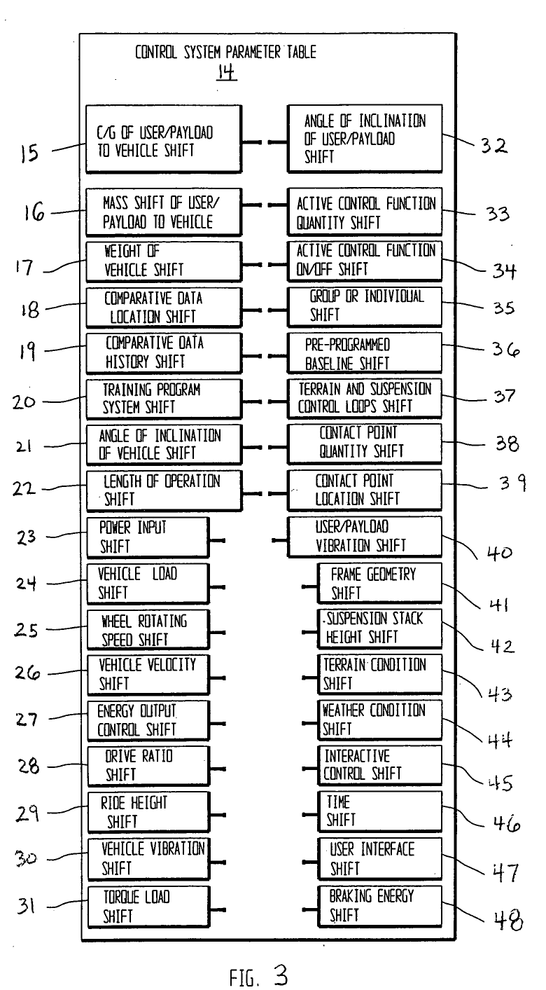

In FIG. 2, the simplified controller operation formula is given as: measurements from parameter shifts via sensors 9 are received by control system 10 and outputs are sent to attached dynamic functions 11 of a vehicle 12 to improve the ride characteristics of the vehicle for the user and/or payload 13.

FIG. 3 depicts an example of a control system parameter table 14 with the following parameters included: center of gravity of user/payload to vehicle shift parameter 15, mass shift of user/payload to vehicle parameter 16, weight of vehicle shift parameter 17, comparative data location shift parameter 18, comparative data history shift parameter 19, training program system shift parameter 20, angle of inclination of vehicle shift parameter 21, length of operation shift parameter 22, power input shift parameter 23, vehicle load shift parameter 24, wheel rotating speed shift parameter 25, vehicle velocity shift parameter 26, energy output control shift parameter 27, drive ratio shift parameter 28, ride height shift parameter 29, vehicle vibration shift parameter 30, torque load shift parameter 31, angle of inclination of user/payload shift parameter 32, active control function quantity shift parameter 33, active control function on/off shift parameter 34, group or individual shift parameter 35, Pre-programmed baseline shift parameter 36, terrain and suspension control loop shift parameter 37, contact point quantity shift parameter 38, contact point location shift parameter 39, user/payload vibration shift parameter 40, frame geometry shift parameter 41, suspension stack height shift parameter 42, terrain condition shift parameter 43, weather condition shift parameter 44, interactive control shift parameter 45, time shift parameter 46, user interface parameter 47, and braking energy shift parameter 48.

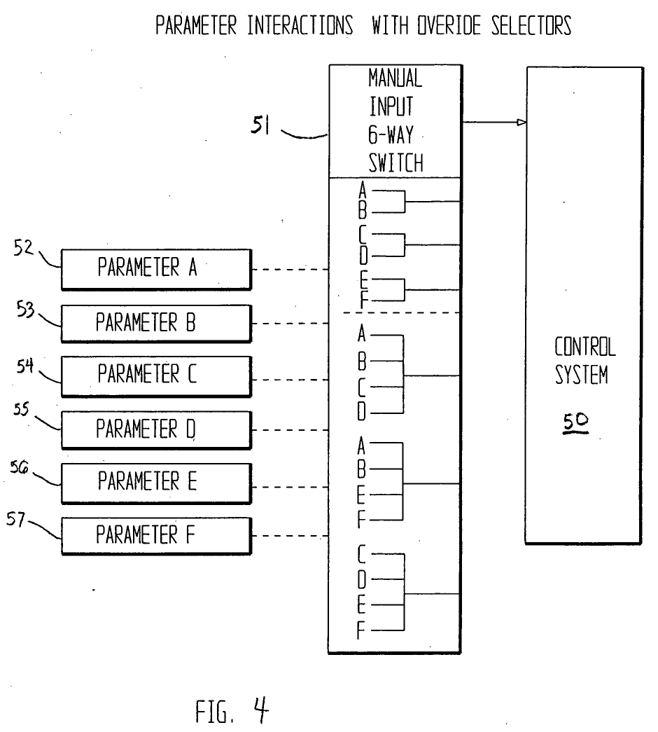

FIG. 4 is a control system 50 with a manual input selector switch 51 that gives the user control over the selection of parameters the control will use for creating output signals. Parameter A 52, parameter B 53, parameter C 54, parameter D 55, parameter E 56, and parameter F 57 can be selected as pairs A/B, C/D, E/F or used together in groups of four such as A/B/C/D, A/B/E/F, C/D/E/F to give the user multiple options in providing manual inputs to change the vehicle characteristics through control system 50.

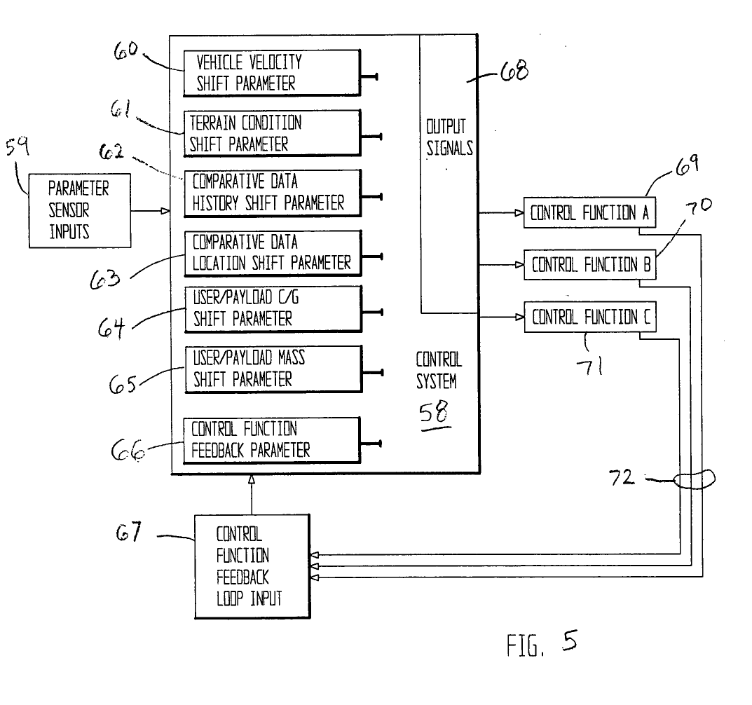

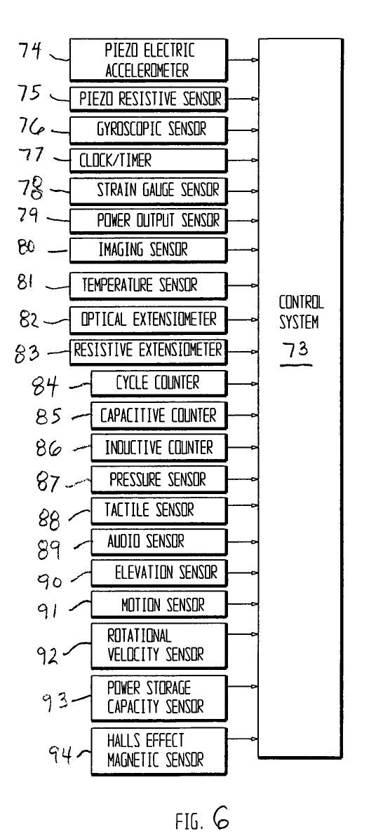

FIG. 5 displays a control system 58 which uses parameter information from control function feedback parameter 66 combined with vehicle velocity shift parameter 60, terrain condition shift parameter 61, comparative data history shift parameter 62, comparative data location shift parameter 63, c/g of user/payload to vehicle shift parameter 64, mass shift of user/payload to vehicle parameter 65 to determine output signals 68 to make adjustments in control function A 69, control function B 70, and control function C 71. Control function A 69, control function B 70, and control function C 71 send signal outputs 72 to control feedback loop input device 67 for input into the control function feedback parameter 66. Parameter sensor inputs 59 send parameter shift signals to the control system 58. Parameters are selected individually, in pairs, in groups, sequentially, in parallel, and combinations thereof for control system operation.

FIG. 6 depicts a group of sensors connected to control system 73. Piezo electric accelerometer 74, piezo resistive sensor 75, gyroscopic sensor 76, clock/timer 77, strain gage sensor 78, power output sensor 79, imaging sensor 80, temperature sensor 81, optical extensiomemeter 82, resistive extensiometer 83, cycle counter 84, capacitive counter 85, inductive counter 86, pressure sensor 87, tactile sensor 88, audio sensor 89, elevation sensor 90, motion sensor 91, rotational velocity sensor 92, power storage capacity sensor 93, and halls effect magnetic sensor 94 provide parameter shift measurement input data for control system 73. Configurations of the control system of FIG. 1 may use two or more of these sensors in combination to determine the control output signals for attached controlled functions.

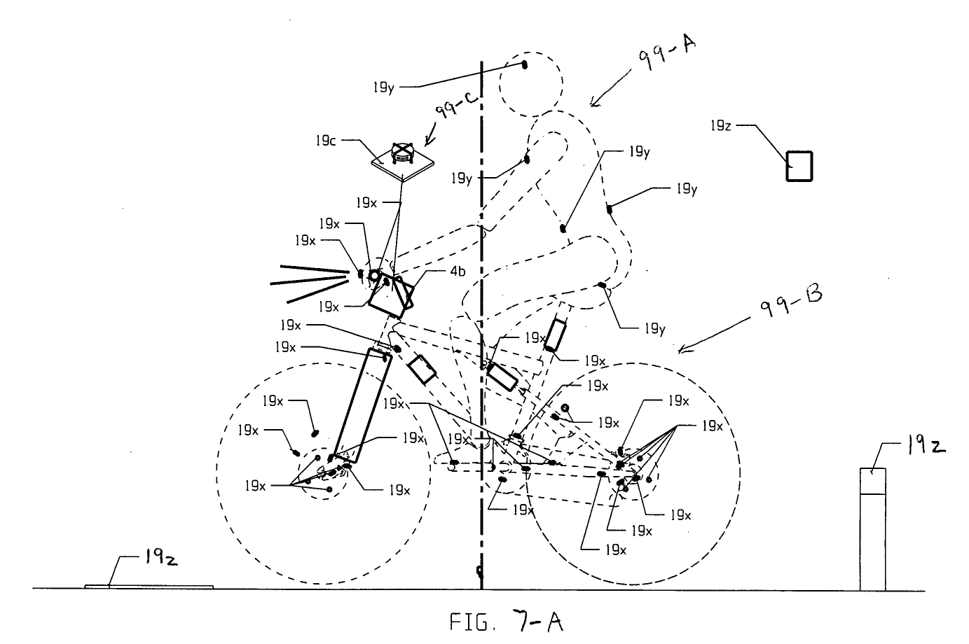

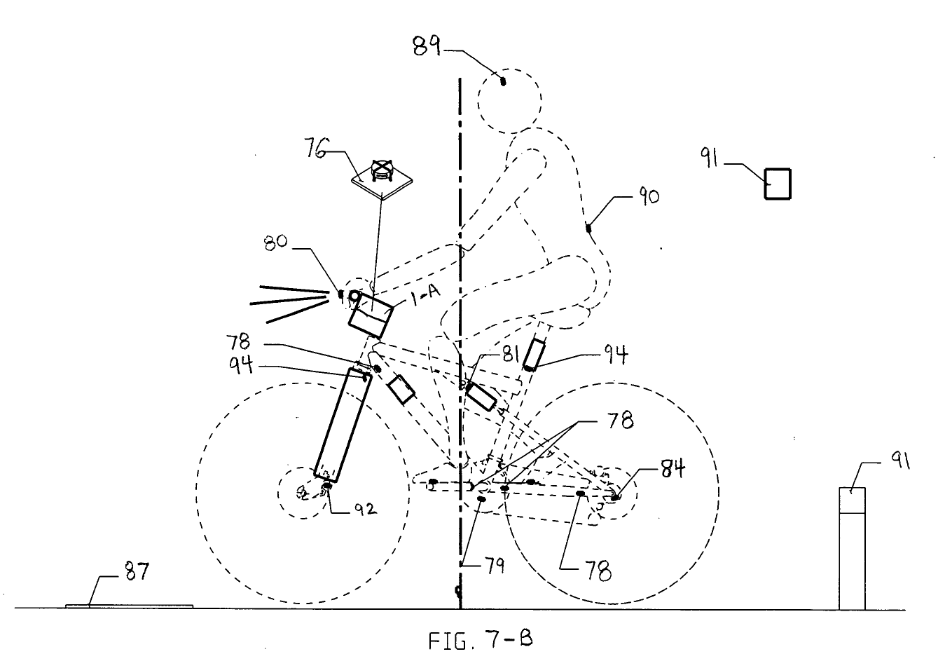

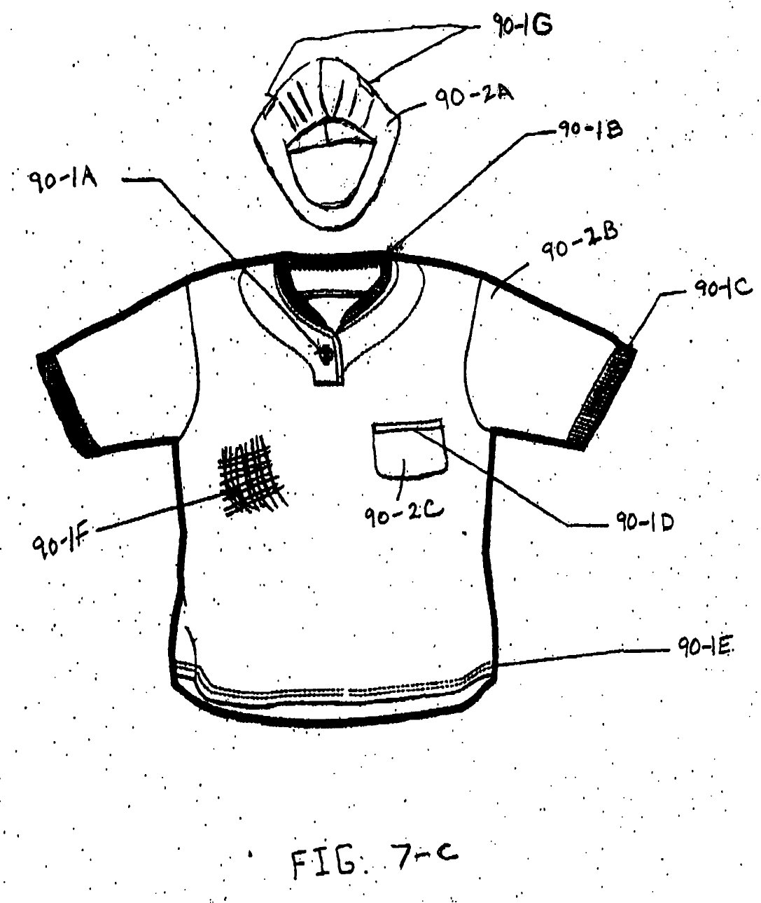

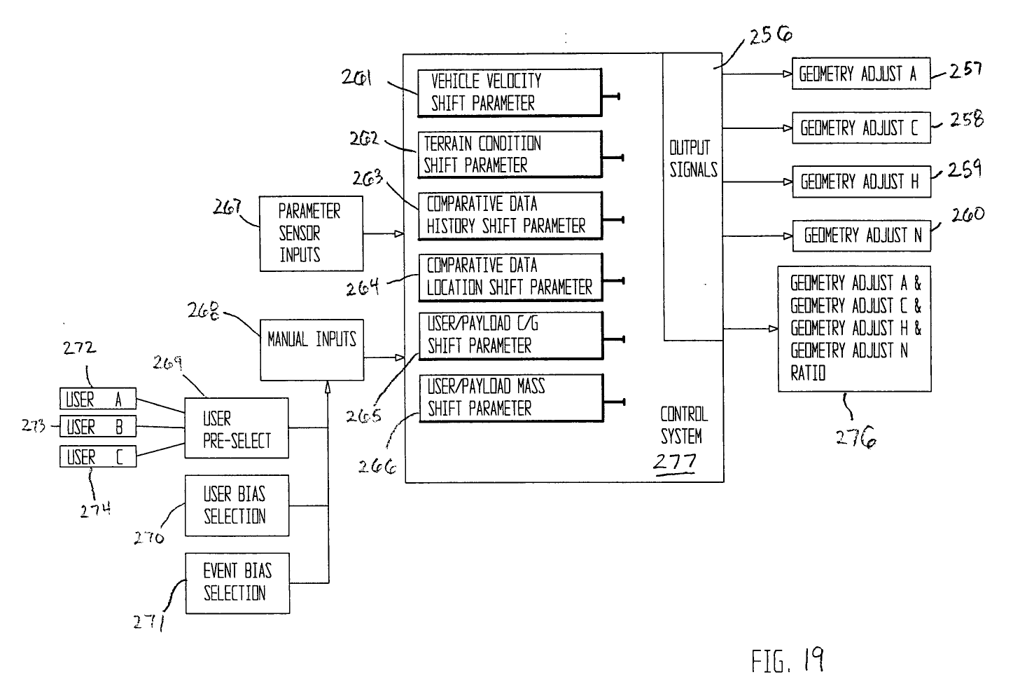

FIG. 7-A displays the versatility of the control system to receive sensor signals from sensors mounted on the user/payload 99-A, on the vehicle 99-B, or off the vehicle (referenced from FIG. 19 of U.S. Nonprovisional patent application Ser. No. 10/113,931—Filed Apr. 2, 2002, Vehicles and Methods Using Center of Gravity and Mass Shift Control System, Inventor: Darrell W. Voss). Approximate locations for sensors are shown on vehicle 99-B such as sensor locations 19x, on the user/payload 99-A such as sensor locations 19y, off the vehicle such as sensor locations 19z, or in a control system housing 99-C such as sensor location 19c. Exact sensor positions vary dependent on the size and shape of the vehicle and the contact points of the user and or payload with the vehicle. Sensor mounting methods to the vehicle are dependent on size and type of sensor. The sensors use wire harness assemblies or wireless communication methods for outputting signals to a control system.

FIG. 7-B displays an embodiment of a bicycle control system 1-A which receives sensor signals from sensors mounted on the user/payload 99-A, on the vehicle 99-B, or off the vehicle. Sensor locations are shown on the vehicle 99-B such as rotational velocity sensor 92, power output sensor 79, strain gauge sensors 78, cycle counter 84, halls effect magnetic sensors 94, temperature sensor 81, and imaging sensor 80. Sensor locations are shown on the user/payload 99-A such as elevation sensor 90 and audio sensor 89. Sensor locations are shown external to the vehicle such as pressure sensor 87 and motion sensors 91. Sensor locations are also shown internal to the control system housing 99-C such as gyroscopic sensor 76. The sensors use wire harness assemblies or wireless communication methods for outputting signals to control system 1-A.

FIG. 7-C depicts sensor locations on a vehicle users' protective gear and apparel. Sensors are attached to, woven into, and integrated with the protective gear and apparel fabrics. Imaging sensors 90-1G are located on protective helmet 90-2A and are removable and integrated into the helmet structure. Voice activation sensor 90-1A is directly mounted to shirt 90-2B. Elevation sensors 90-1B, 90-1C, and 90-1E interwoven into shirt 90-2B provide user positional data to control system of FIG. 7-B. Pressure sensor 90-1F is woven into the fabric of shirt 90-2B. Global positioning sensor 90-1F is located in pocket 90-2C of shirt 90-2B. Similarly, sensor devices that are directly coupled to a user, such as; a wristwatch, heart monitor, blood pressure sleeve, and body temperature sensor output signals to the control system of FIG. 7-B. Apparel such as gloves, pants, visors, boots, shoes, backpacks, belts, and crash protective outerwear are also used to integrate sensors with the user. The sensors use wire harness assemblies or wireless communication methods for outputting signals to a control system.

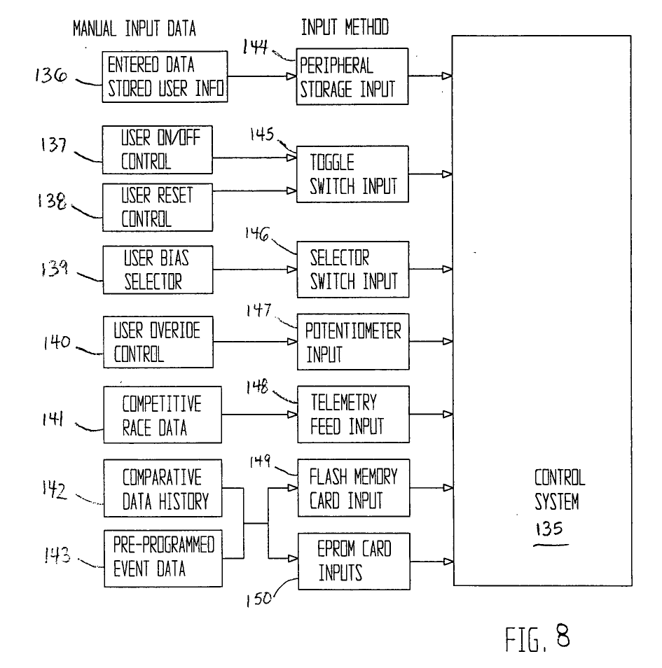

FIG. 8 is an embodiment of the methods for data and manual inputs for control system 135. Manual data types are stored user information 136, user on/off control 137, user reset control 138, user bias selection 139, user override control 140, competitive race data 141, comparative data history 142, pre-and programmed event data 143. These data types are input via one or more of the following input methods; peripheral storage input 144, toggle switch input 145, selector switch input 146, potentiometer input 147, telemetry feed input 148, flash memory card input 149, and eprom card inputs 150.

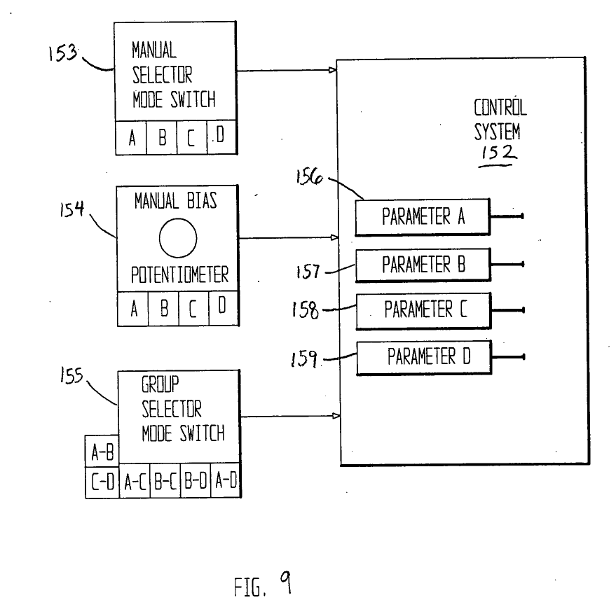

FIG. 9 is another embodiment of a control system with manual inputs to influence the control parameter functions of the control system. Control system 152 receives manual input signals through manual selector input 153, manual potentiometer 154, and group selector switch 155. Parameter A 156, parameter B 157, parameter C 158, and parameter D 159 are the control parameters for control system 152. The manual inputs influence the control algorithms internal to the control system by adjusting the mode of the control parameters. Parameters A, B, C, or D are independently chosen as primary by the user selector input 153. Parameters A, B, C, or D have a greater percentage of influence by the manual potentiometer 154. Parameter paired groups are chosen by the group selector switch 155 such as A/B, C/D, A/C, B/C, B/D, or A/D. The control system algorithms is written to allow for additional manual input groupings as required for the quantity of control functions attached to the vehicle.

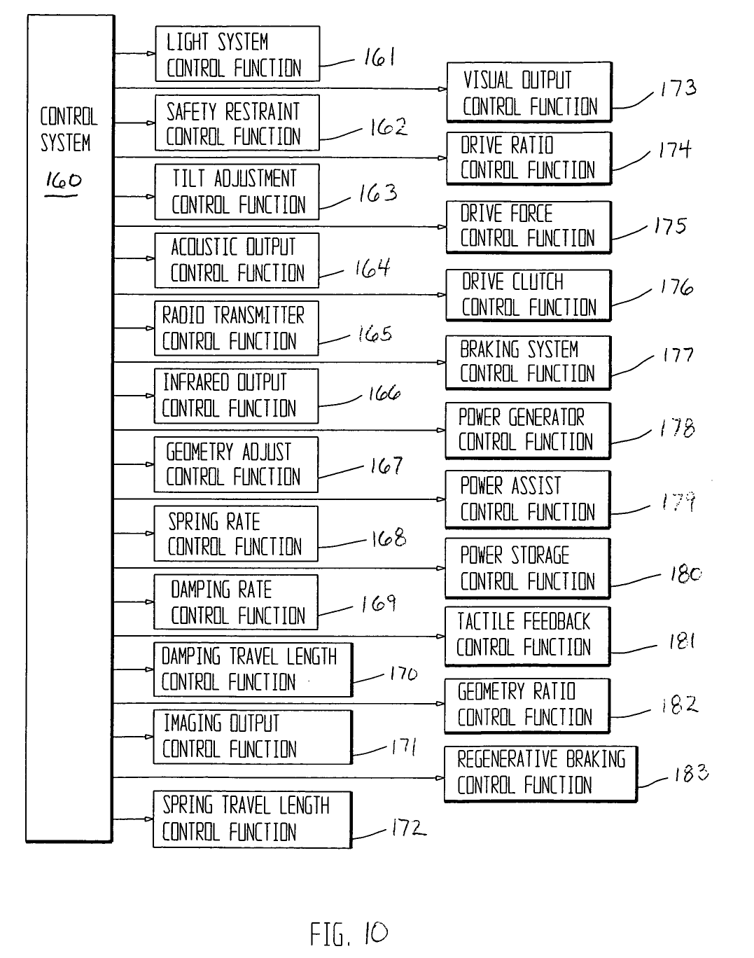

FIG. 10 depicts a control system with representative control functions. Control system 160 makes adjustments to the following control functions based on the formula of FIG. 2; light system control function 161, safety restraint control function 162, tilt adjustment control function 163, acoustic output control function 164, radio transmitter control function 165, infrared output control function 166, geometry adjust control function 167, spring rate control function 168, damping rate control function 169, damping travel length control function 170, imaging output control function 171, spring travel length control function 172, visual output control function 173, drive ratio control function 174, drive force control function 175, drive clutch control function 176, braking system control function 177, power generator control function 178, power assist control function 179, power storage control function 180, tactile feedback control function 181, geometry ratio control function 182, and regenerative braking control function 183. Other vehicle systems with controllable functions are also possible to control with the basic control system mechanism.

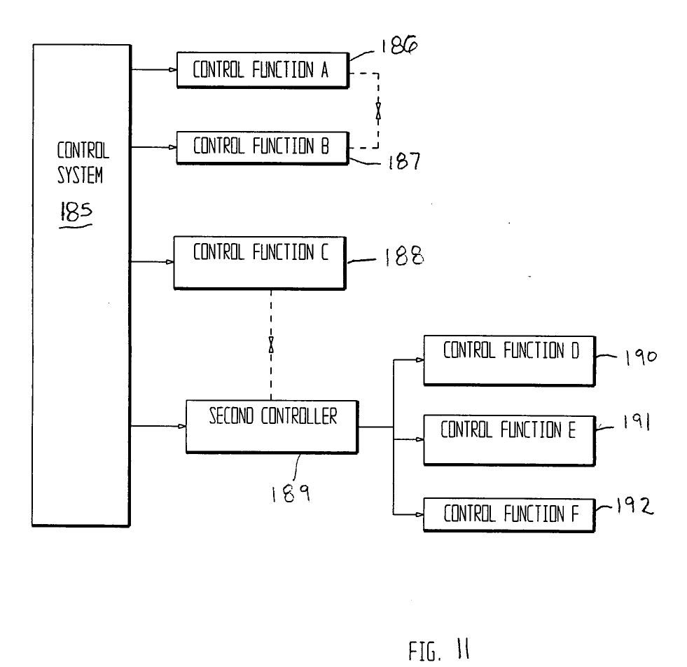

FIG. 11 is a depiction of a control system 185 that includes control function interaction and a secondary controller interaction. Second controller 189 monitors and controls the group of control function D 190, control function E 191, and control function F 192. The second controller also takes inputs from control function C 188 and control system 185. Control system 185 monitors and controls control function A 186 and control function B 187 independently of the second controller 189. This type of control system displays the functionality of a second controller to more closely monitor and control sub-system controlled functions which is advantageous in providing increased accuracy and speed through processing control functions in parallel and serial.

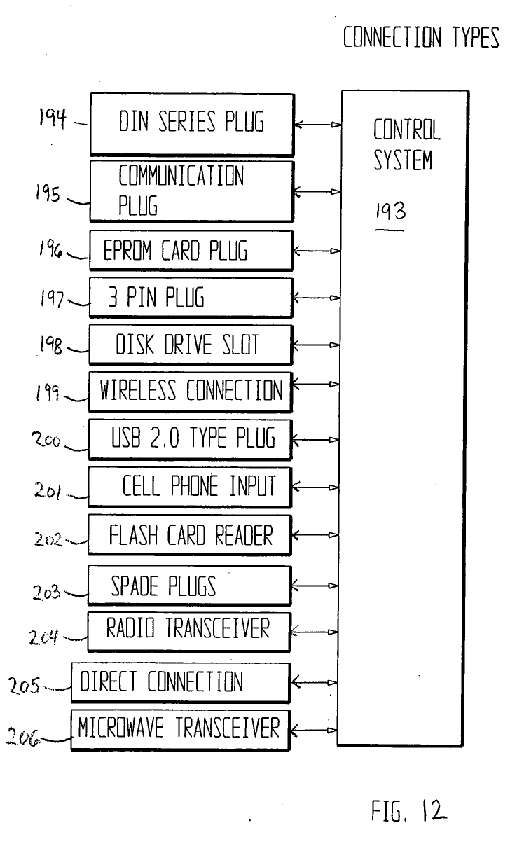

In FIG. 12, a control system 193 is shown with representative connection types for the parameter sensor signal inputs, manual inputs, pre-programmed inputs and control system outputs. DIN series plug 194, communication plug 195, eprom card plug 196, 3 pin plug 197, disc drive slot 198, wireless connection 199, universal serial bus version 2.0 type plug 200, cell phone input 201, flash memory card reader 202, spade plugs 203, radio transceiver 204, direct connection 205, and microwave transceiver 206 are among the many plug and connection types that are possible to connect with the control system.

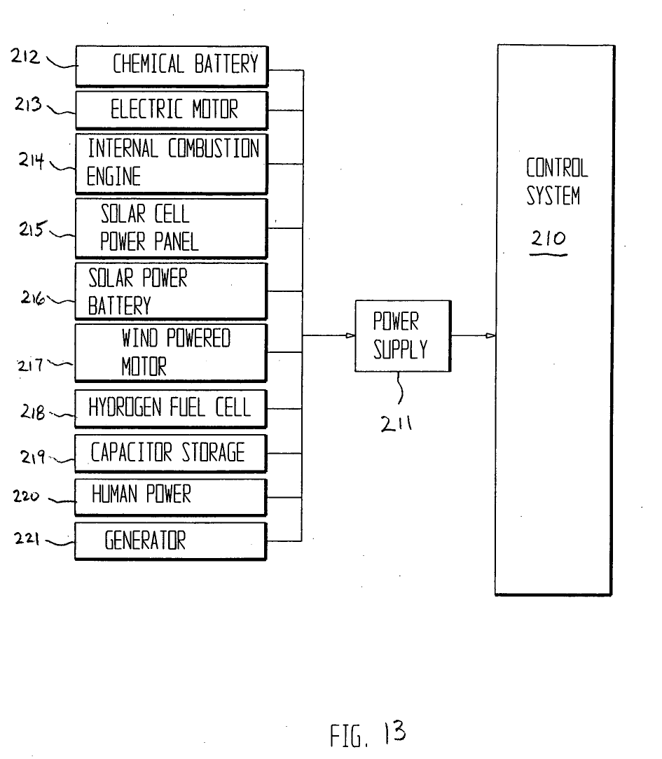

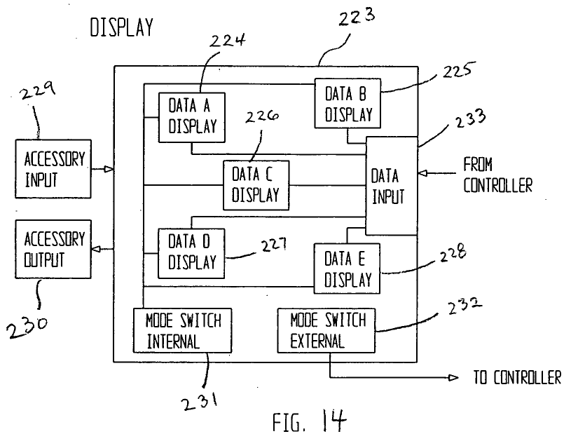

In FIG. 13, a representative of the power supply types is shown for control system 210. Power supply 211 is comprised of a chemical battery 212, electric motor 213, internal combustion engine 214, solar cell power panel 215, solar power battery 216, wind powered motor 217, hydrogen fuel cell 218, capacitor storage 219, human power 220, generator 221, or any combination of the above.

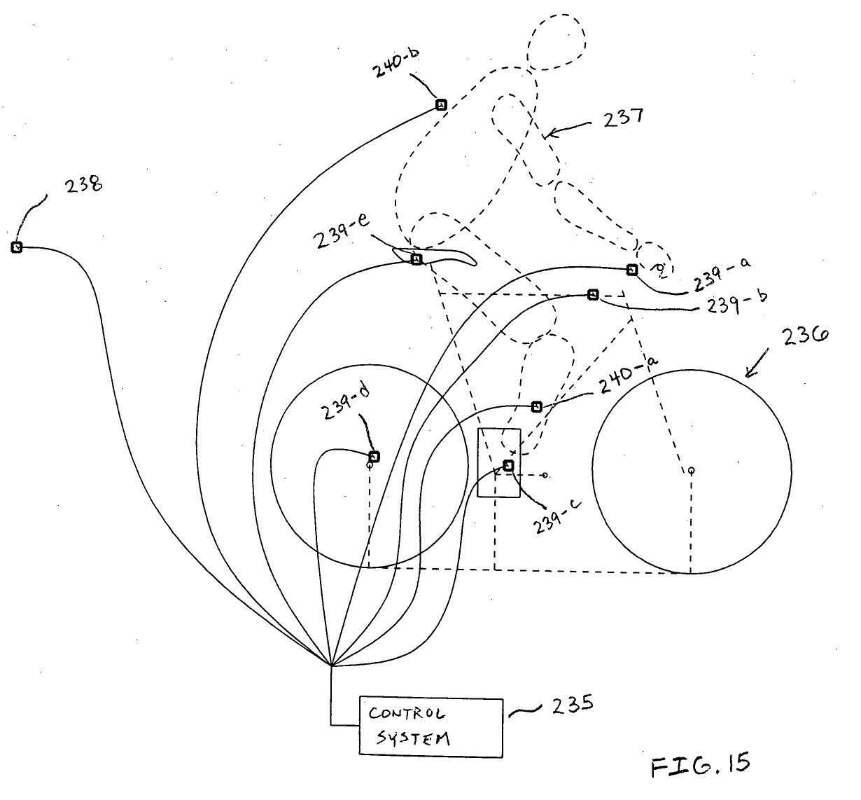

FIG. 14 is a depiction of a visual display device connected to a control system. Visual display housing 223 receives output signals from the controller and converts into data input 233 for data A display 224, data B display 225, data C display 226, data D display 227, and data E display 228. Accessory input 229 and accessory output 230 enable connections to the display housing. The mode switch internal 231 provides manual control over selections in the data displays. The mode switch external 232 enables manual inputs from the display housing 223 to return to the control system.

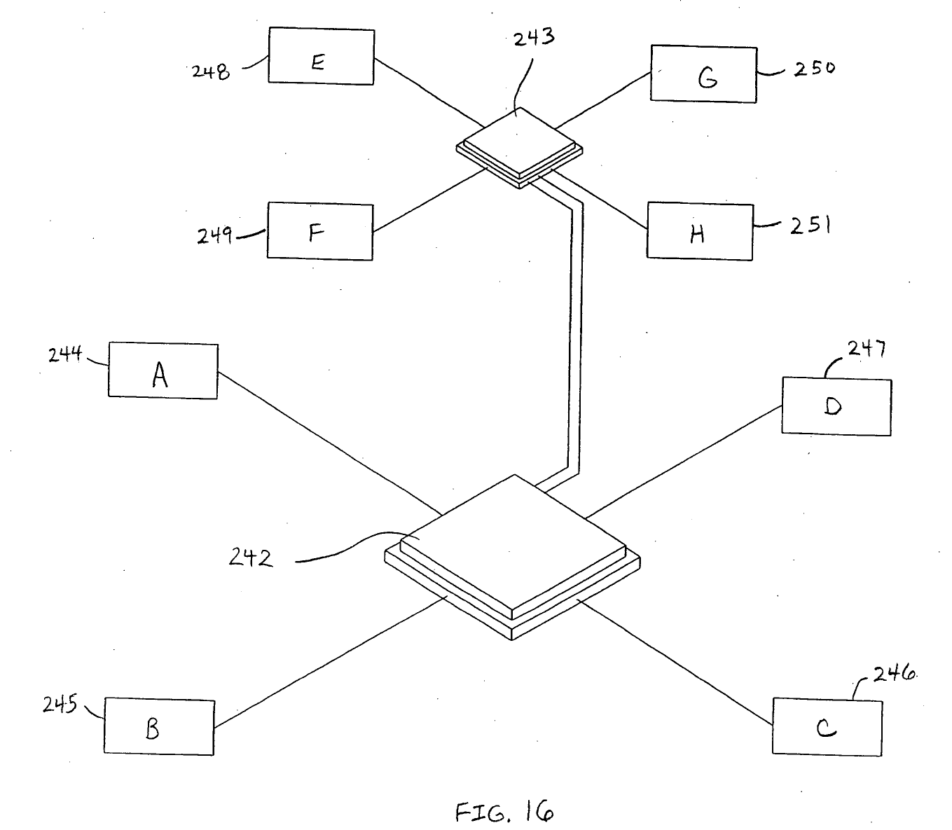

FIG. 15 depicts the versatility of the location possibilities on a vehicle assembly 236, user/payload 237, or off the vehicle at an external location 238. Control system 235 is locatable at vehicle locations 239-a, 239-b, 239-c, 239-d, and 239-e and user/payload locations 240-a and 240-b.

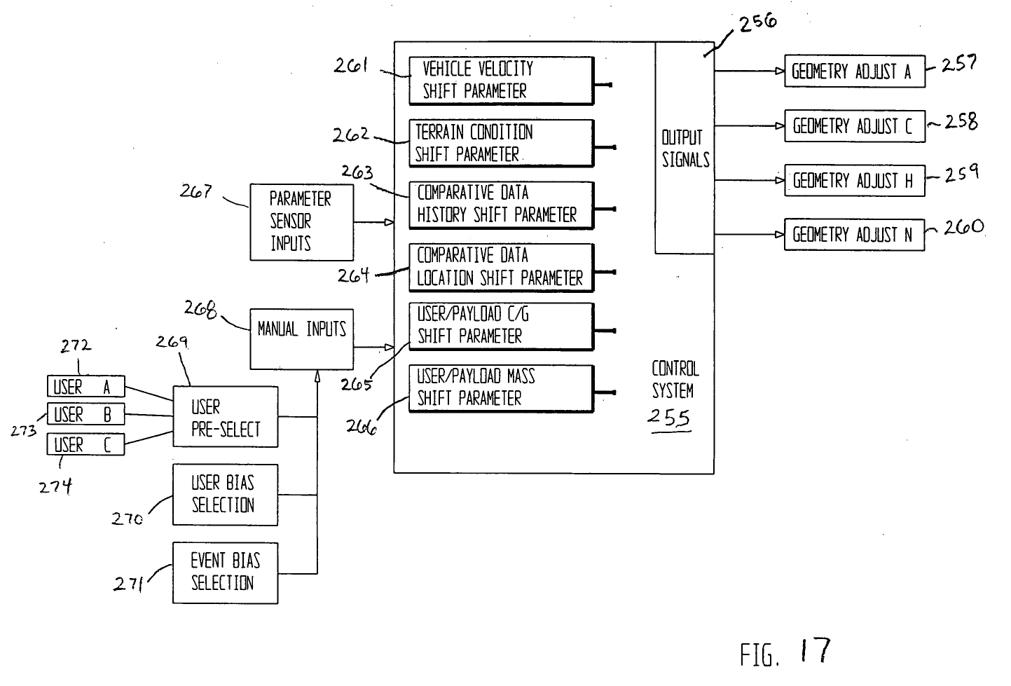

FIG. 16 depicts the combination of two controllers. The control system 242 sends control output signals to controlled function A 244, controlled function B 245, controlled function C 246, and controlled function D 247. Control system 242 sends control and receives signals from secondary control system 243 which sends control output signals to controlled function E 248, controlled function F 249, controlled function G 250, and controlled function H 251. This method of control system arrangement is often used to provide backup system controls as well as regional control of adjustable vehicle systems.

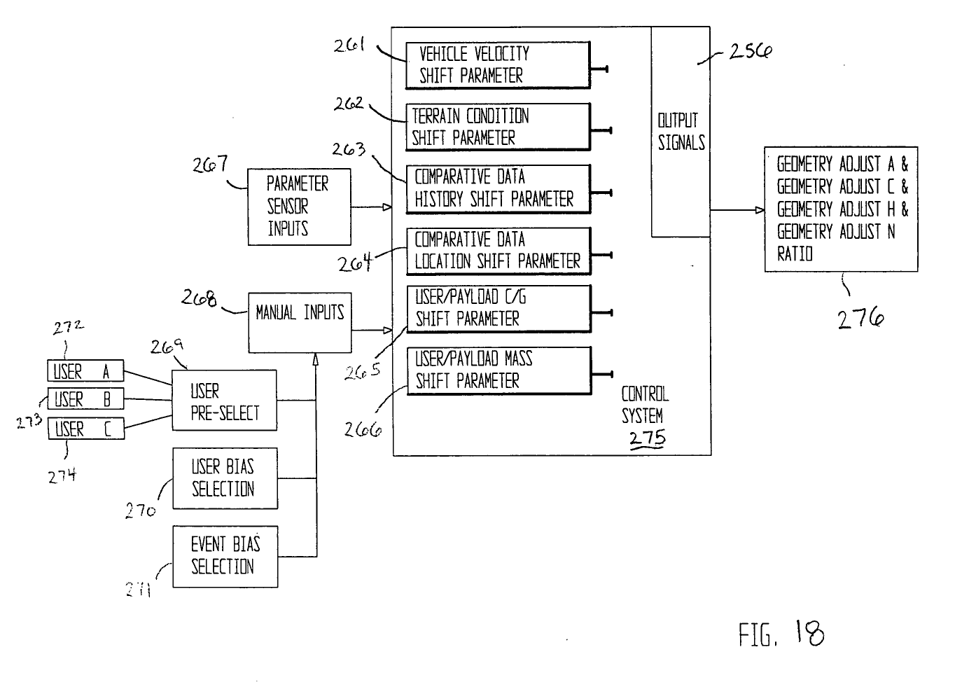

FIG. 17 depicts a control system 255 with multiple control parameters including vehicle velocity shift parameter 261, terrain condition shift parameter 262, comparative data history shift parameter 263, comparative data location shift parameter 264, user/payload c/g shift parameter 265, and user/payload mass shift parameter 266. Control system 255 receives inputs from parameter sensor inputs 267 and manual inputs 268. Manual inputs 268 receive input data from user pre-select switch 269, user bias selection 270, and event bias selection 271. User pre-select switch 269 allows the input of data from user profiles including user A 272, user B 273, user C 274. The control system outputs signals 256 to geometry adjustable control function A 257, geometry adjustable control function C 258, geometry adjustable control function H 259, and geometry adjustable control function N 260.

FIG. 18 is another embodiment of the control system of FIG. 17 wherein control system 275 sends output signals 256 to geometry adjustable control function A, C, H, and N ratio 276.

FIG. 19 is another embodiment of the control system of FIG. 17 wherein control system 277 sends output signals to 256 to geometry adjustable control function A 257, geometry adjustable control function C 258, geometry adjustable control function H 259, geometry adjustable control function N 260 and geometry adjustable control function A, C, H, and N ratio 276.

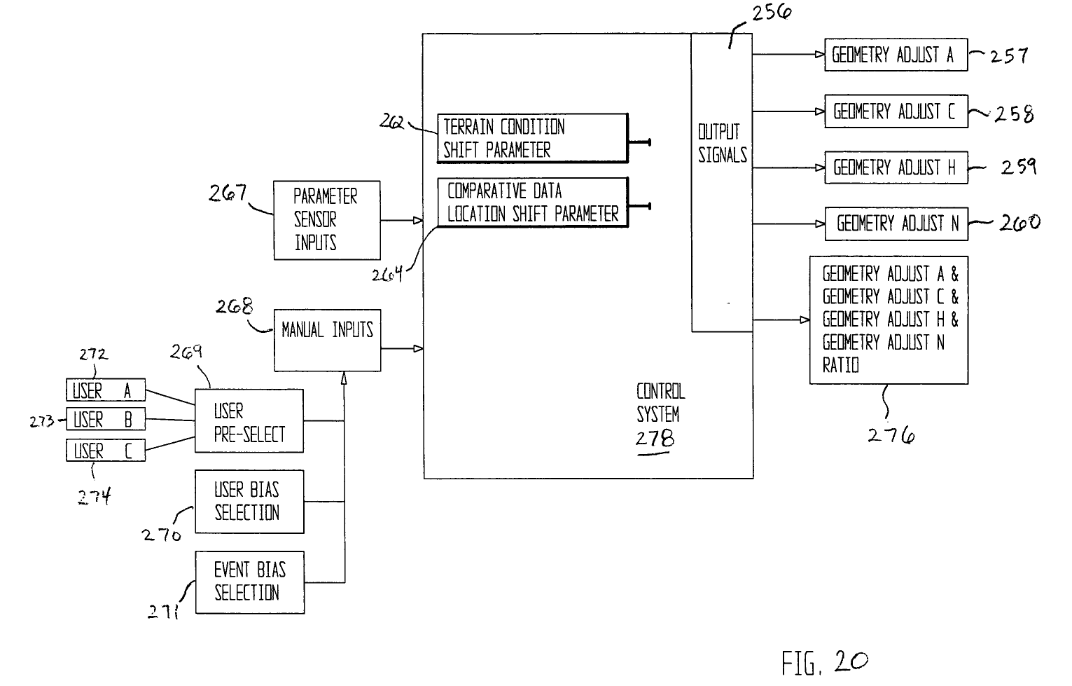

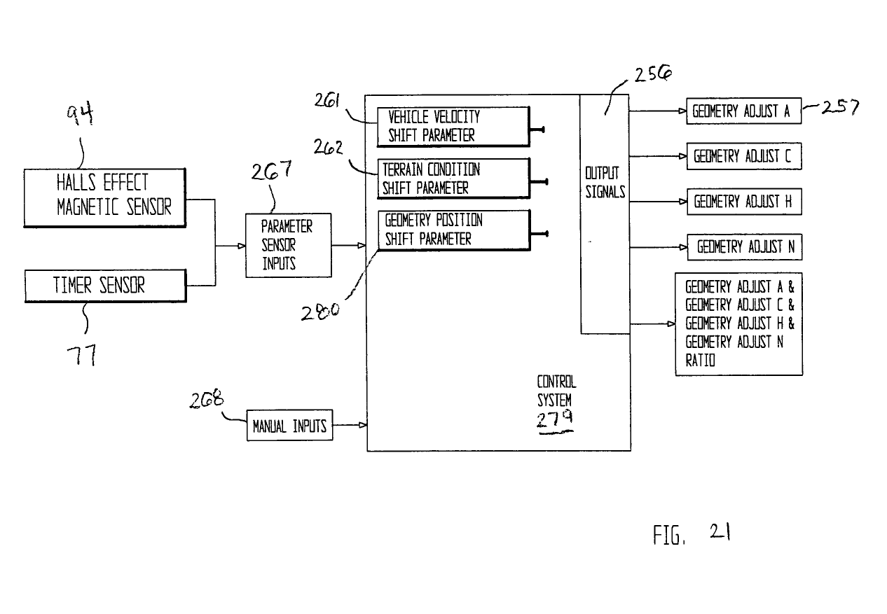

FIG. 20 is another embodiment of the control system of FIG. 19 wherein control system 278 has two control parameters which are terrain condition shift parameter 262 and comparative data location shift parameter 264. Control system 278 sends output signals 256 to geometry adjustable control function A 257, geometry adjustable control function C 258, geometry adjustable control function H 259, geometry adjustable control function N 260 and geometry adjustable control function A, C, H, and N ratio 276.

FIG. 21 is another embodiment of the control system of FIG. 19 wherein control system 279 has three control parameters vehicle velocity shift parameter 261, terrain condition shift parameter 262, and geometry position shift parameter 280. Control system 279 receives parameter sensor inputs 267 from two sensors, Hall's effect magnetic sensor 94 and timer sensor 77. Control system 279 sends output signals 256 to geometry adjustable control function A 257, geometry adjustable control function C 258, geometry adjustable control function H 259, geometry adjustable control function N 260 and geometry adjustable control function A, C, H, and N ratio 276.

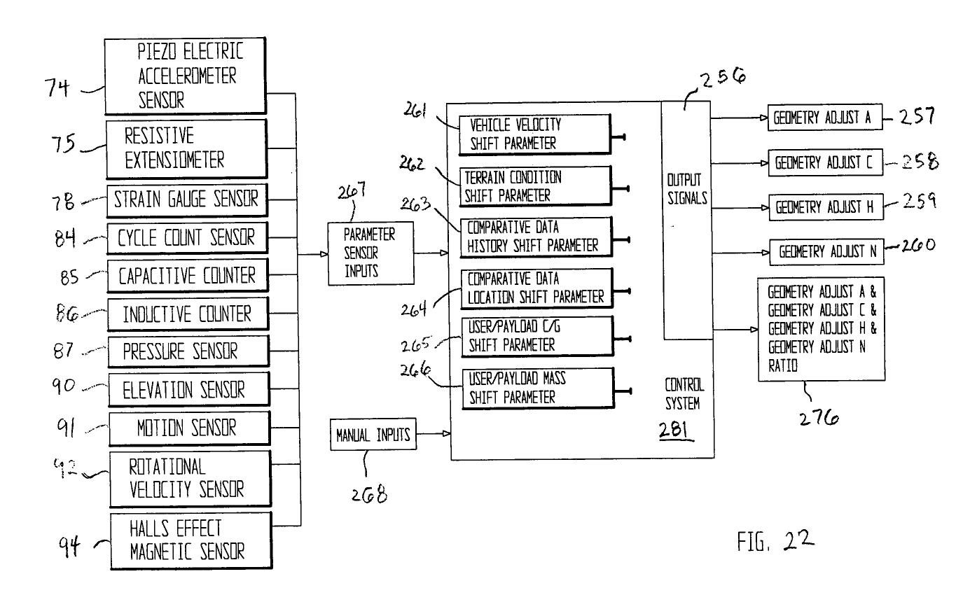

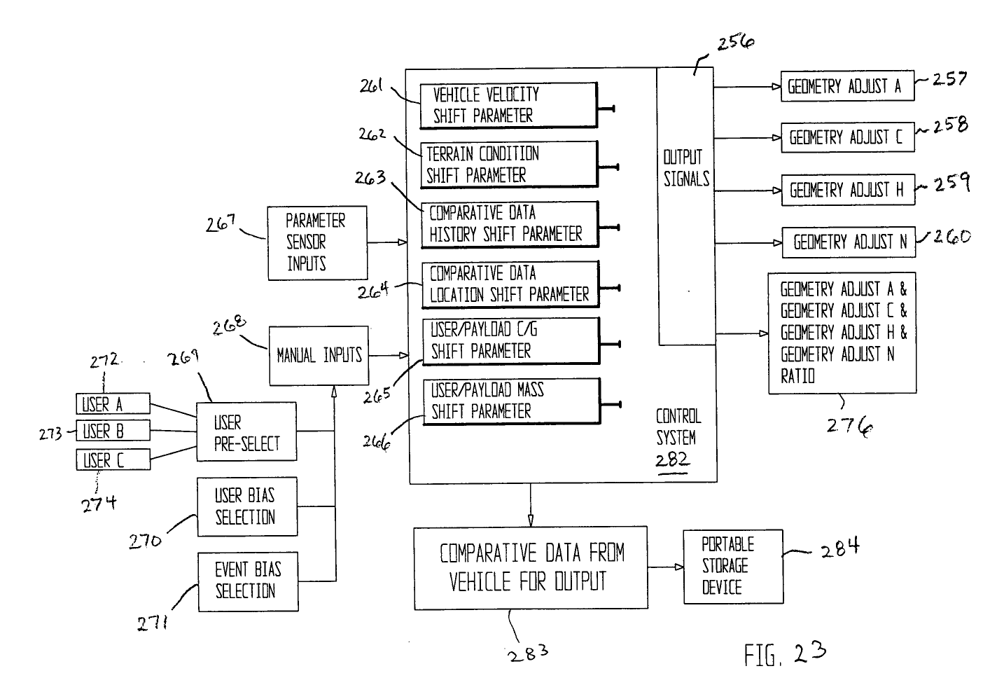

FIG. 22 is another embodiment of the control system of FIG. 17 wherein control system 281 receives parameter sensor inputs 267 from piezo electric accelerometer 74, piezo resistive sensor 75, strain gage sensor 78, cycle counter 84, capacitive counter 85, inductive counter 86, pressure sensor 87, elevation sensor 90, motion sensor 91, rotational velocity sensor 92, and halls effect magnetic sensor 94. Control system 281 sends output signals 256 to geometry adjustable control function A 257, geometry adjustable control function C 258, geometry adjustable control function H 259, geometry adjustable control function N 260 and geometry adjustable control function A, C, H, and N ratio 276.

FIG. 23 is another embodiment of the control system of FIG. 17 wherein control system 282 sends vehicle comparative data outputs 283 to a portable data storage device 284. Control system 282 sends output signals 256 to geometry adjustable control function A 257, geometry adjustable control function C 258, geometry adjustable control function H 259, geometry adjustable control function N 260 and geometry adjustable control function A, C, H, and N ratio 276.

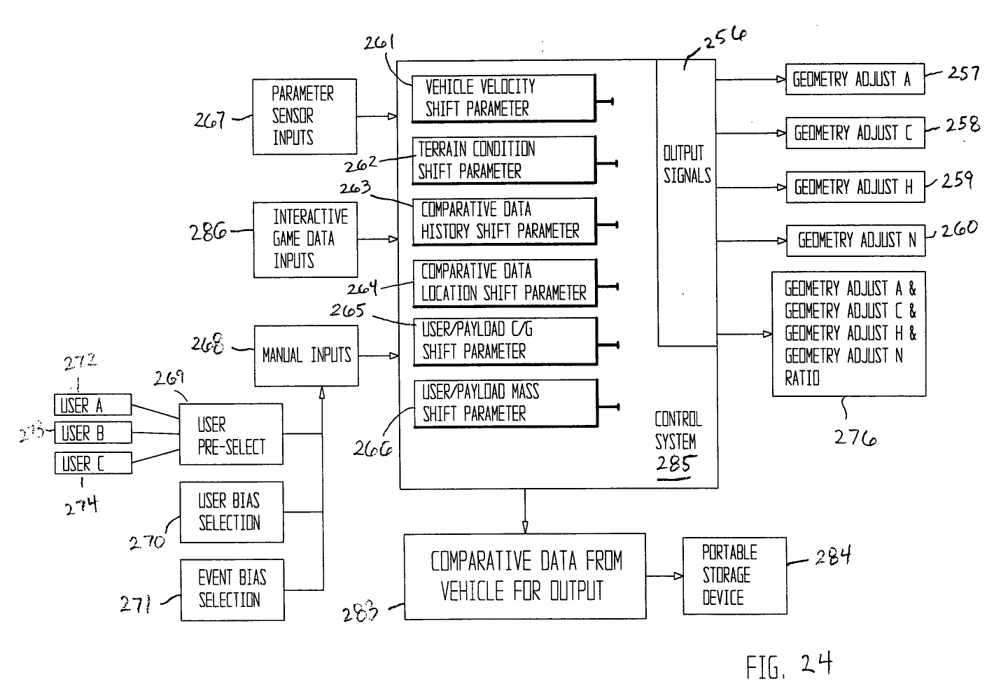

FIG. 24 is another embodiment of the control system of FIG. 23 wherein control system 285 receives interactive game data inputs 286 as well as the manual inputs 268 and parameter sensor inputs 267. The additional data input allows the control to utilize game data, personal history data, product test data, product development data, and other interactive data values into the control system for computing algorithms and reference baseline information for the controllable functions.

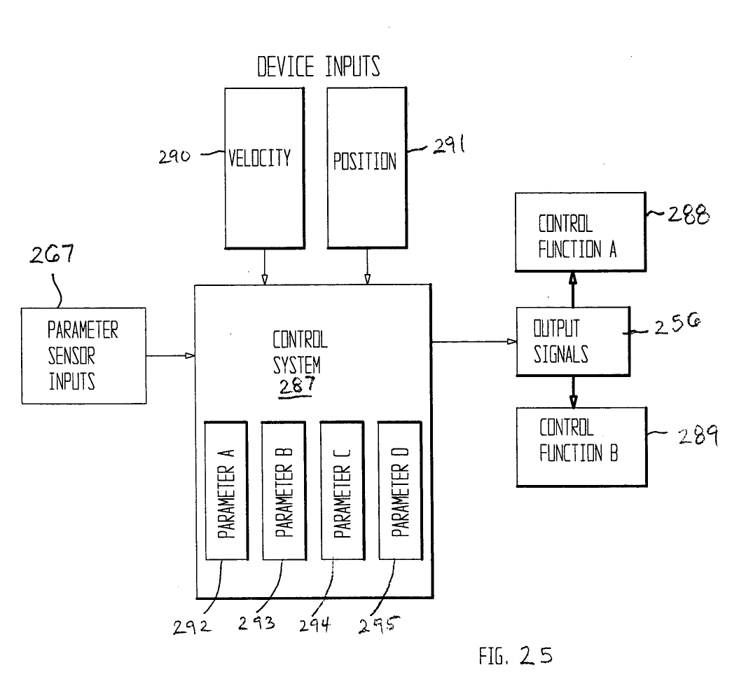

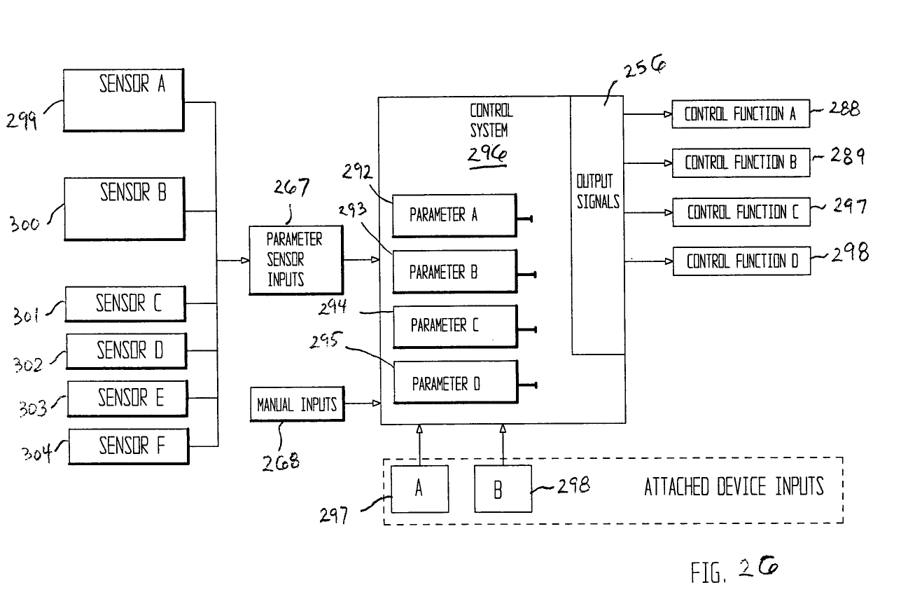

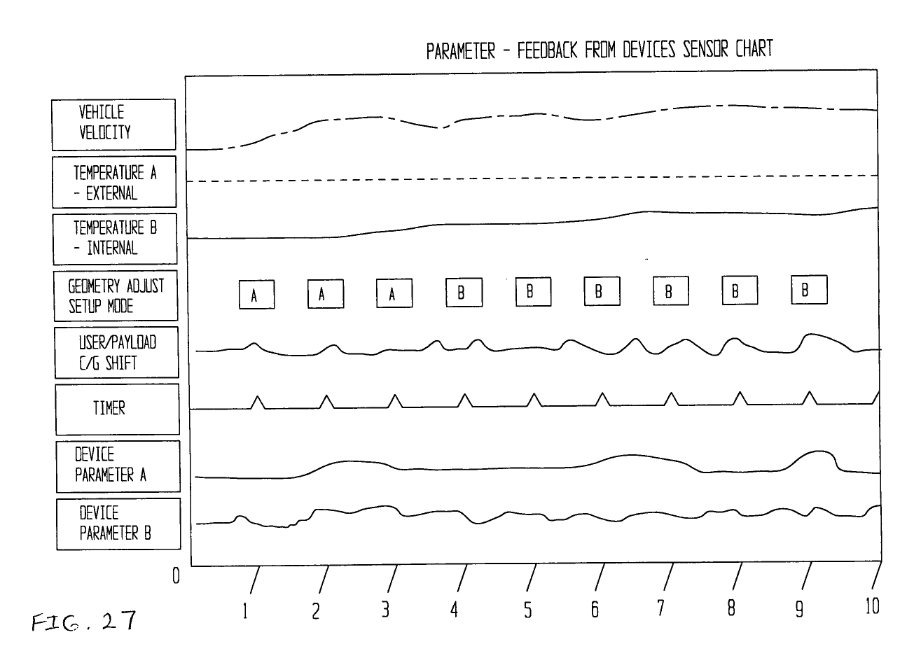

FIG. 25 is an embodiment of the control system of FIG. 1 wherein control system 287 with control parameter A 292, control parameter B 293, control parameter C 294, and control parameter D 295 receives additional inputs from device information such as device velocity 290 and device position 291. Control system 287 evaluates parameter sensor inputs 267 and the device input data to send output signals 256 to control function A 288 and control function B 289.

FIG. 26 depicts control system 296 which receives sensor A 299, sensor B 300, sensor C 301, sensor D 302, sensor E 303, and sensor F 304 parameter shift data through sensor inputs 267. Manual inputs 268 and attached device inputs 297 and 298 are also received by control system 296. Control system 296 from parameter controls, parameter A 292, parameter B 293, parameter C 294, and parameter D 295, determines output signals 256 for control function A 288, control function B 289, control function C 297, and control function D 298.

FIG. 27 is a chart showing feedback data from device parameter A and device parameter B and parameter sensors data. Sensor inputs vehicle velocity, temperature A-external, temperature B-internal, geometry adjust setup mode, user and/or payload c/g shift, timer/counter and inputs from attached devices are recorded.

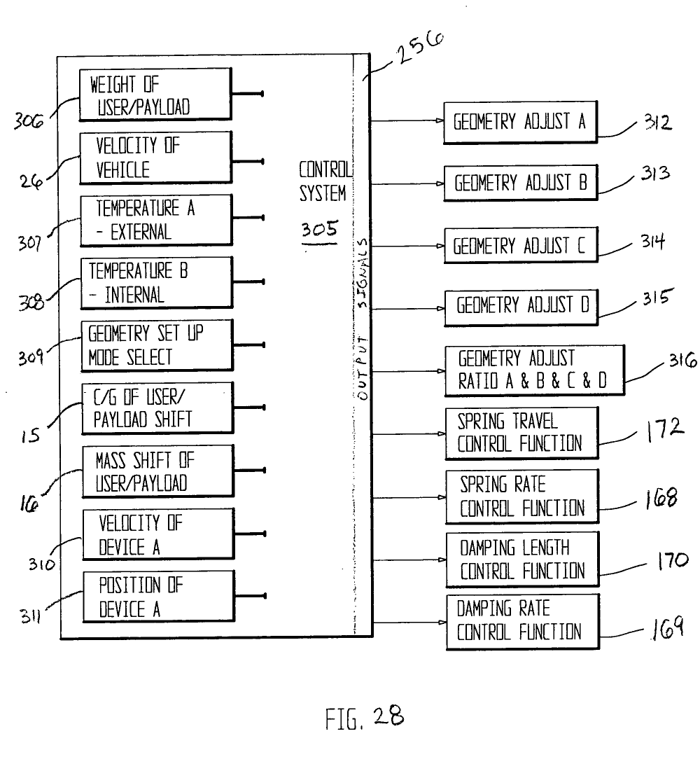

FIG. 28 depicts a control system 305 which has control parameters weight of user/payload 306, vehicle velocity shift parameter 26, temperature A-external 307, temperature B-internal 308, geometry setup mode select 309, center of gravity of user/payload to vehicle shift parameter 15, mass shift of user/payload to vehicle parameter 16, velocity of device A 310, and position of device A 311. Control system 305 sends output signals 256 to control functions geometry adjustable control function A 312, geometry adjustable control function B 313, geometry adjustable control function C 314, geometry adjustable control function D 315, geometry adjustable ratio of A, B, C, & D control function 316, spring rate control function 168, damping rate control function 169, damping travel length control function 170, and spring travel length control function 172.

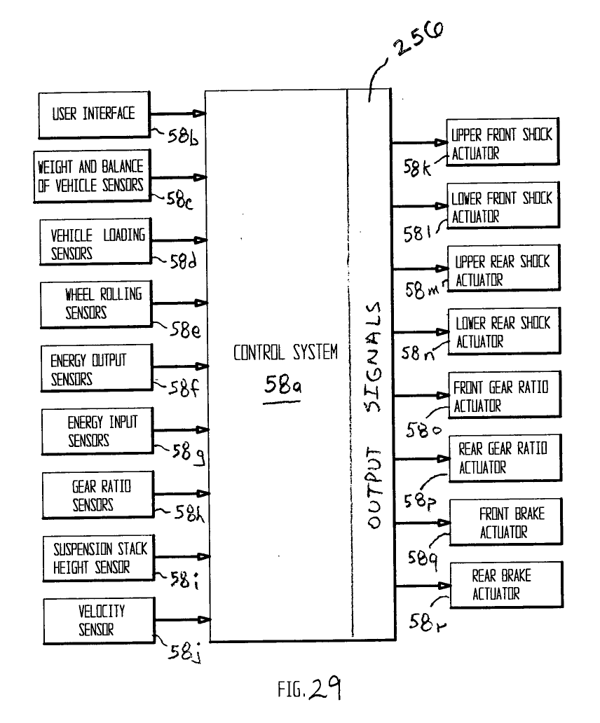

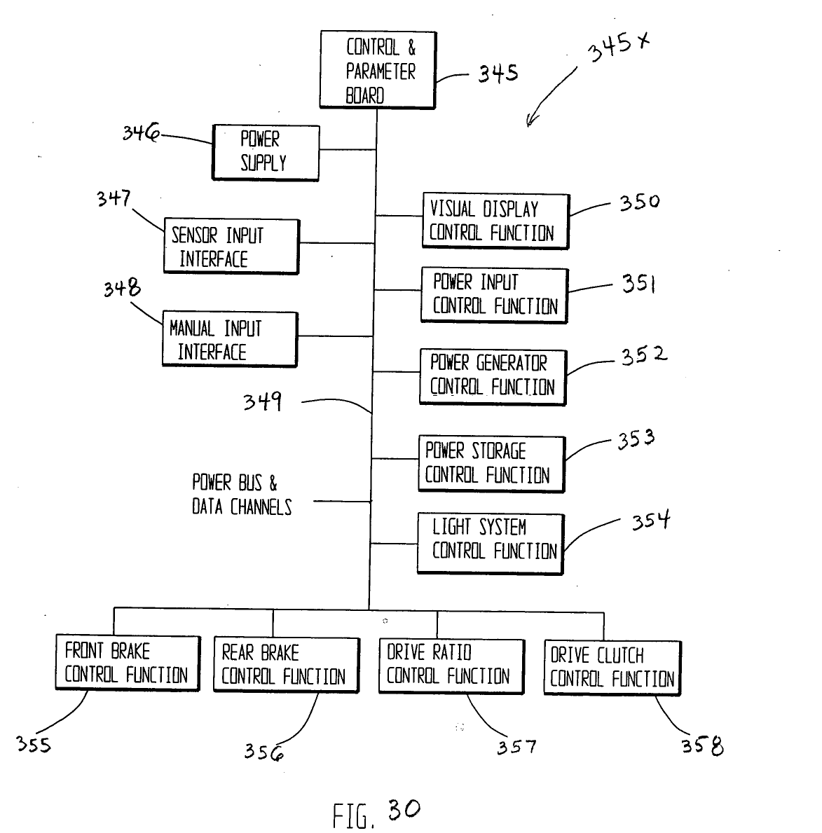

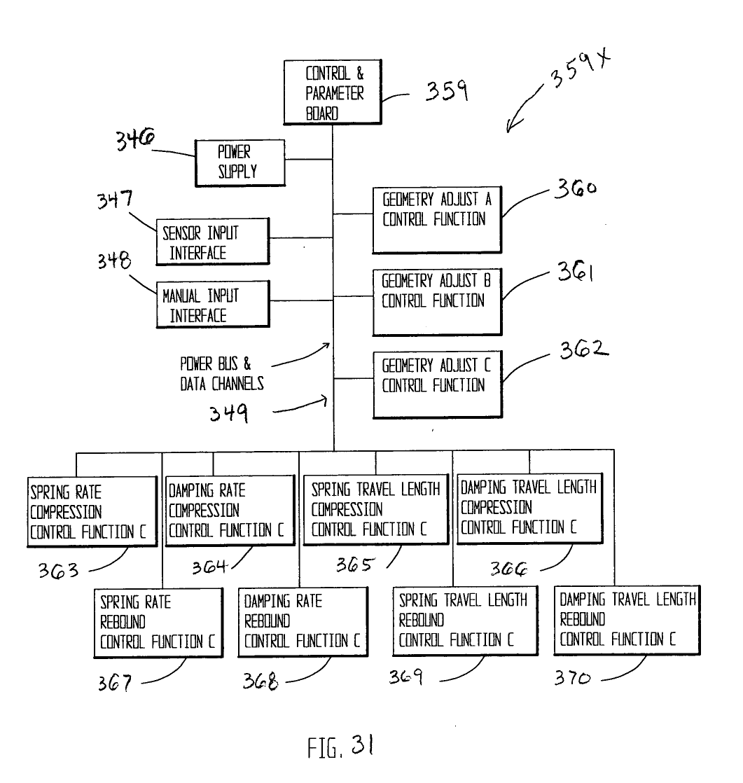

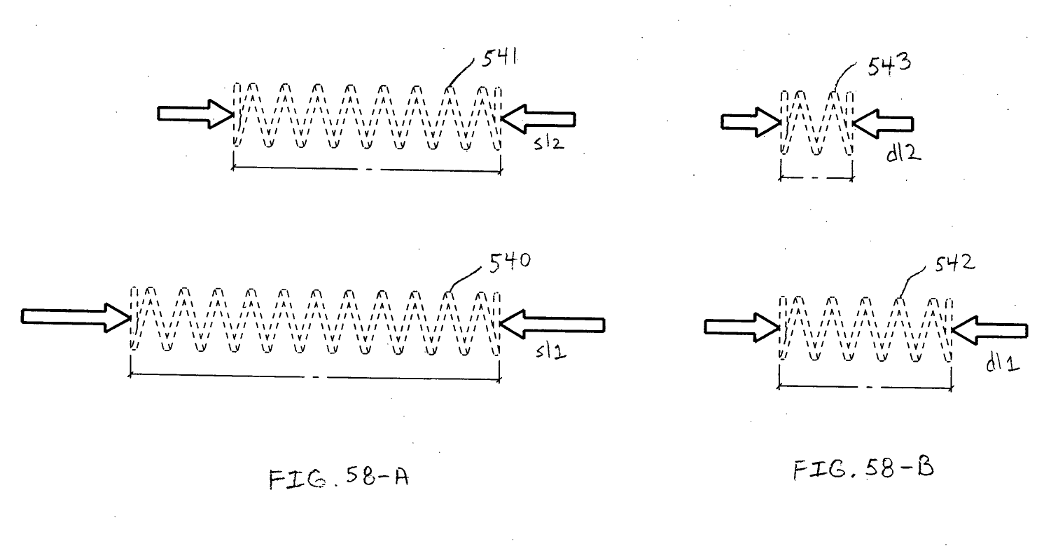

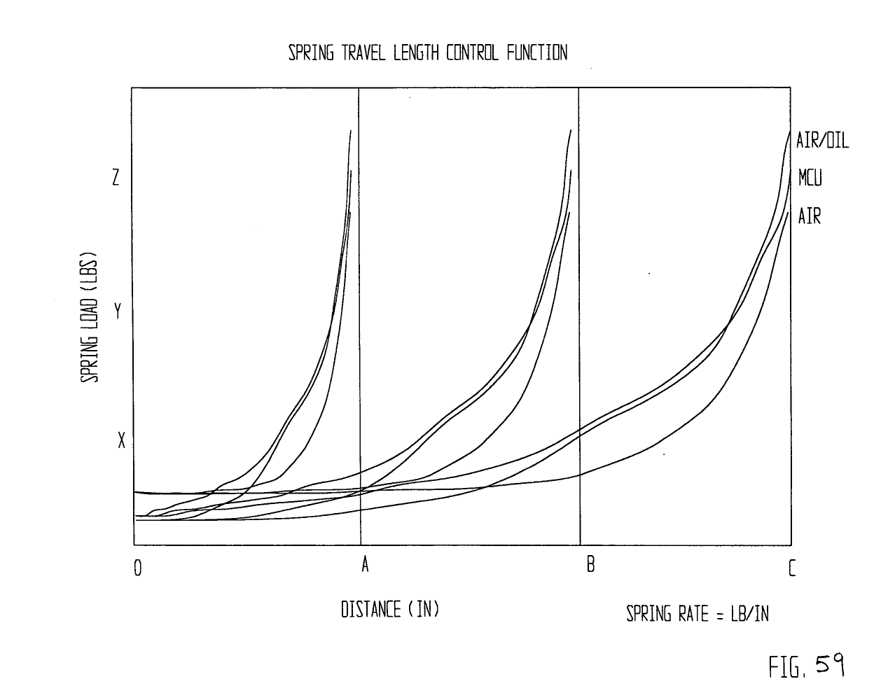

FIG. 29 depicts a control system 58a used to control dynamic systems attached to a vehicle by using signals provided by control parameter sensor inputs as embodied in FIG. 1 (referenced from FIG. 58 of U.S. Nonprovisional patent application Ser. No. 10/113,931—Filed Apr. 2, 2002, Vehicles and Methods Using Center of Gravity and Mass Shift Control System, Inventor: Darrell W. Voss). Vehicle dynamic systems include upper front shock 58k and lower front shock 58l actuators as applied in front suspension systems. Additional dynamic systems include but are not limited to upper rear 58m and lower rear 58n shock actuators, front gear 58o and rear gear 58p ratio actuators, front brake 58q and rear brake 58r actuators that are incorporated into a vehicle. The control system 58a has data inputs including user interface 58b, weight and balance sensors 58c, vehicle loading sensors 58d, wheel rolling sensors 58e, energy output sensors 58f, energy input sensors 58g, gear ratio sensors 58h, suspension stack height sensors 58 I, and velocity sensors 58j. The control system 58a monitors the data inputs and provides appropriate outputs to adjust the attached dynamic control functions as required by the system control parameters.

FIG. 30 is a block diagram of a control system assembly 345x with output power bus and data channels for communication with vehicle controllable functions as identified in FIG.10. The control and parameter board 345 is powered by power supply 346. Communications bus 349 provides signals to the various dynamic control functions. Control system 345x controls the vehicle dynamic systems through the control and parameter board 345. Sensor input interface 347 and manual input interface 348 allow inputs to be sent to the control and parameter board 345. The visual display control function 350, power input control function 351, power generator control function 352, power storage control function 353, light system control function 354, front brake control function 355, rear brake control function 356, drive ratio control function 357, and drive clutch control function 358 are adjusted by control and parameter board 345. Application of the vehicle braking systems are controlled by the front brake control function 355 and the rear brake control function 356. Indexing of the vehicle shifting systems is controlled by the drive ratio control function 357.

FIG. 31 is another embodiment of the control system assembly of FIG. 30 with control system assembly 359x having output power bus and data channels for communication with vehicle controllable functions as identified in FIG.10. The control and parameter board 359 is powered by power supply 346. Control and parameter board 359 adjusts the geometry adjustable A control function 360, geometry adjustable B control function 361, geometry adjustable C control function 362. Spring rate compression control function C 363, damping rate compression control function C 364, spring travel length compression control function C 365, damping travel length compression control function C 366, spring rate rebound control function C 367, damping rate rebound control function C 368, spring travel length rebound control function C 369, and damping travel length rebound control function C 370 are specific control functions related to suspension elements associated with geometry adjustable C control function 362.

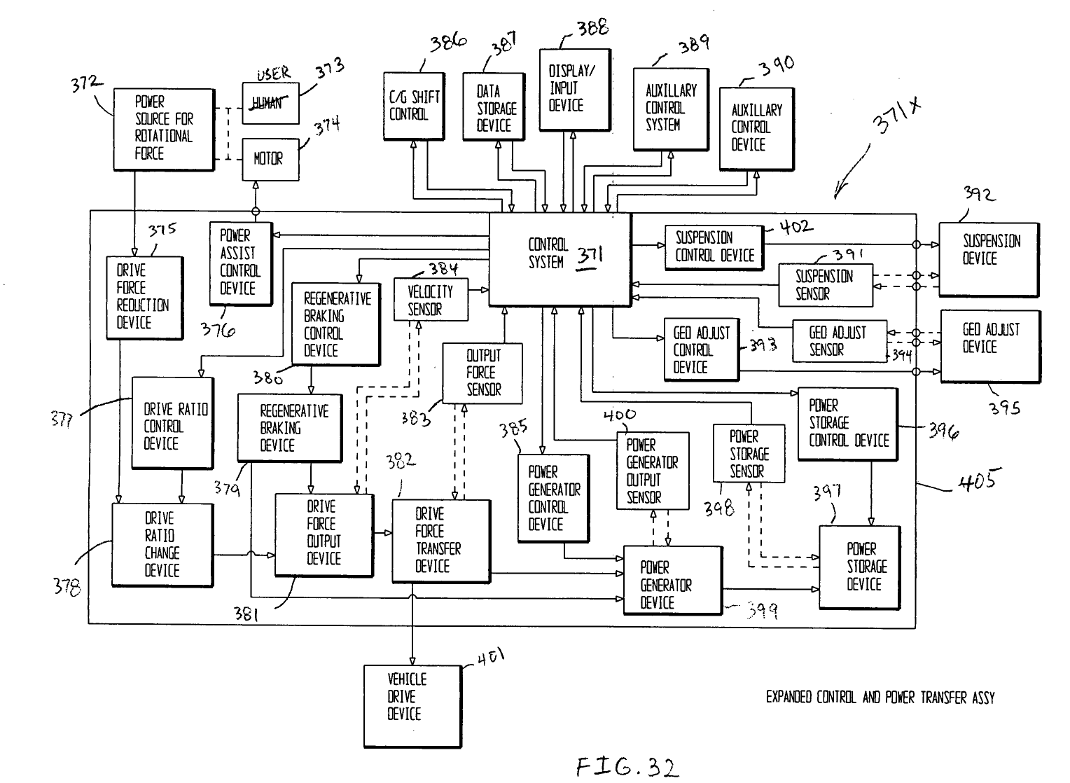

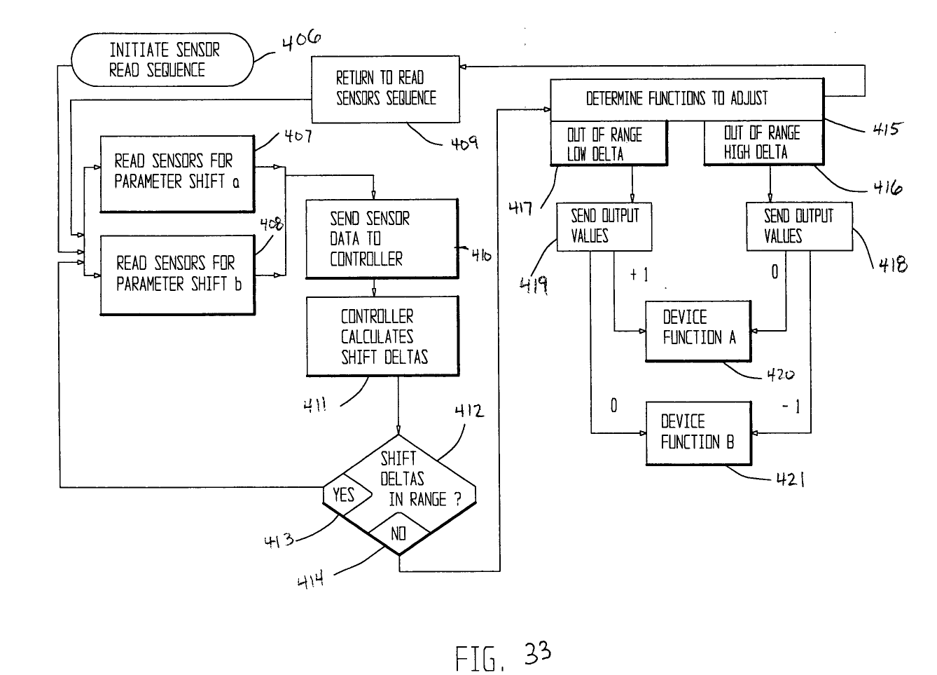

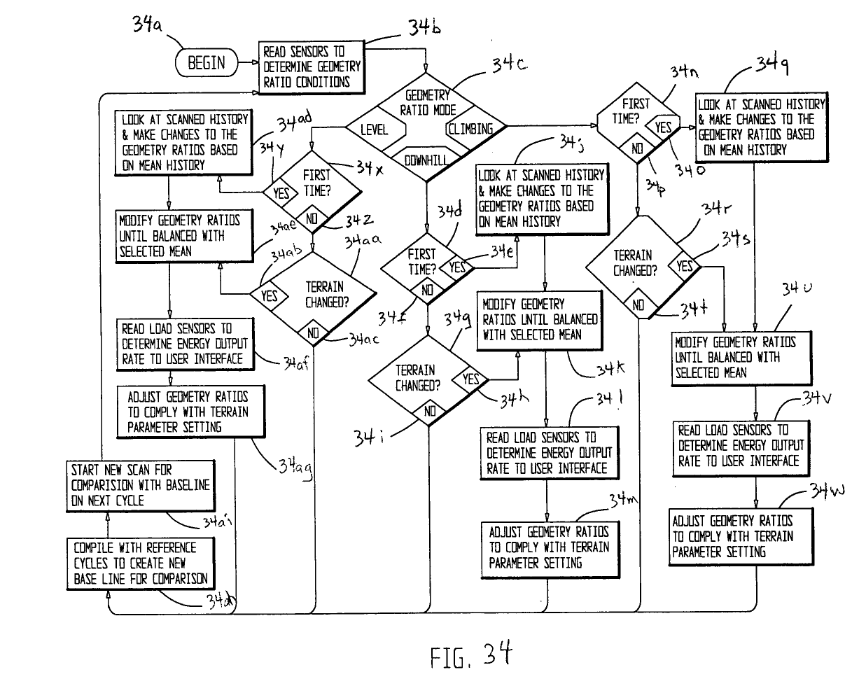

FIG. 32 depicts a control system and housing assembly 371x (referenced from FIG. 16 of U.S. Provisional Patent Application: Ser. No. 60/610,944—Filed Sep. 20, 2004, IMPROVEMENTS IN BICYCLE SYSTEMS AND METHODS, Inventor: Darrell W. Voss). Control system and housing assembly 371x comprises a control system 371, drive force reduction device 375, power assist control device 376, drive ratio control device 377, drive ratio change device 378, regenerative braking device 379, regenerative braking control device 380, drive force output device 381, drive force transfer device 382, output force sensor 383, velocity sensor 384, power generator control device 385, c/g shift control 386, data storage device 387, display/input device 388, auxiliary control system 389, auxiliary control device 390, suspension sensor 391, suspension device 392, geometry adjust control device 393, geometry adjust sensor 394, geometry adjust device 395, power storage control device 396, power storage device 397, power storage sensor 398, power generator device 399, power generator output sensor 400, vehicle drive device 401, and suspension control device 402. A power source 372 is supplied by user power 373 and or motor power 374. Control system and housing assembly 371x is within a vehicle, outside the vehicle frame structure, or in an attached vehicle function assembly in a central or regional location.

FIG. 33 is a logic flow sequence for adjusting device functions based on parameter shift values. The control system initiates a sensor reading sequence at step 406. Step 407 and step 408 are the sensor read steps for parameter shift a and parameter shift b respectively. Sensor data is then sent to the controller in step 410. The controller will calculate the parameter shift deltas at step 411. If the measured shift deltas are in an acceptable range per the control parameters then the control sequence will route through YES gate 413 back to sensor reading at steps 407 and 408. If the parameter shift deltas are out of range, then the control process routes through NO gate 414 to go onto step 415 to determine functions that require adjustment. Out of range high delta readings 416 will create output values sent by step 418 through to either device function A 420 or device function B 421. Out of range low delta readings 417 will create output values sent by step 417 to device function A 420 and device function B 421. The values determined at Step 415 may be output as null values, plus or minus values to make the adjustments required from the device functions.

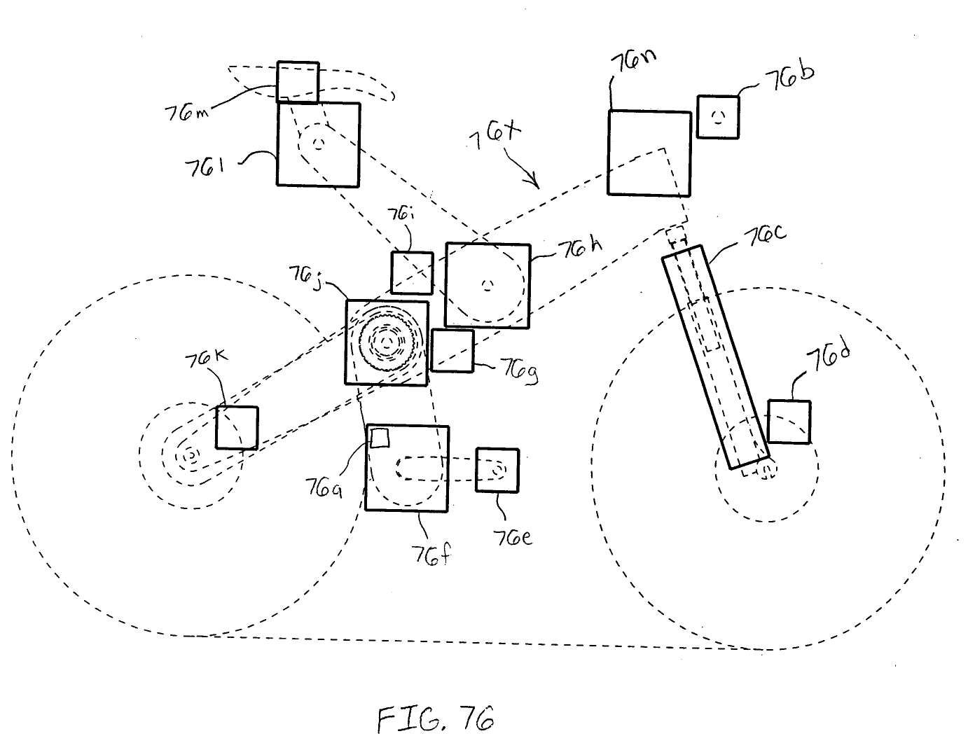

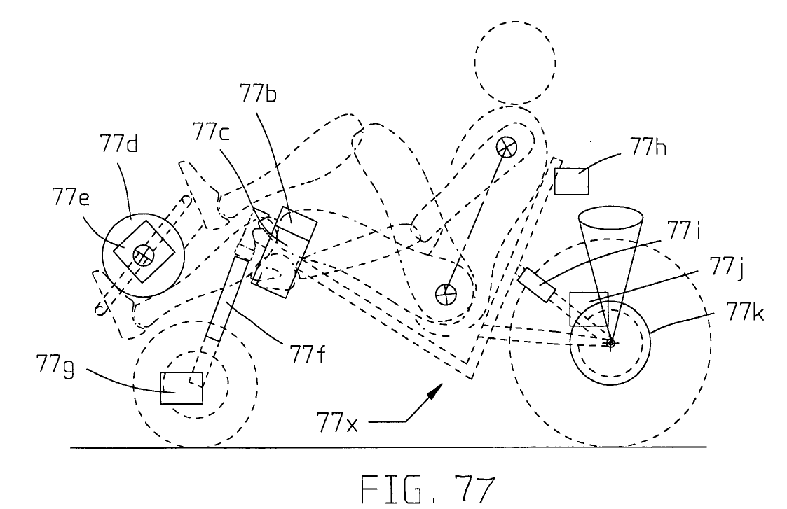

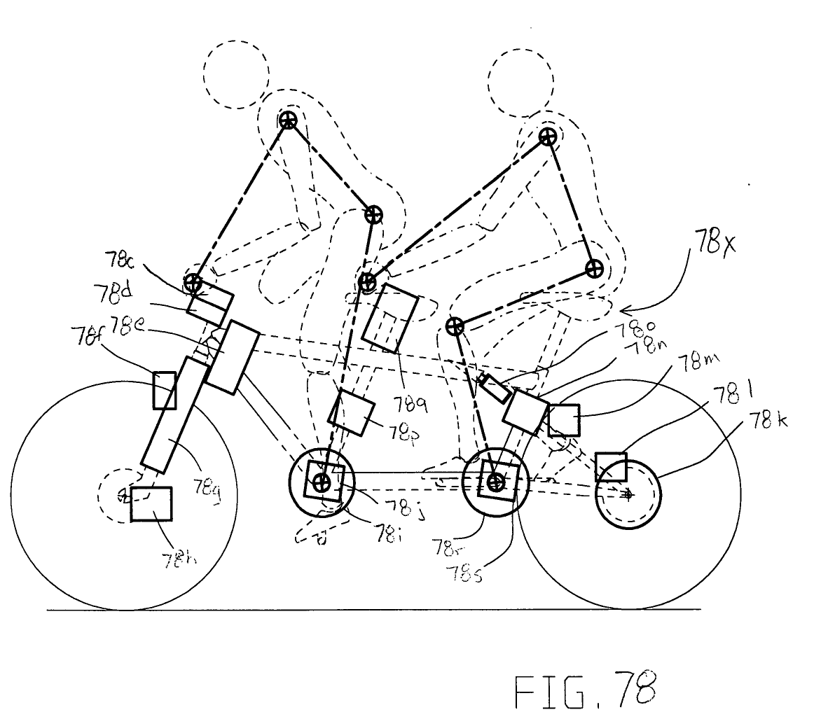

FIG. 34 is a logic flow diagram for a programmable control to show one manner of a controller decision cycle for geometry ratio changes using the embodiment of a control system assembly similar to control system 76a shown in FIG. 76. The initial control cycle sets the control system parameters to zero in begin cycle step34a, then initial geometry ratio shift measurements are taken at step34b. The geometry ratio mode is determined by the input 34c and the cycle path is routed to the corresponding start positions 34n, 34d, or 34x for the selected mode settings, Climbing, Downhill, and Level modes, respectively. The routing for the geometry ratio mode described as Climbing is, as follows. If the cycle is the first cycle then step 34n will send a signal through the YES gate 34o. The control system will then look up the scanned history and make changes (or not) based on the geometry ratio data 34q. The system will send a signal to regulate the geometry ratio until balanced with the load sensor data at step 34u. The system will read load sensors at step 34v to determine the energy output rate to user interface and adjust the geometry ratio to match terrain parameter conditions at step 34w. The system will compute the reference cycles to create a baseline 34ah to use as comparison for the next cycle then return to the beginning of the cycle through step 34ai which sends the signal to the geometry ratio shift measurements step 34b. If the cycle was not the first cycle at step 34n, then the control system would be routed through NO gate 34p to look up the terrain parameter values at step 34r to determine if the terrain parameter has changed from the baseline value, if yes then the signal is routed through YES gate 34s to steps 34u, 34v, 34w, 34ah, and 34ai. If the baseline value has not changed then the control signal would send the signal through the NO gate 34t to step 34ah and start the new scan process again through 34ai by returning to the beginning of the cycle at geometry ratio shift measurements 34b. An analogous procedure is followed for the Downhill mode using system parameter data designed for the optimal geometry ratio conditions for the mode. The control system routes through step 34d to determine if the scan is the first pass. A first time scan will be directed through the YES gate 34e to geometry ratio data 34j to lookup the scanned history and make changes to the geometry ratio based on mean history data. Routing then follows a similar sequence as the other modes; routing continues through to step 34k where the geometry ratios are balanced to match the selected mean parameter value. Load sensors are read in step 34l and step 34m adjusts geometry ratios to comply with terrain parameter settings for the Downhill mode. Then the signal routing is sent through step 34ah and step 34ai to compile with reference cycles and to start another scan process at step 32b. If the look up table at step34d is not the first cycle then the control system will route through NO gate 34f to step 34g to check if there has been a shift in terrain. If the terrain has changed, then the signal will route through the YES gate 34h to process through control steps 34k, 34l, 34m, 34ah, and 34ai. Step 34ai sends the process back to the beginning for geometry ratio shift measurements at step 34b. If at step 34g, the control determines the terrain has not changed, then the control process is sent through step 34ah and step 34ai back to the beginning geometry ratio shift measurements step 34b. Another analogous procedure is followed for the Level mode using system parameter data designed for the optimal geometry ratio positions for the mode. The control system 34c Level mode setting routes 34x to check if this is the first pass. If this is the first pass, the signal is sent through the YES gate 34y to look up the scanned history at step 34ad. Geometry ratios are modified until balance with the mean parameter values derived at step 34ae. The control then reads load sensors to determine energy output rate to user interface at step 34af. Geometry ratios are adjusted to comply with the terrain parameter setting in step 34ag. After adjustments are made, the control process goes to step34ah to compile with the reference cycles to create an updated mean baseline value. Step 34ai then initiates a new scan process back to geometry ratio shift measurements at step 34b. If the process was not on the first pass at step 34x, then the signal will route through the NO gate 34z on to step 34aa. At step 34aa, the control system determines if a terrain parameter shift has occurred and if so, the signal is routed through the YES gate 34ab to step 34ae to modify the geometry ratios until balanced with the mean parameter value. At this point, the control system will follow the steps 34af and 34ag to read sensors and adjust the geometry ratios to match the terrain parameter setting values for the Level mode. After the geometry ratio adjustments are made, the cycle will continue through to steps 34ah and 34ai to compile with the reference cycles and to start a new scan with the adjusted baseline in place. If the control system at step 34aa determines the terrain has not changed, then the signal will be sent through the NO gate 34ac to steps 34ah and 34ai to compile and begin a new scan.

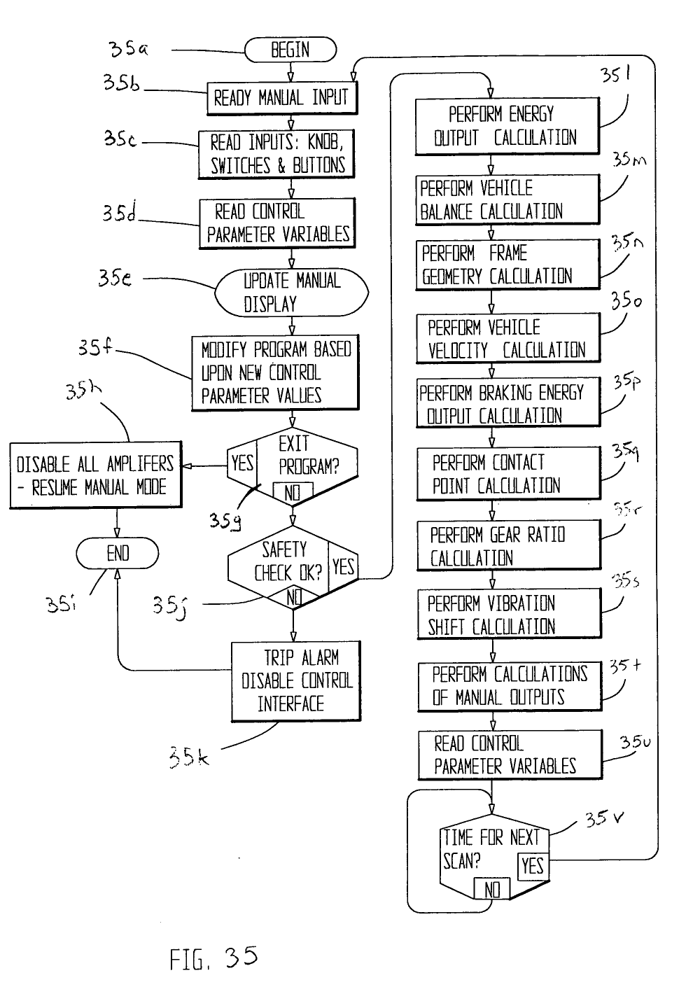

FIG. 35 is a flow diagram example for external inputs to effect changes in control system parameters by manual inputs from a user or technician. The control system runs a sensor input cycle beginning at step 35a. The cycle will look for manual input first in step 35b. Knobs, switches, buttons, and other driver inputs are looked for in step 35c. A wait state step 35d to read variable condition states follows. A technician display or other output device is updated in step 35e. The controller modifies the program parameters based on new variable values at step 35f. The cycle will pause briefly at step 35g to determine if a program stop or exit command has been entered either by manual or automatic mode. If the exit command is read the cycle will move to step 35h, stop and switch to manual mode, then close cycle loop at step 35i. The cycle will continue to step 35j and make a system safety check before proceeding to step 35k if the safety mode is tripped or continue on to perform a sequence of sensor measuring functions shown as steps 35l, 35m, 35n, 35o, 35p, 35q, 35r, 35s, 35t, and 35u. After inputs from the sensor steps, the controller will read the variable states and determine if changes have occurred. The decision step 35v will send the cycle loop out after a timer wait state is reached. Then the cycle will begin again at step 35b.

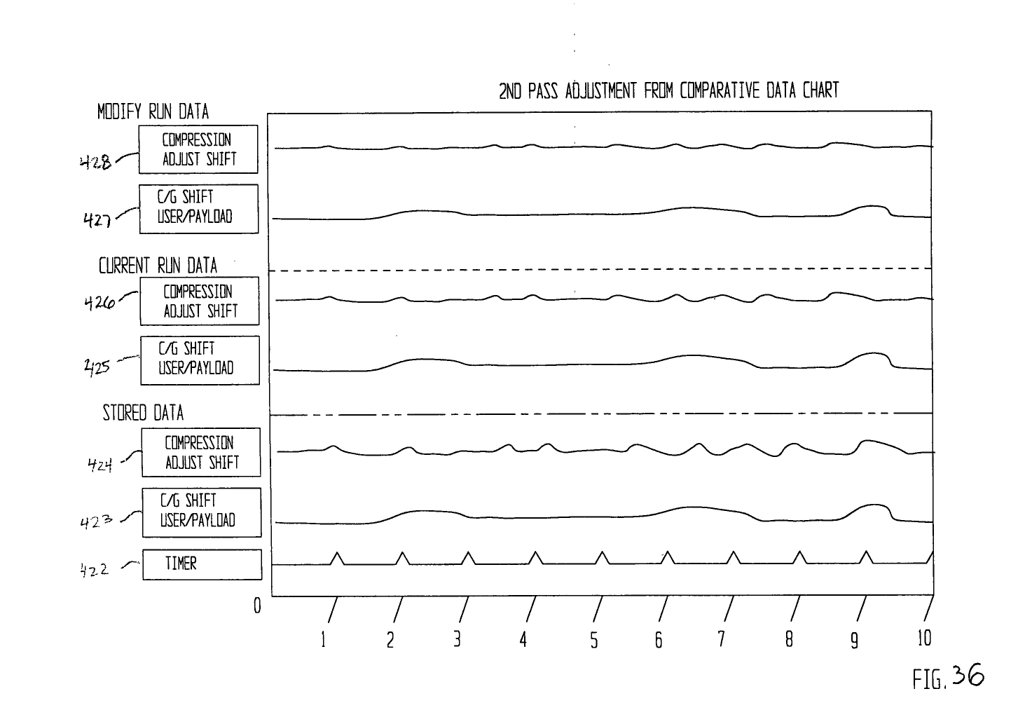

FIG. 36 is a chart representation of a control system using stored data as a baseline and the actively sensed control parameter shifts to make corrective output signals for adjustments to the control functions. C/G user/payload shift stored data 423 and compression adjust shift stored data 424 is compared to c/g user/payload shift current data 425 and compression adjust current data 426 at the read data cycle established by timer 422. C/G user/payload shift corrected data 427 and compression adjust corrected data 428 are generated for storing into a data storage device attached to the control system.

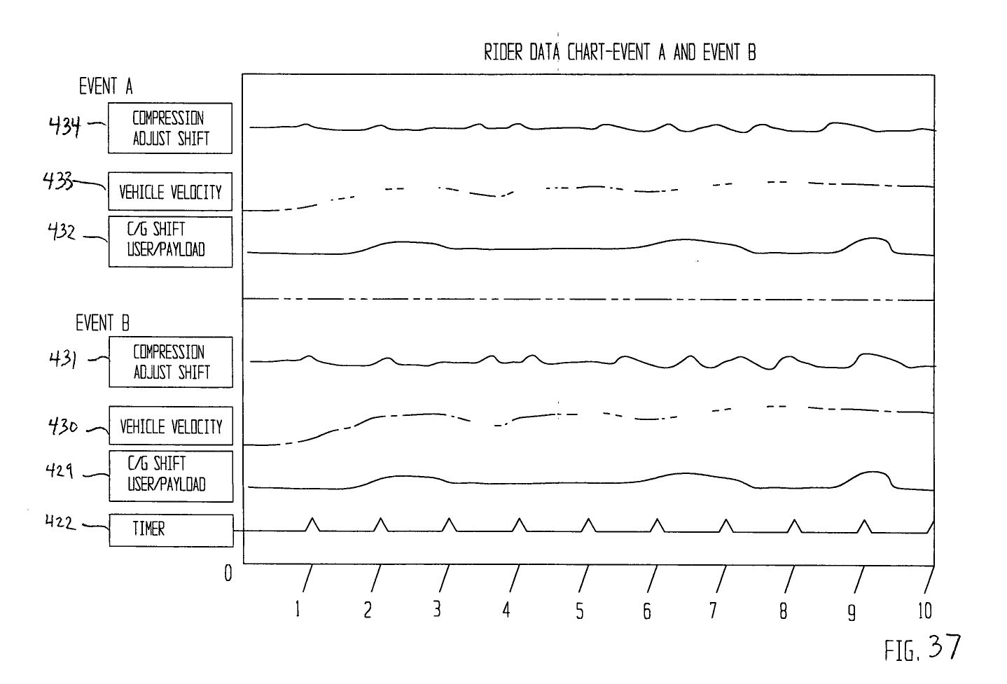

FIG. 37 is a chart representation of a control system using stored data from multiple passes on a closed course, from events at different locations, or under different terrain parameter conditions. C/G user/payload shift event b data 429, vehicle velocity event b data 430, and compression adjust shift event b data 431 are recorded at the read data cycle established by timer 422. C/G shift user/payload event a data 432, vehicle velocity event a data 433, and compression adjust shift event a data 434 are recorded at the same read data cycles established by timer 422. The event data is then used by the control system to establish as a baseline to improve controlled function performance on succeeding passes.

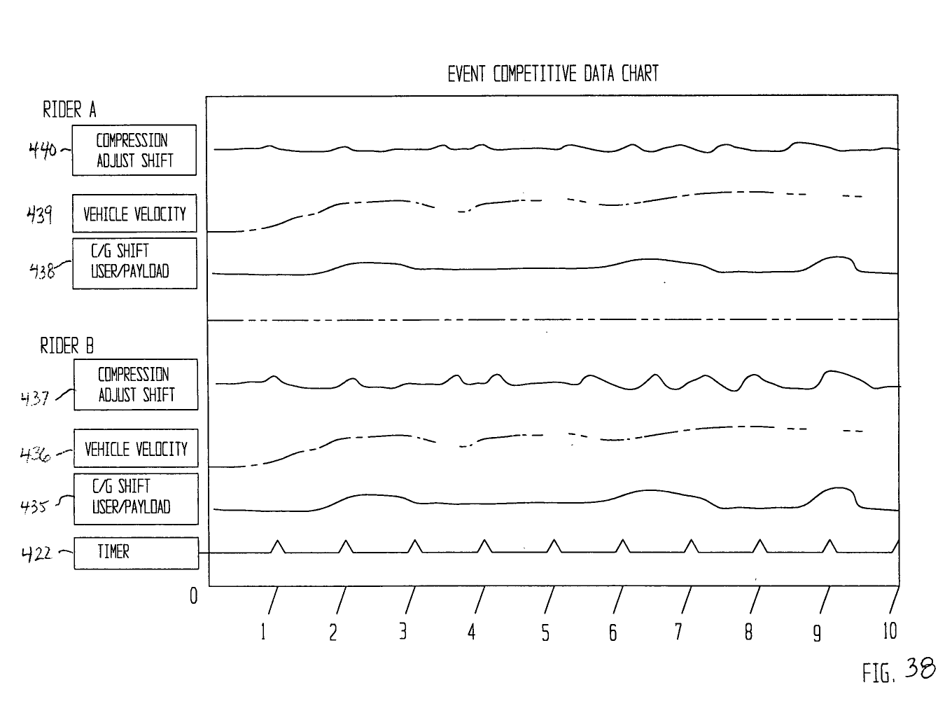

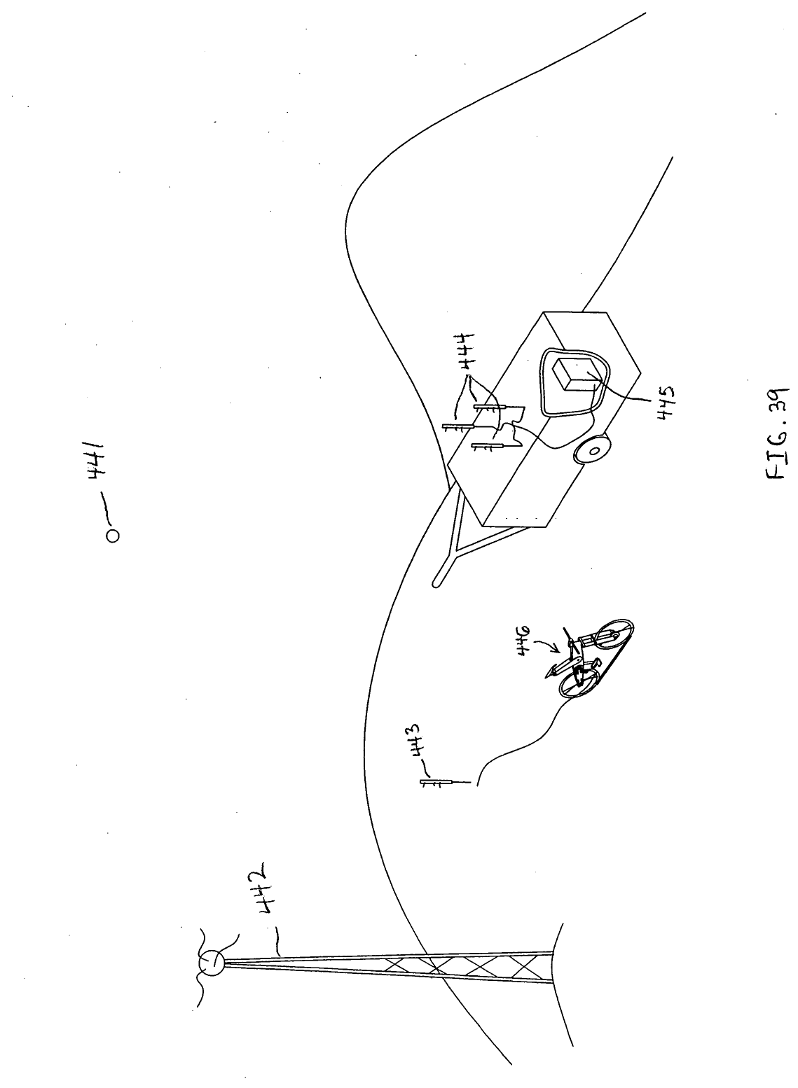

FIG. 38 is a chart representation of a control system using parameter data to evaluate control function performance measurements comparative from one user to another. The comparative data is used as stored data for later user input, as display data input for user current performance evaluation, or as parameter control feedback for active controlled function modifications. C/G user/payload shift rider b data 435, vehicle velocity rider b data 436, and compression adjust shift rider b data 437 are recorded at the read data cycle established by timer 422. C/G shift user/payload rider a data 438, vehicle velocity rider a data 439, and compression adjust shift rider a data 440 are recorded at the read data cycles established by timer 422.

FIG. 39 depicts a bicycle assembly 446 with controllable functions on a controlled course where sensors are located off the vehicle to provide parameter inputs to the external control system 445.Global positioning system 441, microwave tower 442, and path sensor 443 transmit parameter shift signals inputs to external control system 445. External control system 445 uses infrared and wireless communication methods through mobile unit output signals 444 to provide output signals to the controllable functions on bicycle assembly 446. External control system 445 is mounted in or on a mobile unit or at a fixed location.

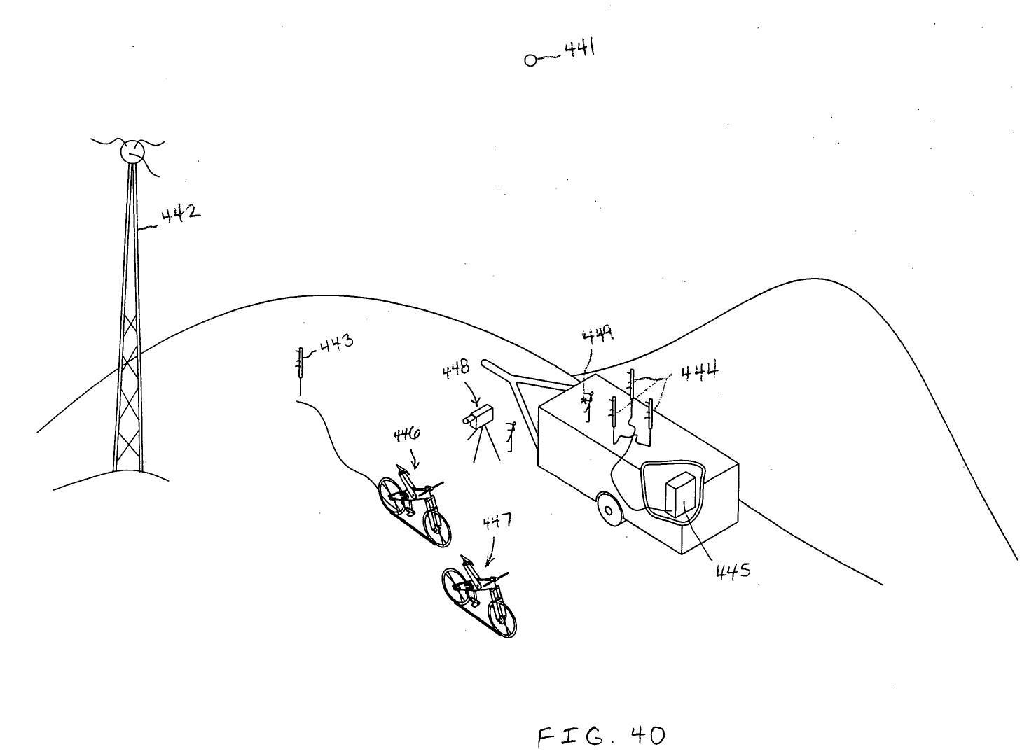

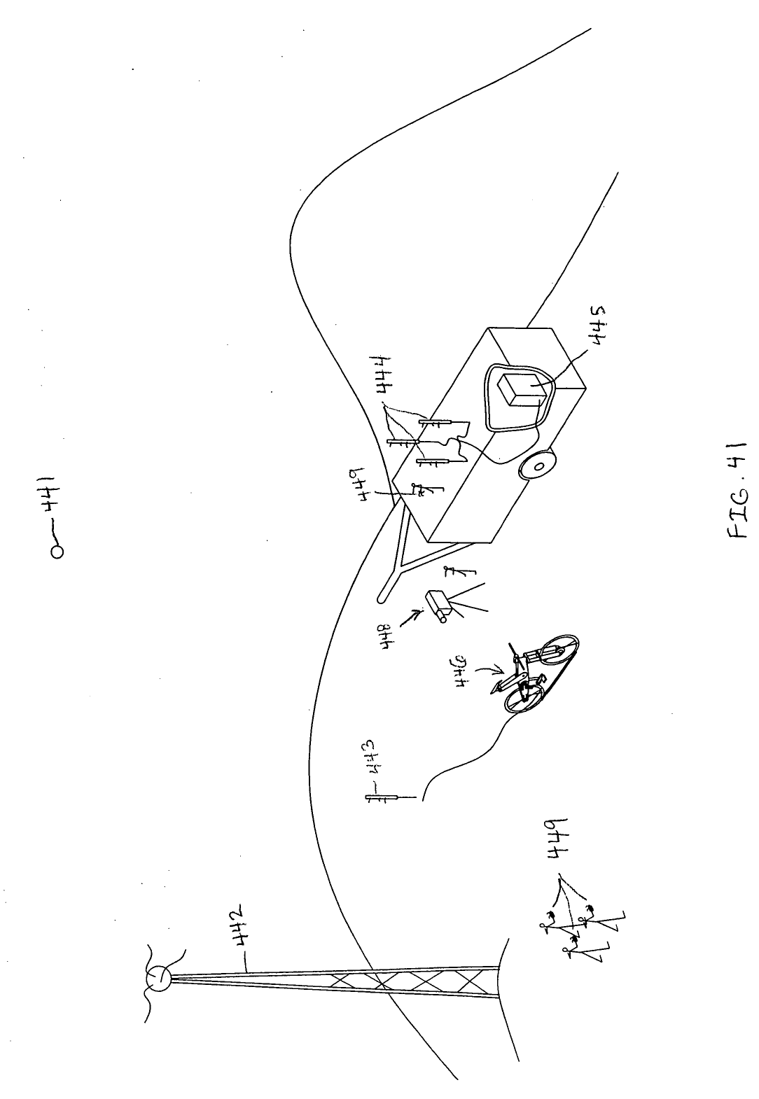

FIG. 40 depicts bicycle assembly 446 and bicycle assembly 447 both with controllable functions on a controlled course where sensors are located off the vehicles to provide parameter inputs to the external control system 445. Global positioning system 441, microwave tower 442, path sensor 443, and imaging unit 448 transmit parameter shift signals inputs to external control system 445. External control system 445 uses infrared and wireless communication methods through mobile unit output signals 444 to provide output signals to the controllable functions on bicycle assembly 446 and bicycle assembly 447. Sensor parameter shift data and mobile unit output signals 444 are also sent to hand held display 449 for performance data and comparative data evaluation by a technician.

FIG. 41 depicts a bicycle assembly 446 with controllable functions on a controlled course where sensors are located off the vehicle to provide parameter inputs to the external control system 445. Global positioning system 441, microwave tower 442, path sensor 443, and imaging unit 448 transmit parameter shift signals inputs to external control system 445. External control system 445 uses infrared and wireless communication methods through mobile unit output signals 444 to provide output signals to the controllable functions on bicycle assembly 446. Sensor parameter shift data and mobile unit output signals 444 are also sent to hand held display 449 for performance data and comparative data evaluation by event spectators or broadcast media.

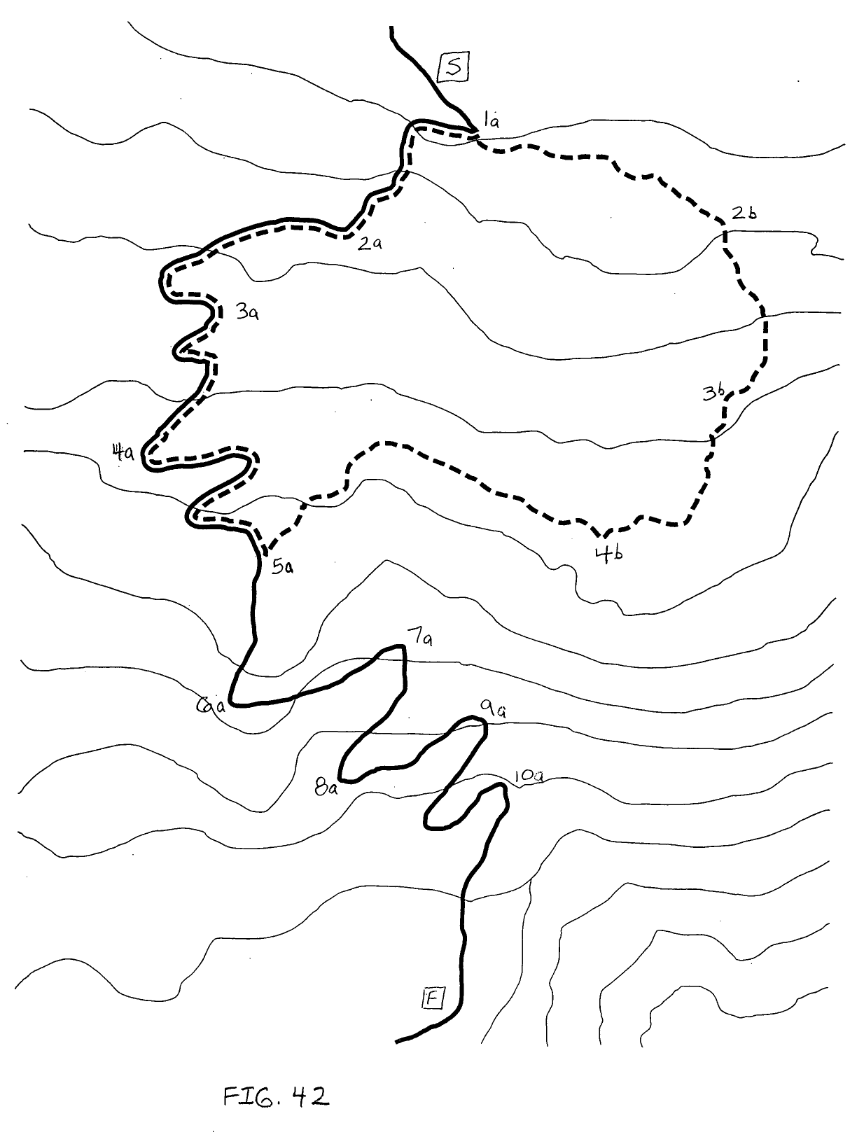

FIG. 42 is a topographical chart for a course-race-event route map showing established data timing locations S, 1a, 2a, 3a, 4a, 5a, 6a, 7a, 8a, 9a, 10a, 2b, 3b, 4b, and F. Course sensors and timers for parameter control data capture are located at the data timing locations. This method provides a data capturing and performance monitoring process for a controlled event site or an amusement or theme park.

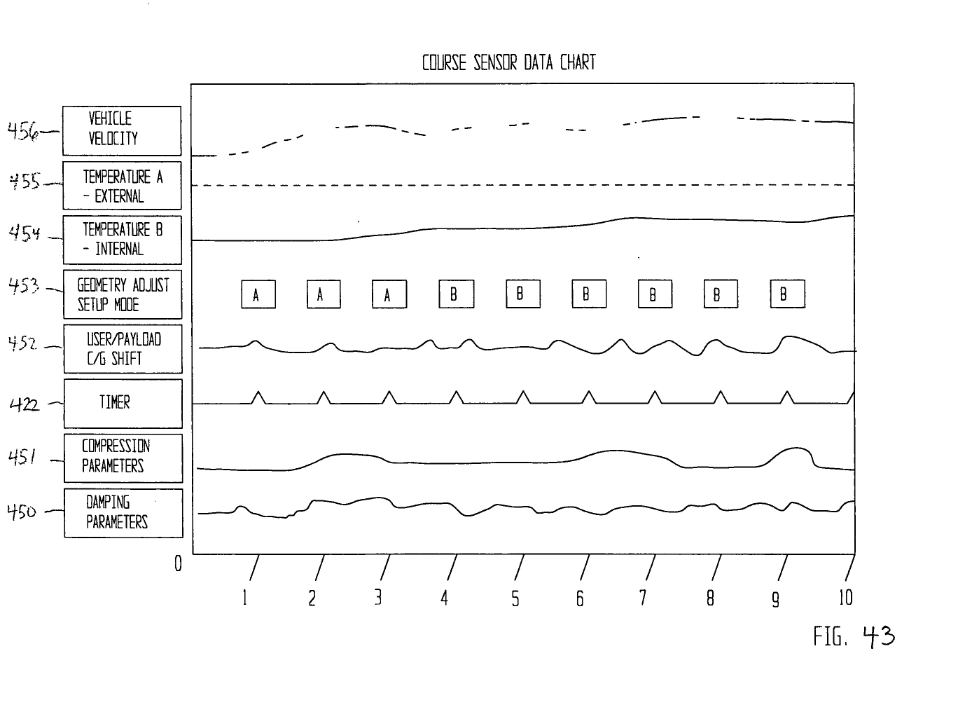

FIG. 43 is a chart representation of data recorded at the data locations of FIG. 42. Damping parameters 450, compression parameters 451, c/g user/payload shift parameter 452, geometry adjust setup mode 453, temperature B-internal 454, temperature A-internal 455, and vehicle velocity 456 are key control parameter shift measures recorded at the read data cycles established by timer 422.

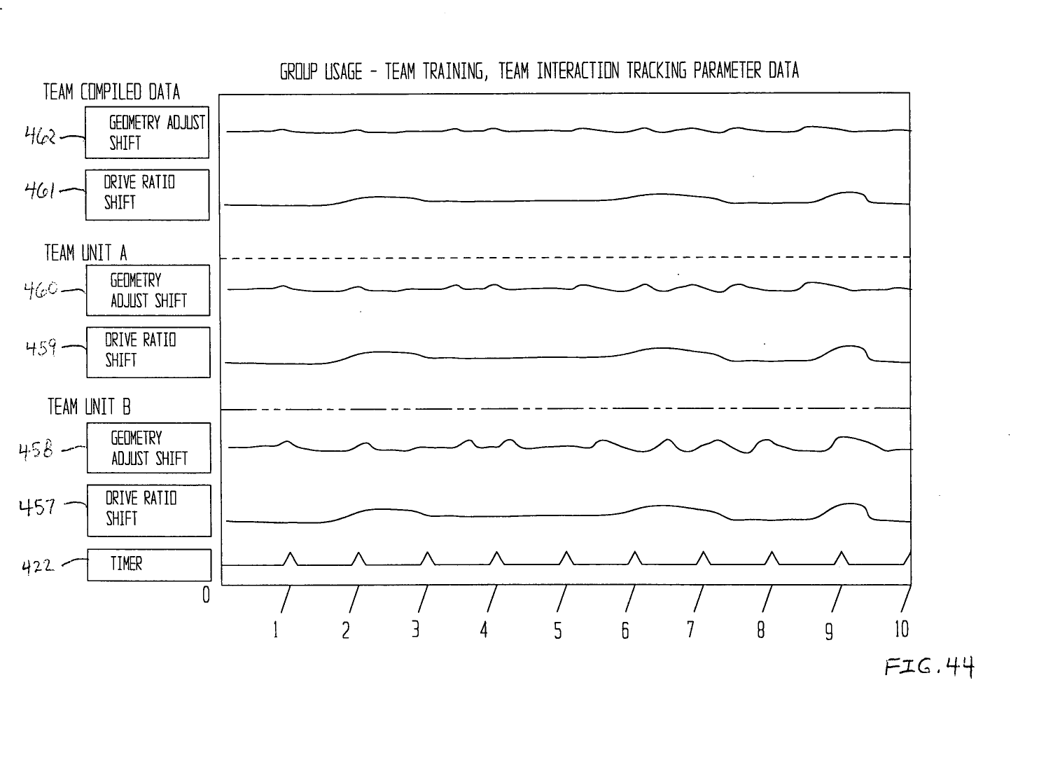

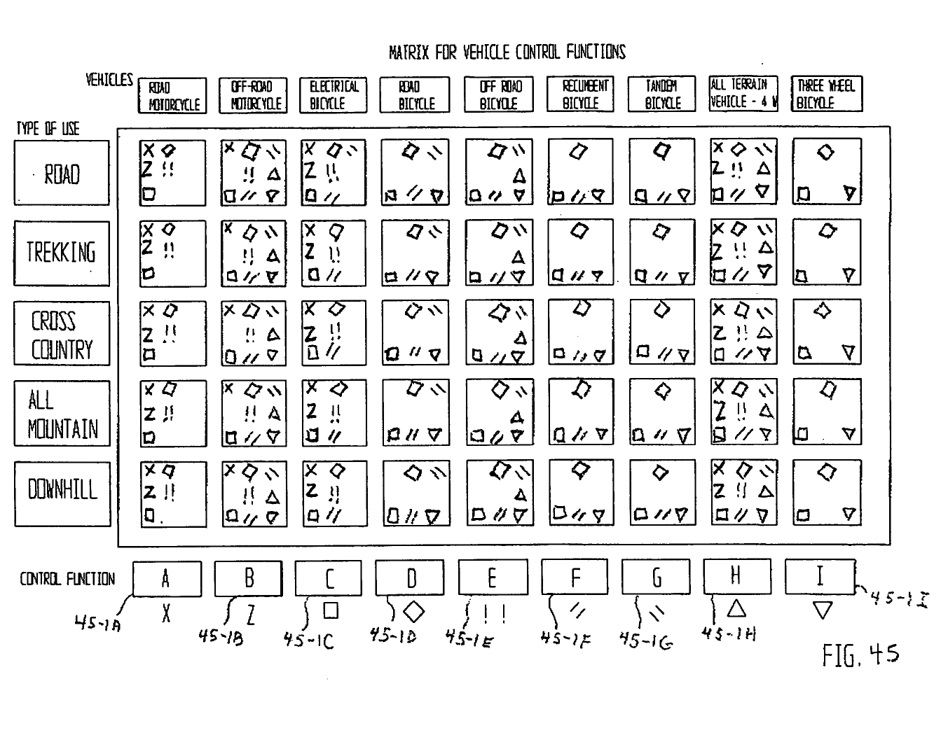

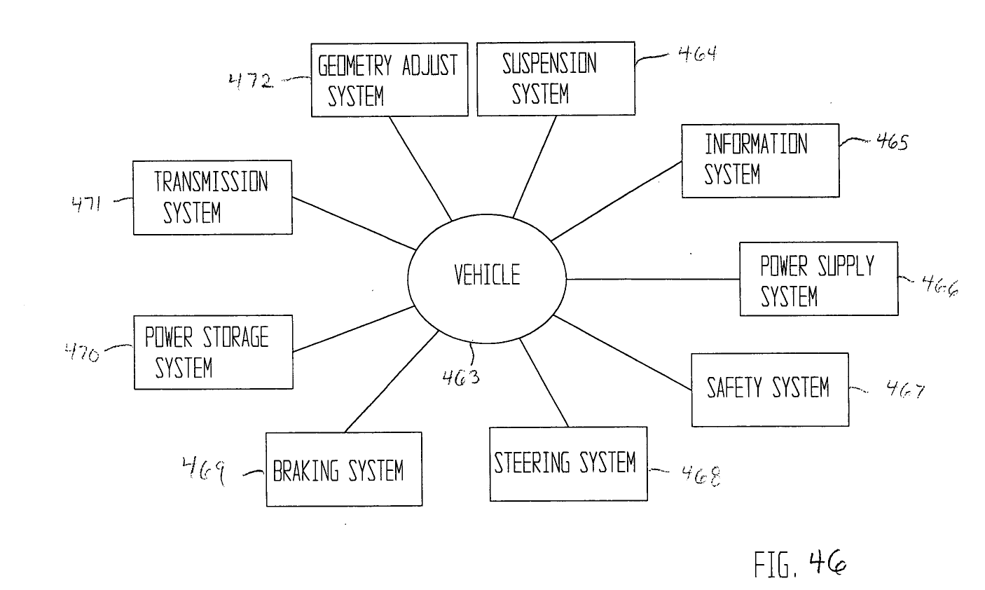

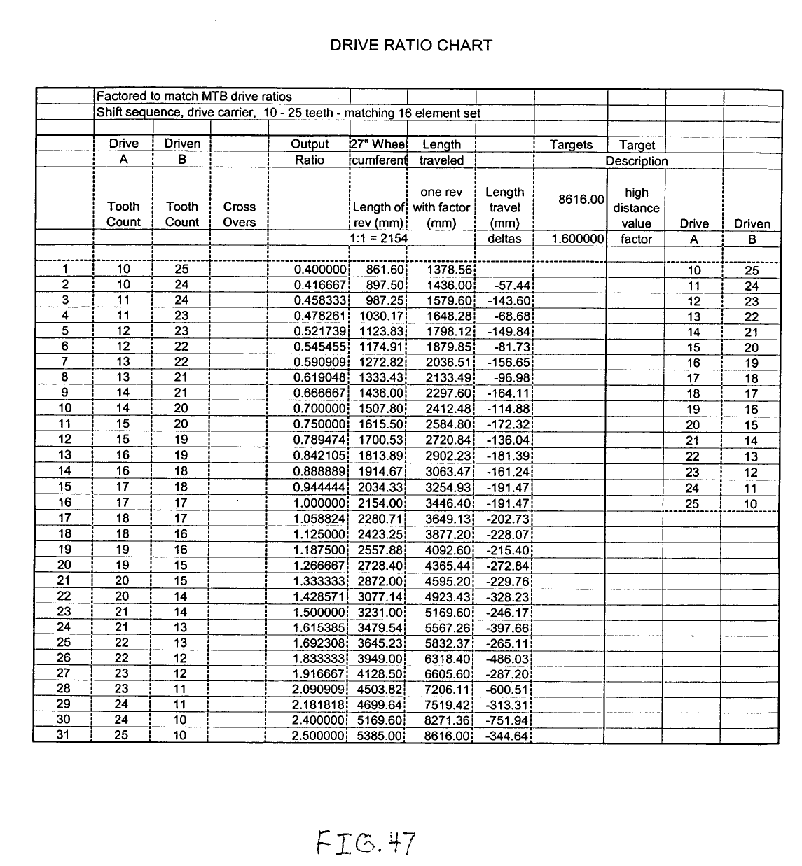

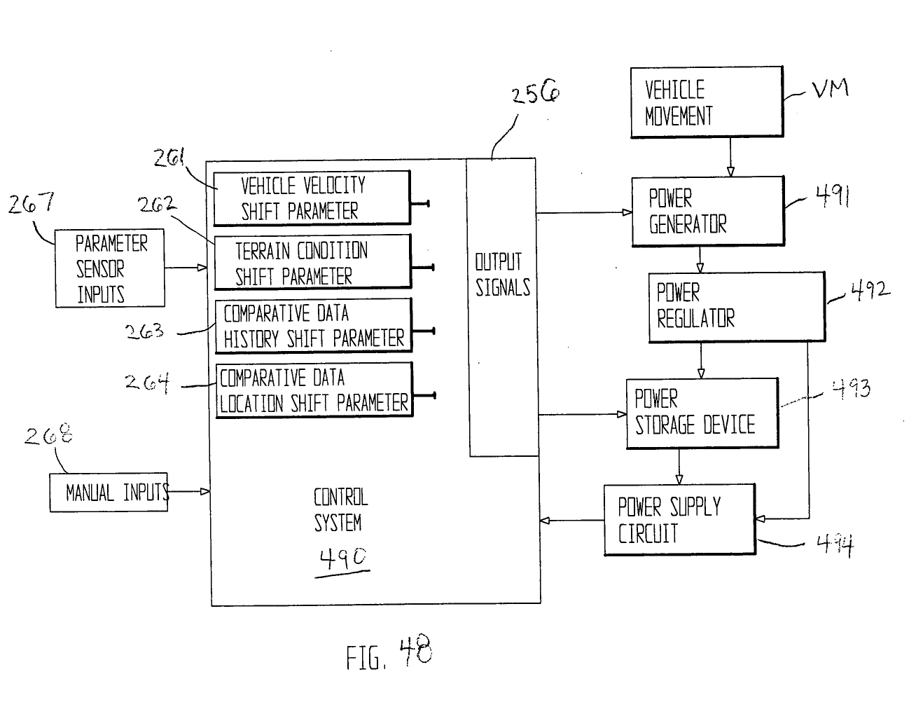

FIG. 44 is a chart representation of a control system using parameter data to evaluate control function performance measurements comparative from one team to another. The comparative data is used as stored data for later user and team input, as display data input for user or team current performance evaluation, or as parameter control feedback for active controlled function modifications of team vehicles. Team B drive ratio shift data 457, team B geometry adjust shift data 458, team A drive ratio shift data 459, and team A geometry adjust shift data 460 are recorded at the read data cycle established by timer 422. Team compiled mean data is established and recorded as drive ratio shift compiled data 461 and geometry adjust shift data 462. The control system data capture is beneficial for team training, team development, and compiling team interaction data.

FIG. 45 is a chart representation of a matrix of control functions, categories of use, and vehicle types. Controllable functions of the vehicle are determined based on most likely to affect the ride characteristics of the vehicle during use in the type of ride category chosen. Control function 45-1A represents a vehicle power system. Control function 45-1B represents a vehicular external lighting system. Control function 45-1C represents a structural frame geometry control system. Control function 45-1D represents a transmission drive ratio shift system. Control function 45-1E represents a power generator and storage system. Control function 45-1F represents a spring rate function. Control function 45-1G represents a damper rate control function. Control function 45-1H represents a spring travel adjust system. Control function 45-1I represents a damper travel adjust system. The control system defined herein dynamically adjusts vehicular control functions individually, in paired sets, in groups, in series, in parallel, and combinations thereof to provide improved ride characteristics for the vehicle.

FIG. 46 is a graphic illustration of a vehicle system overview. Vehicle 463 comprises the attached vehicle operating systems; suspension system 464, information system 465, power supply system 466,safety systems 467, steering system 468, braking system 469, power storage system 470, transmission system 471, and geometry adjust system 472. Each vehicle operating system has one or more controllable functions. The control system 1 controls an operating system individually, in combination, controlled functions from one system, or controlled functions from two or more vehicle operating systems.

FIG. 47 is a graphic chart of transmission drive ratio data from a transmission system. A control system as depicted in FIG. 1 controls the transmission drive ratio function to provide an efficient energy power band for the vehicle user.

FIG. 48 is a block diagram of vehicle controlled power generation and power storage functions. A power generator captures energy created from the vehicle movement, converts into electrical energy, and outputs the electric power through a power regulator 492 which controlled by the control system 490 sends the power to a power storage device 493 or to the power supply circuit 494 for the control system 490. Control system 490 sends output signals 256 to the control functions shown.

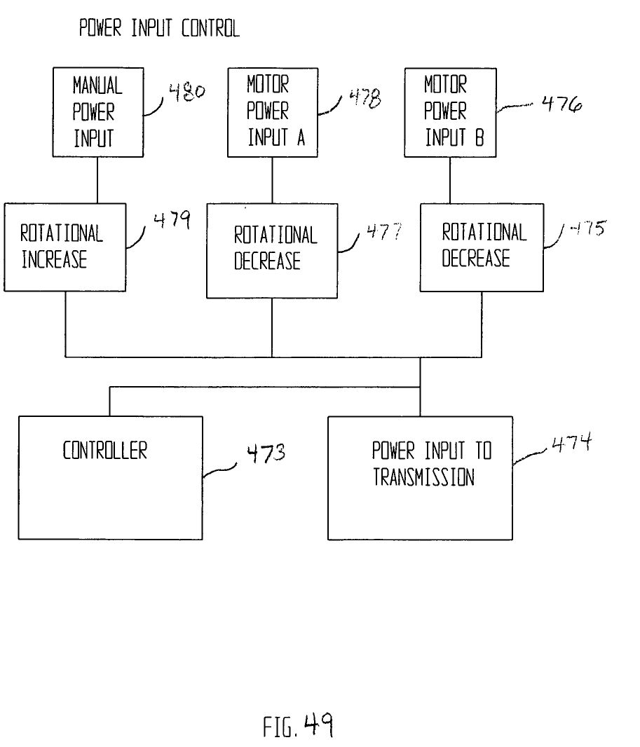

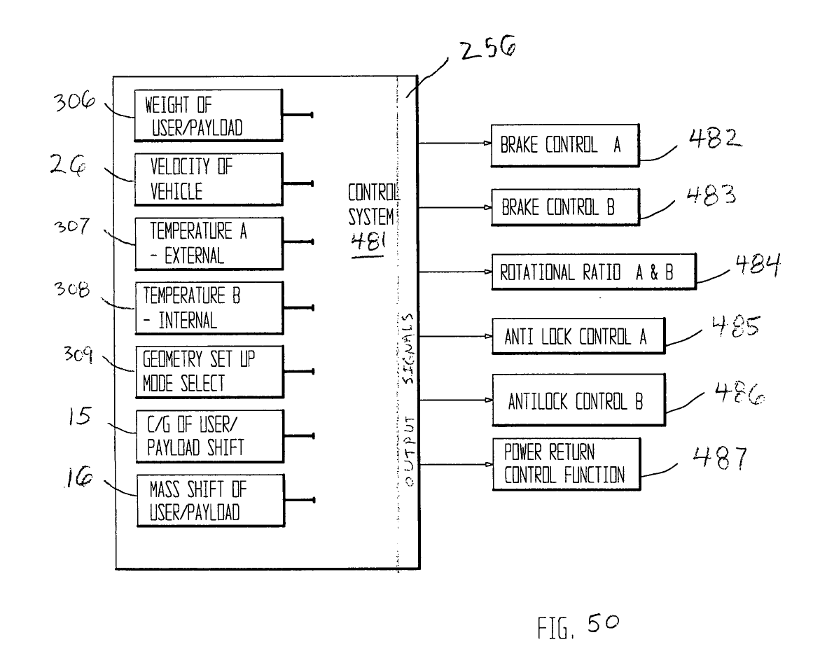

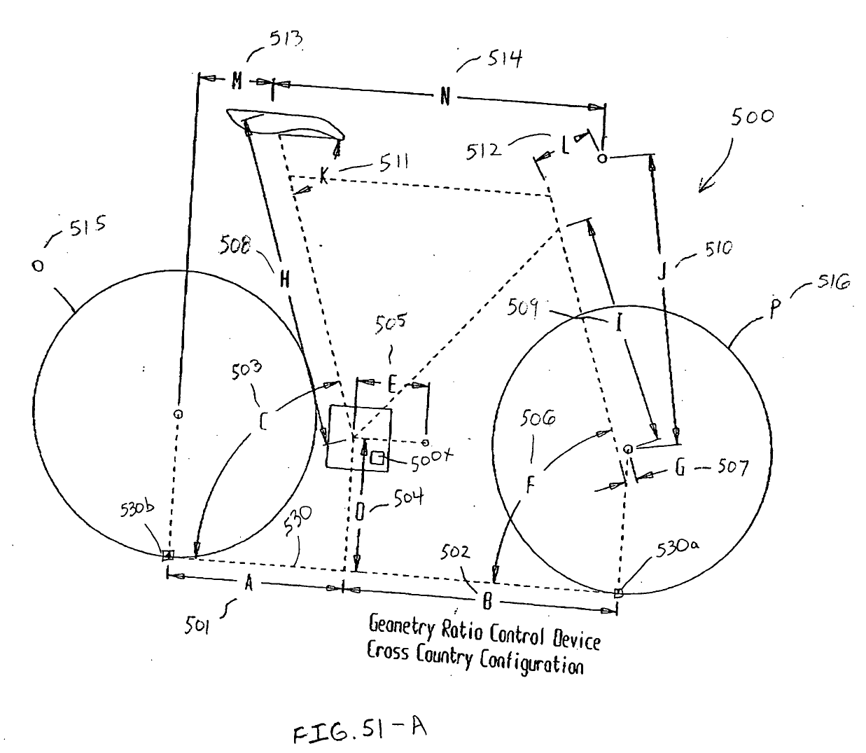

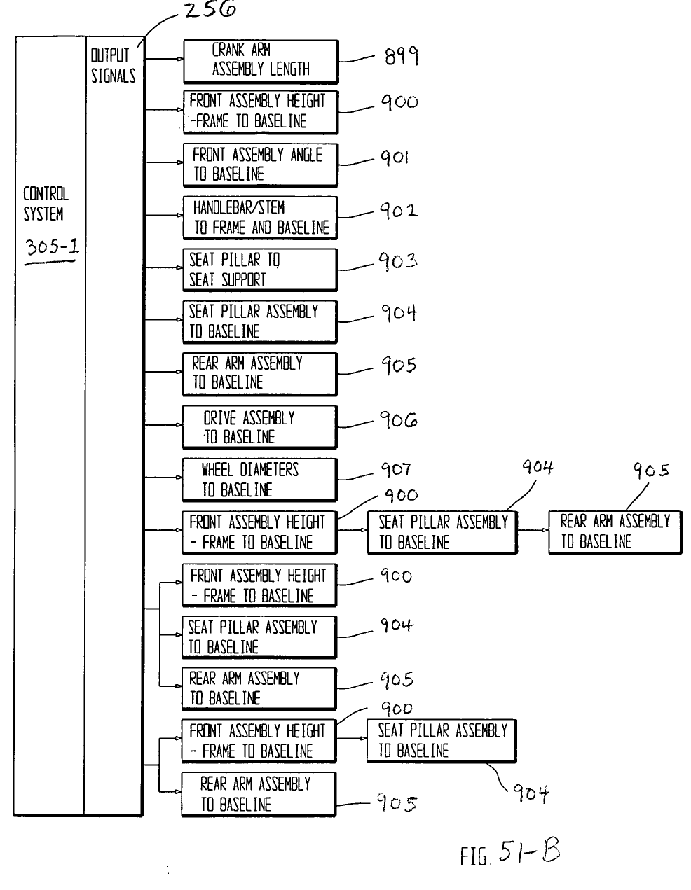

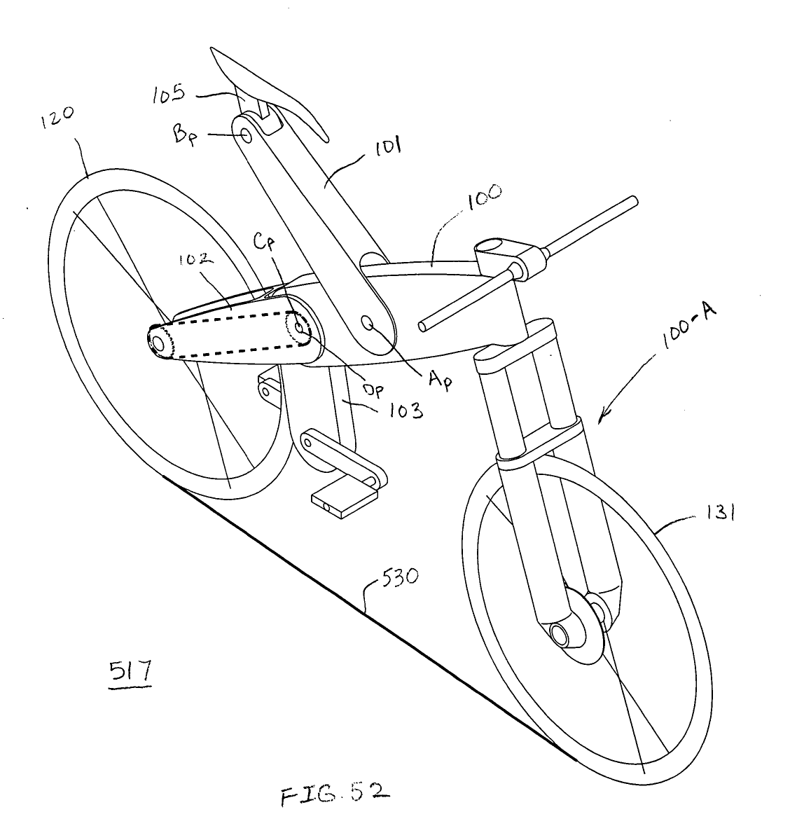

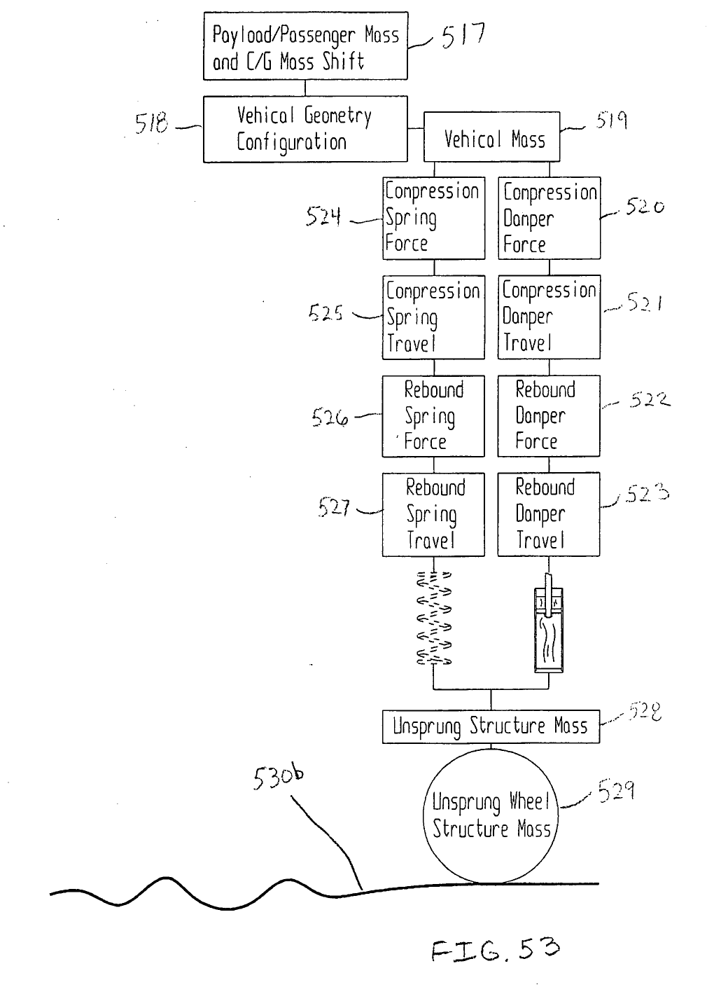

FIG. 49 is a graphical illustration of a power input control. Controller 473 adjusts the power input ratios of the power input to transmission 474 by controlling the manual power input 480 with rotational increase step 479, motor power a input 478 with rotational decrease step 477, and motor power b input 476 with rotational decrease step 475. The power supply connections are applicable as primary power supplies or as supplemental power supplies. The controller 473 reduces the output rotational speed of the motor power a input 478 and motor power b input 476 to more closely match the rotational speed of manual power input 480. The controller 473 will adjust the power supplies ratio range from 100 percent to 0 percent. The rotational speed increase of the human power supply and the rotational speed decrease of the motor power supplies provide a more closely balanced rotational input speed to the transmission assembly. The balanced speed inputs results in improved drive ratio transitions when switching between the power supplies or when one power supply provides a greater percentage of the power mix than the other power supply.

FIG. 50 depicts control system 481 which using control parameters weight of user/payload 306, vehicle velocity shift parameter 26, temperature A-external 307, temperature B-internal 308, geometry setup mode select 309, center of gravity of user/payload to vehicle shift parameter 15, mass shift of user/payload to vehicle parameter 16 to send output signals 256 to brake system controllable functions brake control A 482, brake control B 483, rotational ratio A & B 484, anti lock control A 485, anti lock control B 486, and power return control function 487.

FIG. 51-A depicts geometry adjustable dimensions of a representative two-wheel vehicle 500 similar to a bicycle with geometric adjustable ratios (reference from FIG. 7 of U.S. Provisional Patent Application Ser. No. 60/610,944, Improvements in Bicycle Systems and Method, Darrell W. Voss, filed Sep. 20, 2004). The baseline for vehicle dimensions is baseline 530 which is the line representing the points of contact of the vehicle to the ground by ground contact points 530a and 530b. Dimension A—centerline of BB to rear wheel baseline contact distance 501, dimension B—centerline of BB to front wheel baseline contact distance 502, dimension C—seat tube centerline to baseline plane angle 503, dimension D—BB centerline to baseline distance 504, dimension E—crank arm pivot to pedal center distance 505, dimension F—front arm to baseline plane angle 506, dimension G—front wheel mount offset to head tube centerline 507, dimension H—top of seat center to BB centerline distance 508, dimension I—front arm frame mounting point to front wheel center distance 509, dimension J—handlebar centerline to front wheel center distance 510, dimension K—seat to seat tube angle 511, dimension L—head tube centerline to handlebar centerline distance 512, dimension M—top of seat center to rear wheel center distance 513, dimension N—top of seat center to handlebar centerline distance 514, dimension O—rear wheel diameter 515, dimension P—front wheel diameter 516 are adjustable through geometry adjust devices with controllable functions by representative control system 500x. Geometry adjustments of dimensions are selectable individually, in series, in parallel, or in a series/parallel combination. Geometry adjustments are adjustable as pre-selected static positions or as dynamic positions during operation.

FIG. 51-B depicts an embodiment of a control system for controlling the geometric dimensions from the array of dimensional adjustments possible in ratio relationships of the dimensions shown in FIG. 51-A when applied to the representative bicycle shown in FIG. 52. Geometry adjust control functions affect one or more vehicle geometric dimensions. Geometric adjustable control function 899 is an example of the geometric adjustment of one geometric dimensional aspect of the vehicle through the adjustment of the dimension E-crank arm pivot to pedal center distance 505. The following group of geometry adjust control functions affect two or more vehicle dimensions. The control system 305-1 adjusts geometry adjust control functions 899, 900, 901, 902, 903, 904, 905, 906, and 907 individually. Geometry adjustable control function 900 is the geometric adjustment of the front assembly height to frame from the front wheel center which affects the following dimensions; dimension B—centerline of BB to front wheel baseline contact point 530a distance 502, dimension F—front assembly to baseline angle 506, dimension G—front assembly wheel mount offset to head tube centerline 507, dimension G—front arm mount offset to head tube centerline 507, dimension I—front arm frame mounting point to front wheel center distance 509, and dimension J—handlebar centerline to front wheel center distance 510. Geometry adjust function 901 is the geometric adjustment of the front assembly angle to the baseline which affects the following dimensions; dimension B—centerline of BB to front wheel baseline contact distance 502, dimension F—front arm to baseline plane angle 506, dimension G—front assembly wheel mount offset to head tube centerline 507, and dimension J—handlebar centerline to front wheel center distance 510. Geometry adjust function 902 is the geometric adjustment of the handlebar/stem distance to the frame and front wheel center which affects the following dimensions; dimension J—handlebar centerline to front wheel center distance 510, dimension L—head tube centerline to handlebar centerline distance 512, and dimension N—top of seat center to handlebar centerline distance 514. Geometry adjust function 903 is the geometric adjustment of the seat support angle to the seat pillar in relationship to the baseline which affects the following dimensions; dimension H—top of seat center to BB centerline distance 508, dimension K—seat to seat tube angle 511, dimension M—top of seat center to rear wheel center distance 513, and dimension N—top of seat center to handlebar centerline distance 514. Geometry adjust function 904 is the geometric adjustment of the seat pillar angle to the baseline which affects the following dimensions; dimension C—seat tube centerline to baseline plane angle 503, dimension M—top of seat center to rear wheel center distance 513, and dimension N—top of seat center to handlebar centerline distance 514. Geometry adjust function 905 is the geometric adjustment of the rear arm assembly in relation to the baseline which affects the following dimensions; Dimension A—centerline of BB to rear wheel baseline contact distance 501, dimension C—seat tube centerline to baseline plane angle 503, dimension D—BB centerline to baseline distance 504, dimension F—front arm to baseline plane angle 506, dimension H—top of seat center to BB centerline distance 508, dimension M—top of seat center to rear wheel center distance 513, and dimension N—top of seat center to handlebar centerline distance 514. Geometry adjust function 906 is the geometric adjustment of the drive assembly of a vehicle as shown in FIG. 52 which affects the following dimensions; Dimension A—centerline of BB to rear wheel baseline contact distance 501 and dimension D—BB centerline to baseline distance 504. Geometry adjust function 907 is the geometric adjustment of the wheel diameters to the baseline which affects the following dimensions; dimension D—BB centerline to baseline distance 504, dimension O—rear wheel diameter 515, and dimension P—front wheel diameter 516. Control system 305-1 controls the geometry adjust control functions in series as shown by the serial control of geometry adjust control functions 900, 904, and 905. Control system 305-1 controls the geometry adjust control functions in parallel as shown by geometry adjust control functions 900, 904, and 905 operating concurrently. Geometry adjust control functions are controllable by control system 305-1 in a combined serial and parallel process as shown by the control of geometry adjust control function 900 and 904 in series and parallel with geometry adjust control function 905.

FIG. 52 depicts bicycle assembly 517 incorporating geometry adjustable features which allow control functions to make positional shifts in the dimensions depicted in FIG. 51-A. Bicycle assembly 517 incorporate geometry adjustable features through the pivotably rotatable positions of seat pillar 101, seat support 105, rear arm assembly 102, and transmission drive ratio assembly 103 in relation to the frame 100 structure and in relationship to each other. Wheel assemblies 131 and 120 contact to the baseline 530 defines the ground baseline through the centers of the wheel assembly hubs to the bicycle geometry connection and pivot points Ap, Bp, Cp, and Dp.

FIG. 53 is a diagram of the vehicle and user relationships to an unsuspended wheel and structure mass 529. The relationship of the payload/passenger mass and c/g mass shift 517 to the vehicle geometry configuration 518 is dependent upon vehicle mass 519 and the supporting suspension control functions compression damper force 520, compression damper travel 521, rebound damper force 522, rebound damper travel 523, compression spring force 524, compression spring travel 525, rebound spring force 526, rebound spring travel 527 that are connected to the unsuspended vehicle mass 528. As the vehicle travels over terrain 530b, the suspension control functions are adjusted to improve the ride characteristics for the vehicle.

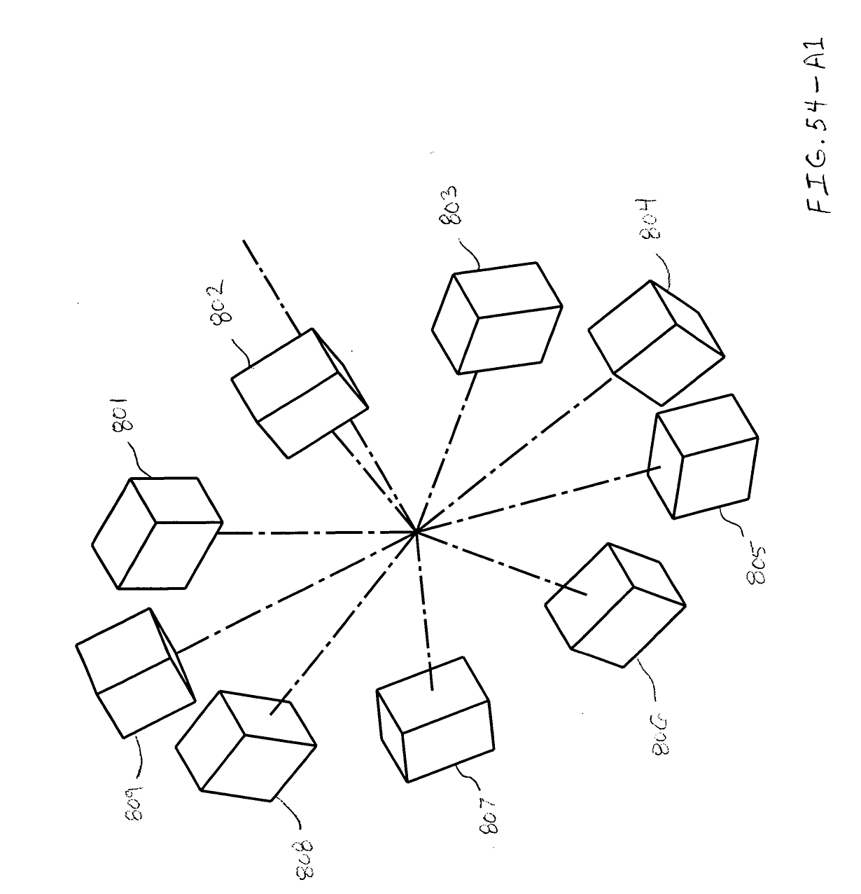

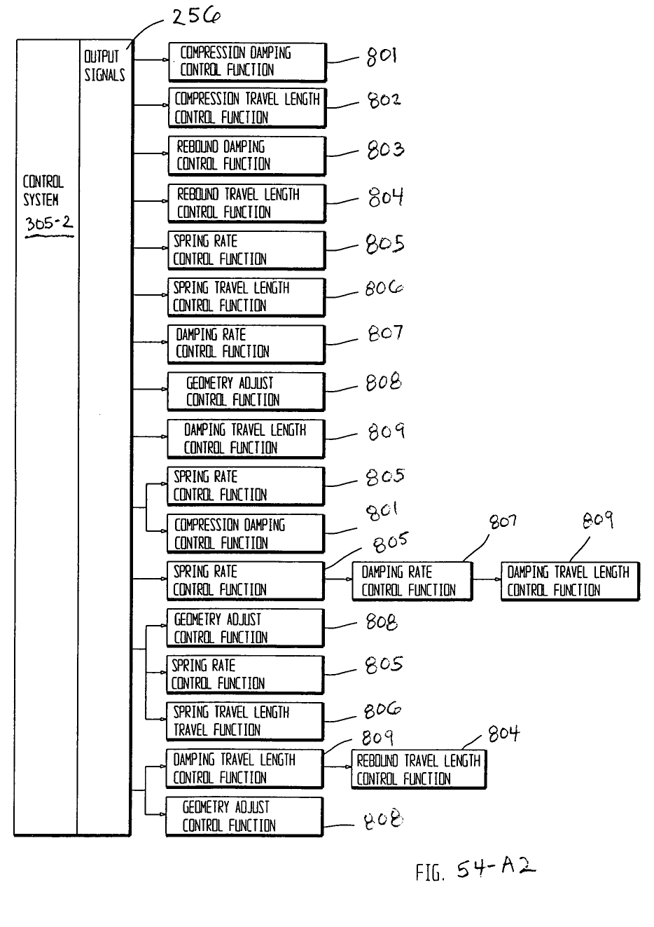

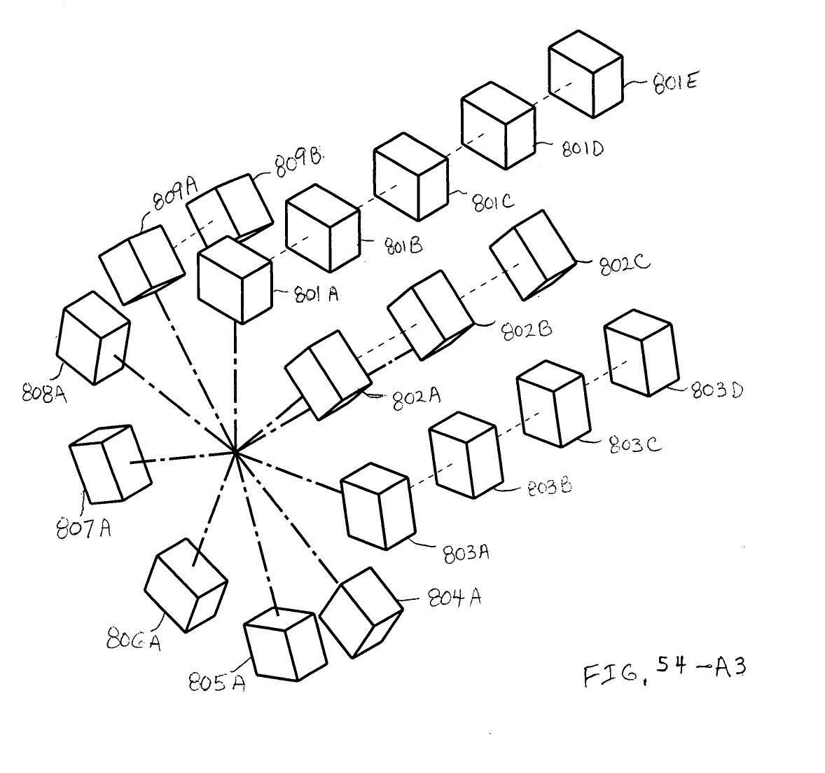

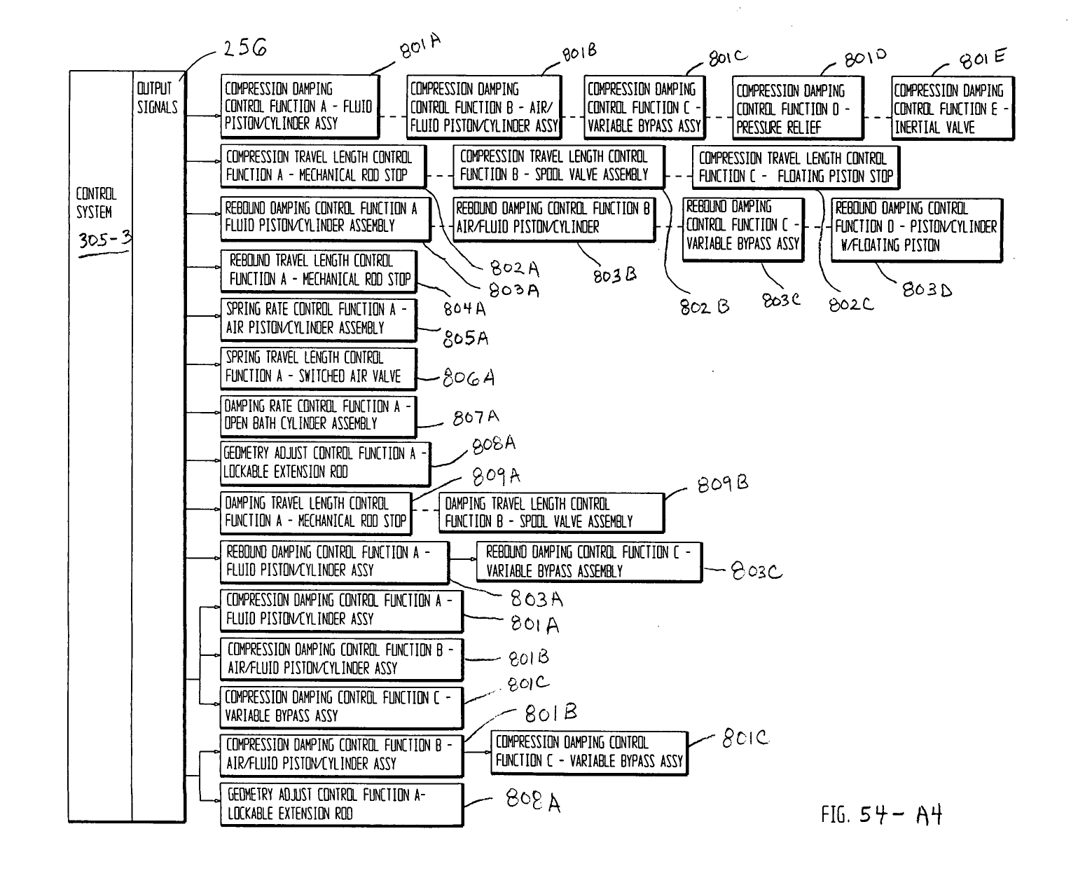

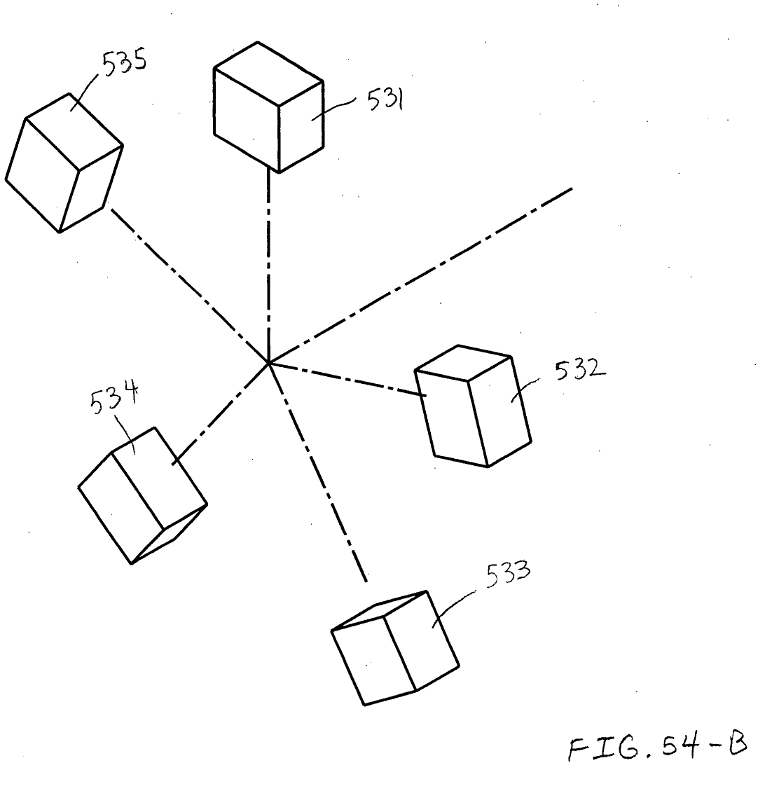

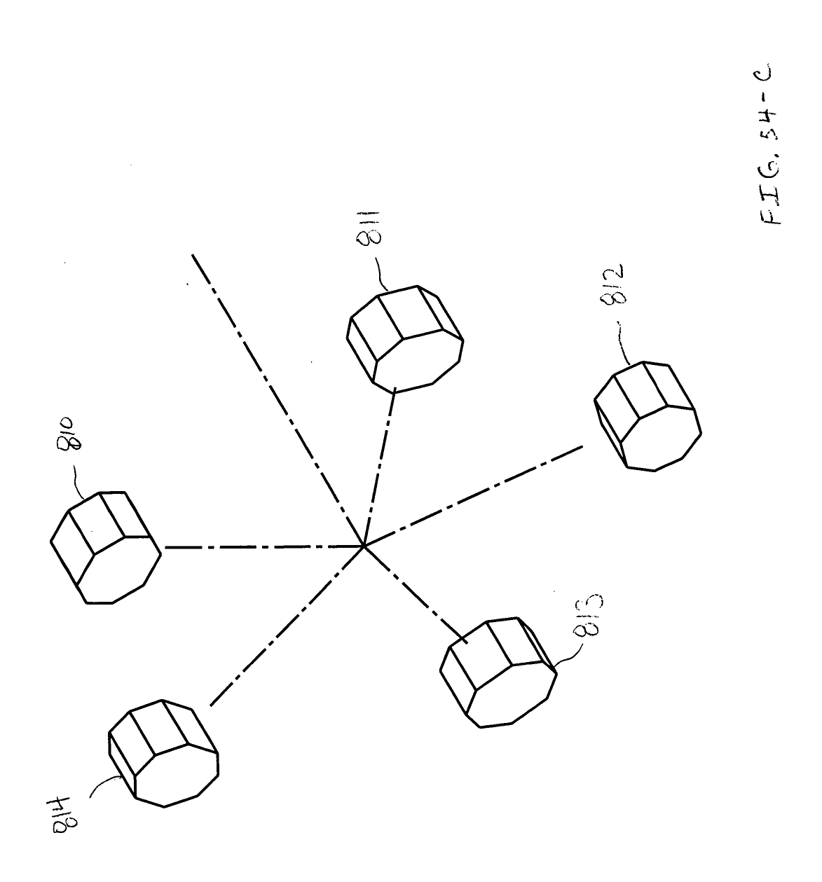

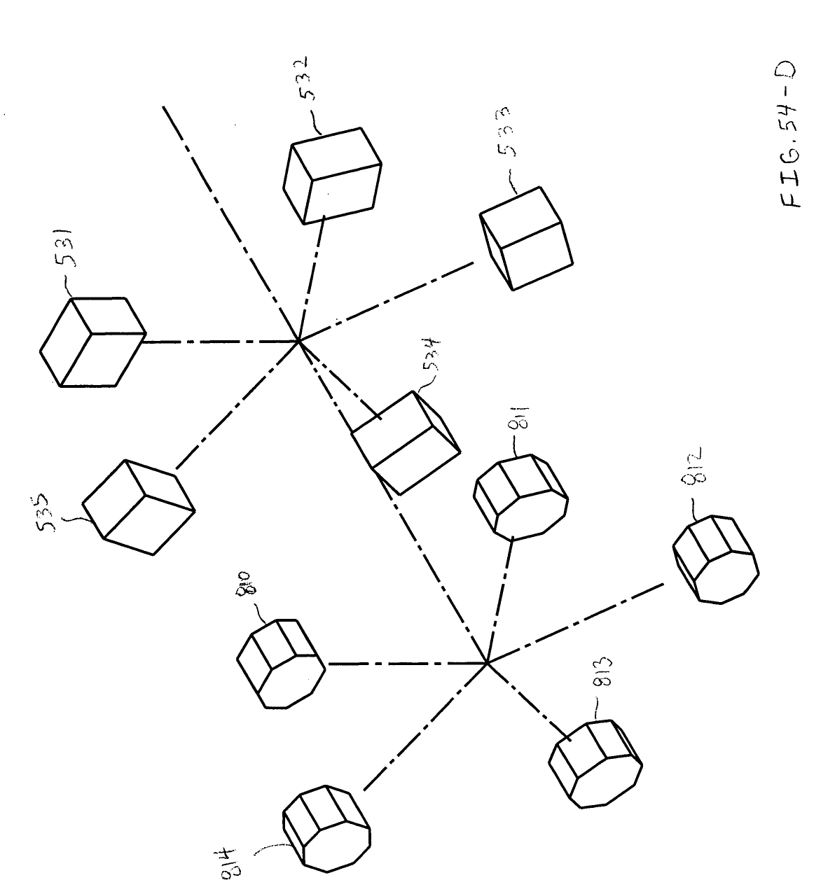

FIG. 54-A1 is a block diagram of multiple control functions for a geometry adjust suspension system. The geometry adjust suspension system controls the positions of the user in relationship to the vehicle via the user to vehicle reference contact points and the user in relationship to the ground via the vehicle to ground contact reference points. The geometry adjust suspension system control functions control movements which include but are not limited by pivotable movement, linear movement, ratcheting movements, pin indexing movements, gear mesh rotations, sprocket and chain assembly rotations, and eccentric movements. The suspension system control functions control the absorption and dissipation of kinetic energy created from the vehicle and user mass traveling over a surface such as shown in FIG. 53. The geometry adjust and suspension system control functions include but are not limited by compression damping rate control function 801, compression damping travel length control function 802, rebound damping control function 803, rebound damping travel length control function 804, spring rate control function 805, spring travel length control function 806, damping rate control function 807, geometry adjust control function 808, and damping travel length control function 809. The control functions control compression damping control methods which include but are not limited to open fluid bath assemblies and devices that use compressible gases, such as air or nitrogen, in combination with fluids to achieve controllable features such as fluid velocity control, internal cylinder pressure control, fluid path control, and fluid viscosity control. The control functions control compression damping devices which include but are not limited by single action air piston/cylinder assemblies, single action air/fluid piston/cylinder assemblies, single action air/fluid piston/cylinder assemblies with attached external reservoirs, single action air/fluid piston/cylinder with one or more springs, single action air/fluid piston/cylinder assemblies with a secondary floating piston in the cylinder, single action air/fluid piston/cylinder assemblies with fluid bypass channels, single action air/fluid piston/cylinder assemblies with inertia valves, double action air piston/cylinder assemblies, double action air/fluid piston/cylinder assemblies, double action air/fluid piston/cylinder assemblies with attached external reservoirs, double action air/fluid piston/cylinder with one or more springs, double action air/fluid piston/cylinder assemblies with a secondary floating piston in the cylinder, double action air/fluid piston/cylinder assemblies with fluid bypass channels, and double action air/fluid piston/cylinder assemblies with inertia valves. The types and construction of piston/cylinder assemblies are numerous and have an array of possible construction and material combinations. The control functions control spring devices which include but are not limited by metallic coil springs, non-metallic coil springs, spring washer stacks, elastomers, microcellular urethane material, gas piston/cylinder assemblies, gas filled bladders made of expansive materials, and other compressible mediums; individually or in combinations with each other. The spring devices are applied individually or in combination to establish spring rate control functions whether in the compression or rebound process.

FIG. 54-A2 is a block diagram of an embodiment of the control system of FIG. 1 wherein control system 305-2 outputs signals to the geometry adjust and suspension control functions described in FIG. 54-A1. Control system 305-2 controls and adjusts the geometry adjust and suspension control functions individually, in groups of two or more as a ratio to each other, in groups of two or more as a ratio to another geometry adjust or suspension element, in series, in parallel, and in a series and parallel combination. Geometry adjust and suspension control function adjustments are pre-settable before vehicle operation, dynamically adjusted during vehicle operation, or a combination of static and dynamic during vehicle operation.

FIG. 54-A3 is an expanded block diagram of multiple control device examples for the control of functions of the geometry adjust suspension system shown in FIG. 54-A2. Geometry adjust suspension control function devices for compression damping rate control function include but are not limited by compression damping control function A—fluid piston/cylinder assembly 801A, compression damping control function B—air/fluid piston/cylinder assembly 801B, compression damping control function C—variable bypass assembly 801C, compression damping control function D—pressure relief valve assembly 801D, and compression damping control function E—inertial valve assembly 801E. Geometry adjust suspension control function devices for compression damping travel length control function include but are not limited by compression damping travel length control function A—mechanical rod stop 802A, compression damping travel length control function B—spool valve assembly 802B, and compression damping travel length control function C—floating piston stop 802C. Geometry adjust suspension control function devices for rebound damping rate control function include but are not limited by rebound damping control function A—fluid piston/cylinder assembly 803A, rebound damping control function B—air/fluid piston/cylinder 803B, rebound damping control function C—variable bypass assembly 803C, and rebound damping control function D—air/fluid piston/cylinder assembly with floating piston 803D. A geometry adjust suspension control function device for rebound damping travel length control function is rebound damping travel length control function A—mechanical rod stop 804A. A geometry adjust suspension control function device for the spring rate control function is spring rate control function A—air piston/cylinder assembly 805A. A geometry adjust suspension control function device for spring travel length control function is spring travel length control function A—switched air valve assembly 806A. A geometry adjust suspension control function device for the damping rate control function is damping rate control function A—open bath cylinder assembly 807A. A geometry adjust suspension control function device for the geometry adjust control function is geometry adjust control function A—lockable extension rod 808A. A geometry adjust suspension control function device for the damping travel length control function include but are not limited by damping travel length control function A—mechanical rod stop 809A and damping travel length control function B—spool valve assembly 809B.

FIG. 54-A4 is a block diagram of an embodiment of the control system of FIG. 1 wherein control system 305-3 outputs signals to the geometry adjust and suspension control function devices described in FIG. 54-A3. Control system 305-3 controls and adjusts the geometry adjust and suspension control function devices individually, in groups of two or more as a ratio to each other, in groups of two or more as a ratio to another geometry adjust or suspension device, in series, in parallel, and in a series and parallel combination. Control system 305-3 controls and adjusts compression damping control function A-fluid piston/cylinder assembly 801A, compression damping travel length control function A—mechanical rod stop 802A, rebound damping control function A—fluid piston/cylinder assembly 803A, rebound damping travel length control function A—mechanical rod stop 804A, spring rate control function A—air piston/cylinder assembly 805A, spring travel length control function A—switched air valve assembly 806A, damping rate control function A—open bath cylinder assembly 807A, geometry adjust control function A—lockable extension rod 808A, damping travel length control function A—mechanical rod stop 809A individually; or in series, such as, rebound damping control function A—fluid piston/cylinder assembly 803A and rebound damping control function C—variable bypass assembly 803C; in parallel, such as, compression damping control function A—fluid piston/cylinder assembly 801A, compression damping control function B—air/fluid piston/cylinder assembly 801B, and compression damping control function C—variable bypass assembly 801C; or in a series and parallel combination, such as, compression damping control function B—air/fluid piston/cylinder assembly 801B and compression damping control function C—variable bypass assembly 801C in series and parallel with geometry adjust control function A—lockable extension rod 808A. Geometry adjust and suspension control function device adjustments are pre-settable before vehicle operation, dynamically adjusted during vehicle operation, or a combination of static and dynamic during vehicle operation.

FIG. 54-B is a block diagram representation of multiple control functions which includes geometry adjust functions 531, spring rate functions 532, spring travel length functions 533, damping rate functions 534, and damping travel length functions 535. Geometry adjust functions 531 is representative of geometry adjust control devices which include but are not limited to threaded rods adjuster assemblies, air cylinder/piston assemblies, hydraulic cylinder/piston assemblies, air/hydraulic cylinder/piston assemblies, ratchet assemblies, indexable pin assemblies, slide rail assemblies, air bladder assemblies, gear mesh assemblies, sprocket and chain assemblies, eccentric rod assemblies, and cam assemblies. Spring rate functions 532 is representative of spring rate control devices which include but are not limited to air cylinder/piston assemblies, air/hydraulic cylinder/piston assemblies, air/coil spring assemblies, coil spring/hydraulic assemblies, air cylinder/coil spring/hydraulic assemblies, and gas/hydraulic cylinder/piston assemblies. Spring travel length functions 533 is representative of spring travel length control devices which include but are not limited to threaded rod adjuster assemblies, air cylinder/piston assemblies, hydraulic cylinder/piston assemblies, air/hydraulic cylinder/piston assemblies, ratchet assemblies, indexable pin assemblies, slide rail assemblies, air bladder assemblies, gear mesh assemblies, sprocket and chain assemblies, eccentric rod assemblies, and cam assemblies. Damping rate functions 534 is representative of damping rate control devices which include but are not limited to air cylinder/piston assemblies, air/hydraulic cylinder/piston assemblies, air/coil spring assemblies, coil spring/hydraulic assemblies, air cylinder/coil spring/hydraulic assemblies, and gas/hydraulic cylinder/piston assemblies. Damping travel length functions 535 is representative of damping travel length control devices which include but are not limited to threaded rods adjuster assemblies, air cylinder/piston assemblies, hydraulic cylinder/piston assemblies, air/hydraulic cylinder/piston assemblies, ratchet assemblies, indexable pin assemblies, slide rail assemblies, air bladder assemblies, gear mesh assemblies, sprocket and chain assemblies, eccentric rod assemblies, and cam assemblies. Additional suspension control features that are adjustable include but are not limited to pressure release devices (known as pop-off valve), variable damping rate devices (known as lock out control valves), variable pressure release devices (known as metered pop-off valves), variable damper bypass mechanical devices, variable damper bypass electronic valve devices, dual spring rate air/fluid cartridges, rebound damping rate adjusters, and rebound damping length adjusters.

FIG. 54-C is a block diagram representation of multiple geometry adjust control functions which includes geometry adjust individual control functions 810, geometry adjust ratio function 811, geometry adjust ratio function 812, geometry adjust ratio function 813, and geometry adjust ratio function 814. Control systems control geometry adjustable devices individually, in ratios of two or more in relation to each other, in ratios of two or more in relation to another vehicle parameter or component, in series operation of two or more, in parallel operation of two or more, or in combinations of series and parallel of three or more.

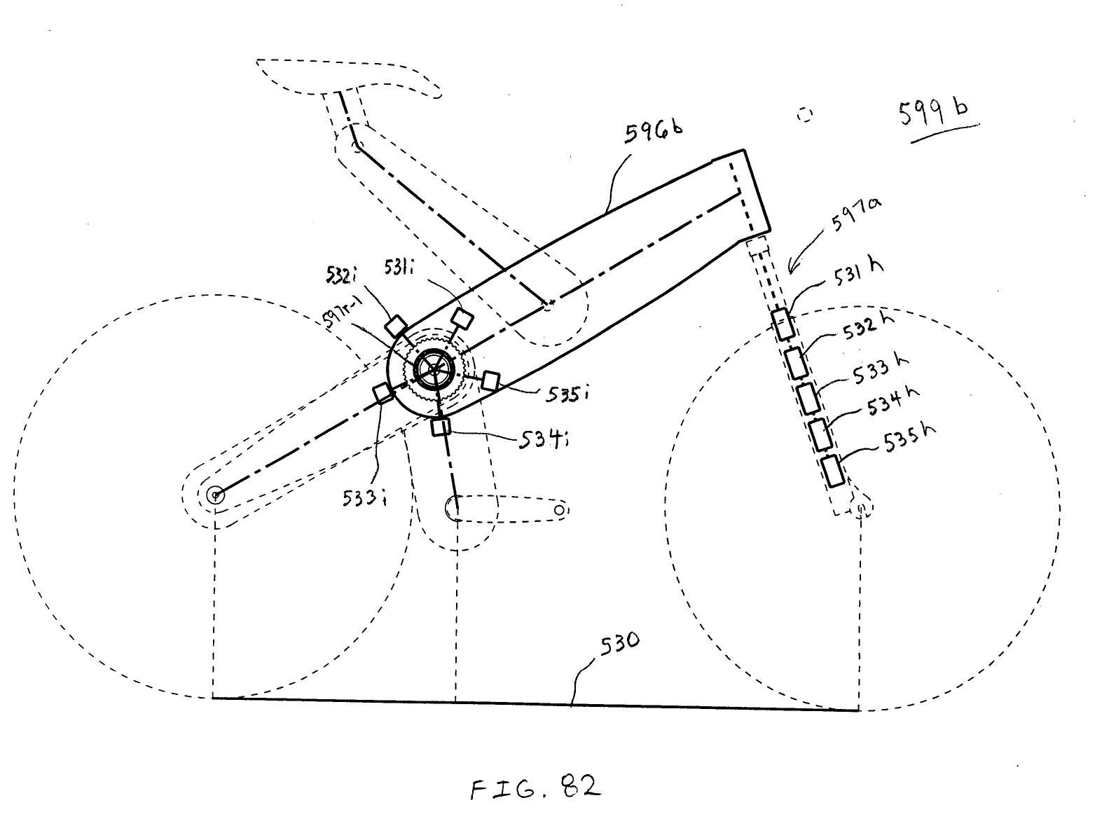

FIG. 54-D is a block diagram representation of a combination of the multiple geometry adjust control functions shown in FIGS. 54-B and suspension control functions shown in 54-C. The geometry adjust control functions and suspension control functions for vehicle structures are controllable individually, in combinations of two or more, in series, in parallel, and in a combination of series and parallel. The interrelationships of the control functions to each other are very complex and mechanical devices alone are inadequate in adapting to the rapid changes required to improve the vehicle characteristics during operation. Combinations of control functions are shown applied to bicycle assembly 700A in FIG. 80-B.

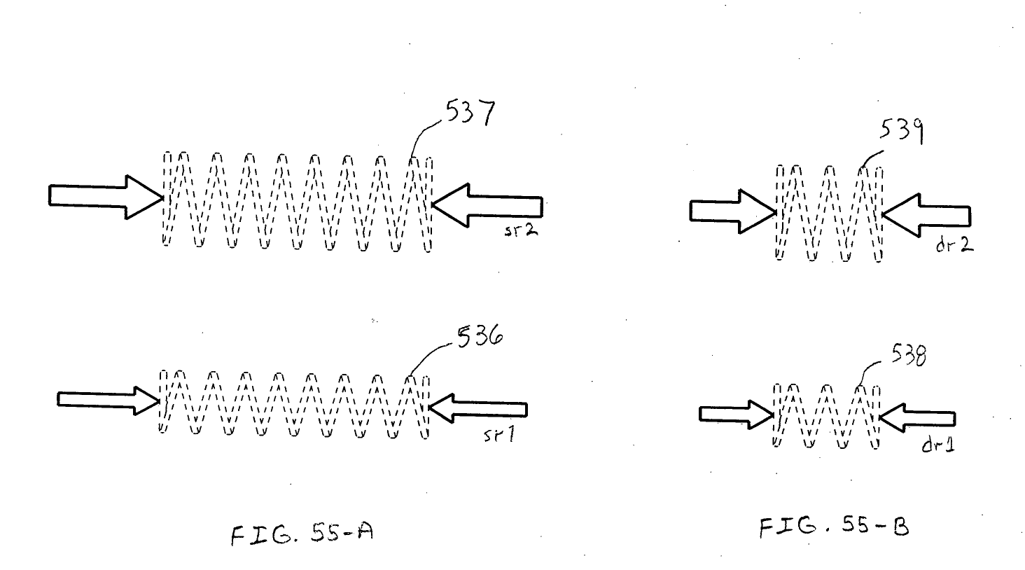

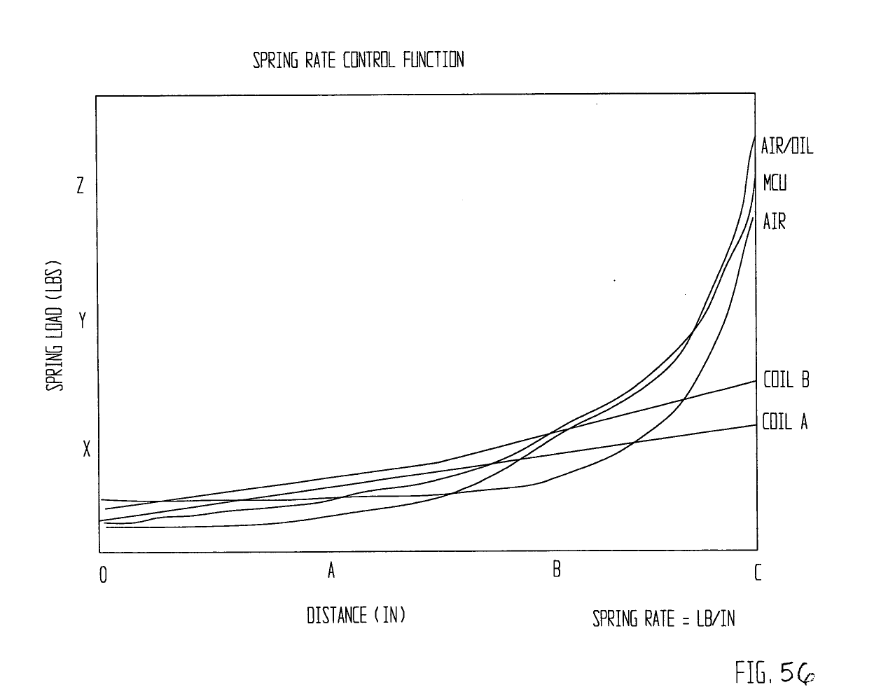

FIG. 55-A is a graphical illustration of a spring rate control function wherein spring rate 536 and spring rate 537 are representative spring rate forces.

FIG. 55-B is a graphical illustration of a damping rate control function wherein damper rate 538 and damper rate 539 are representative of damper rate forces.

FIG. 56 is a chart representation of measured spring rates of pounds per inch. Springs are comprised of various materials and the representative linear and curved spring rates are shown herein.

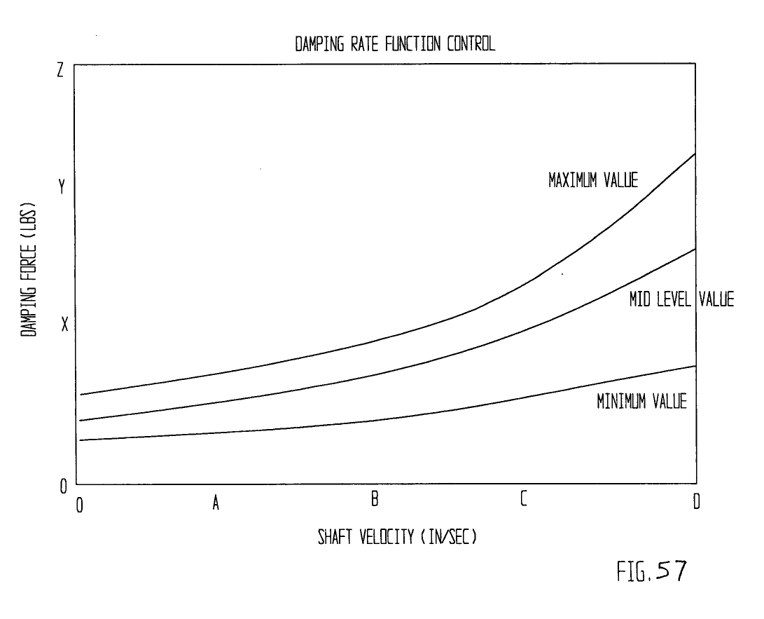

FIG. 57 is a chart representation of a damping rate control function. A maximum and minimum value is established for a control parameter to adjust to the mid level value.

FIG. 58-A is a graphical representation of a spring travel length control function spring travel length 540 and spring travel length 541.

FIG. 58-B is a graphical representation of a damping travel length control functions damper travel length 542 and damper travel length 543.

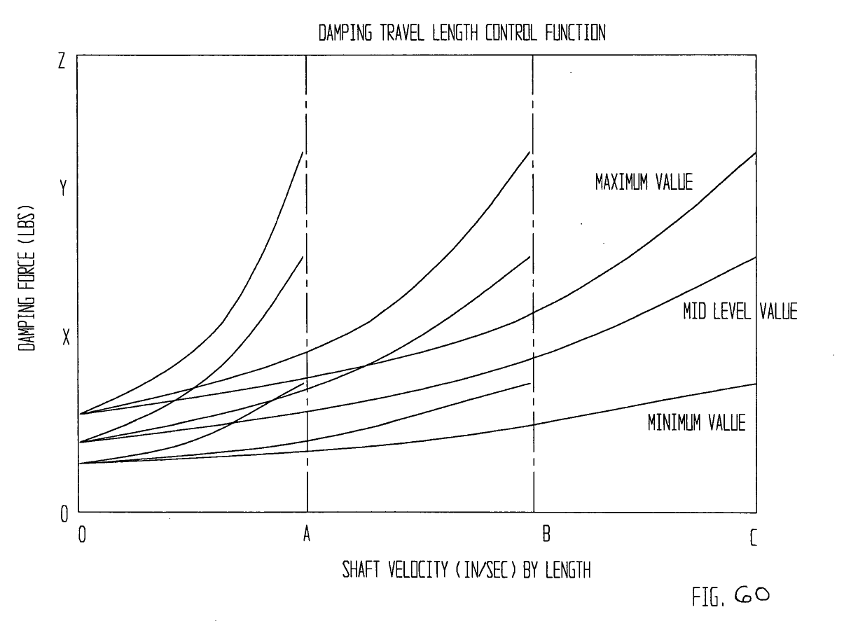

FIG. 59 is a chart representation of a spring travel length 541 control function wherein the same spring rate is adjusted from three inches of travel length to two inches of travel length then to one inch of travel length and the corresponding spring travel length adjustments are shown.

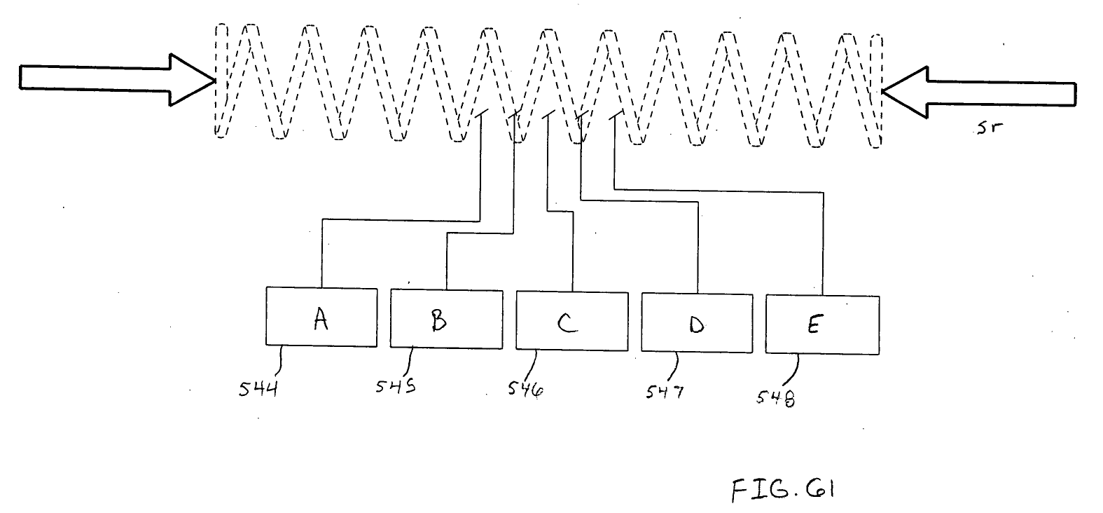

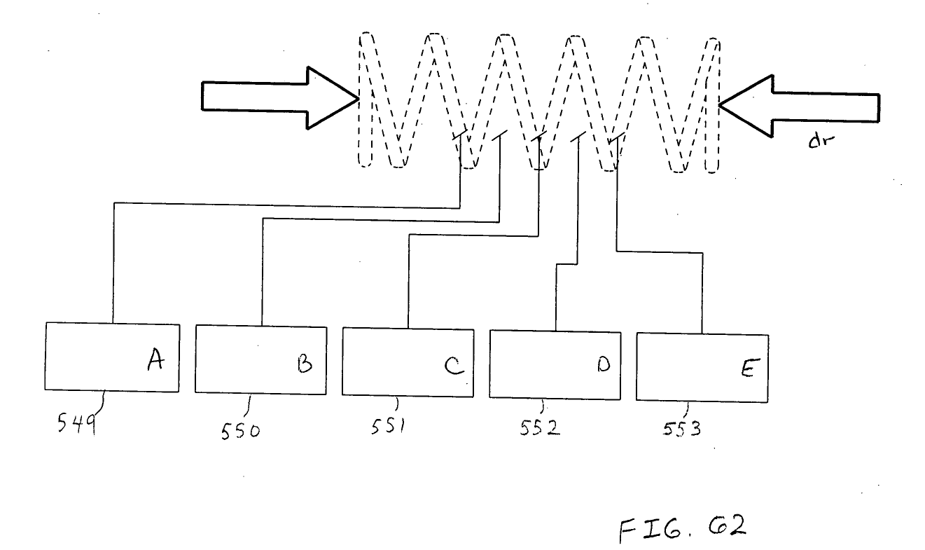

FIG. 60 is a chart representation similar to FIG. 59 for a damper travel length 543 control function and the corresponding damper length adjustments are shown.

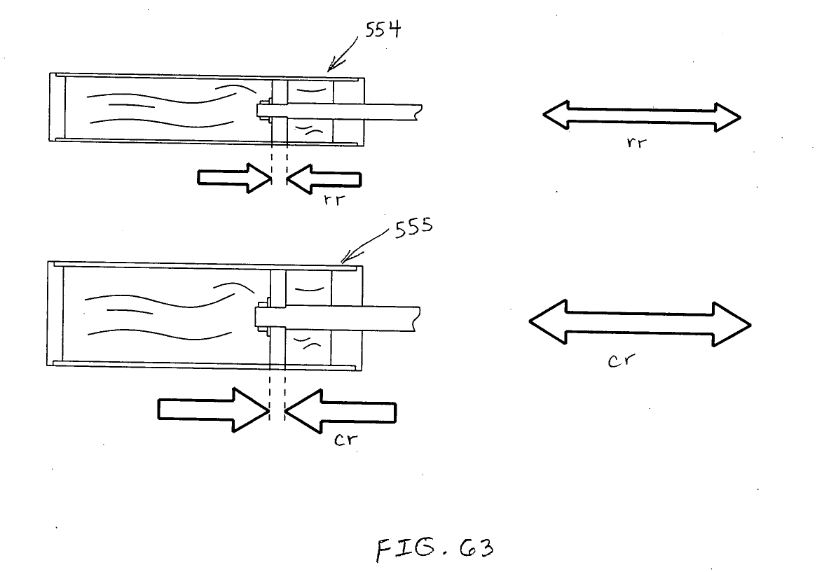

FIG. 61 is a block diagram of spring rate control function types. Spring rate devices include but are not limited by metallic coil springs, non-metallic coil springs, elastomers, microcellular urethane material, air cylinder/piston assemblies, gas cylinder/piston assemblies, and air bladders in combination for compression control. Spring rate control function 544 is representative of coil spring assemblies, spring rate control function 545 is representative of coil spring assemblies combined with an air cylinder/piston assembly, spring rate control function 546 is representative of coil spring assemblies combined with an air/hydraulic cylinder/piston assemblies with external reservoirs, spring rate control function 547 is representative of air/hydraulic cylinder/piston assemblies wherein the compression of the air is the spring function, and spring rate control function 548 is representative of air/hydraulic cylinder/piston assemblies with a secondary floating piston in the cylinder. Spring rate Sr represents the controllable feature of the control function device.

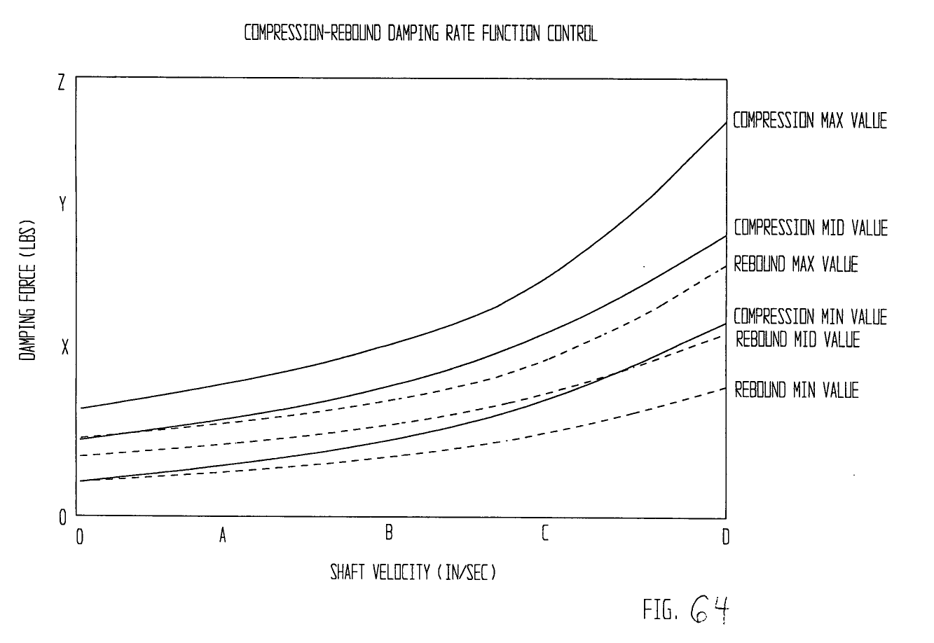

FIG. 62 is a block diagram of damping rate control function types. Damping rate devices use compressible gases such as nitrogen and/or air in combination with uncompressible fluids to achieve controllable features such as fluid velocity control, internal cylinder pressure, and fluid viscosity. Coil springs, elastomers, and microcellular urethane materials are also used in combination for rebound control. Damping rate dr represents the controllable feature of the control function device. Damping rate control function 549 is representative of air cylinder/piston assemblies, damping rate control function 550 is representative of air/hydraulic cylinder/piston assemblies, damping rate control function 551 is representative of air/hydraulic cylinder/piston assemblies with external reservoirs, damping rate control function 552 is representative of air/hydraulic cylinder/piston assemblies with one or more coil springs, and damping rate control function 553 is representative of air/hydraulic cylinder/piston assemblies with a secondary floating piston in the cylinder.

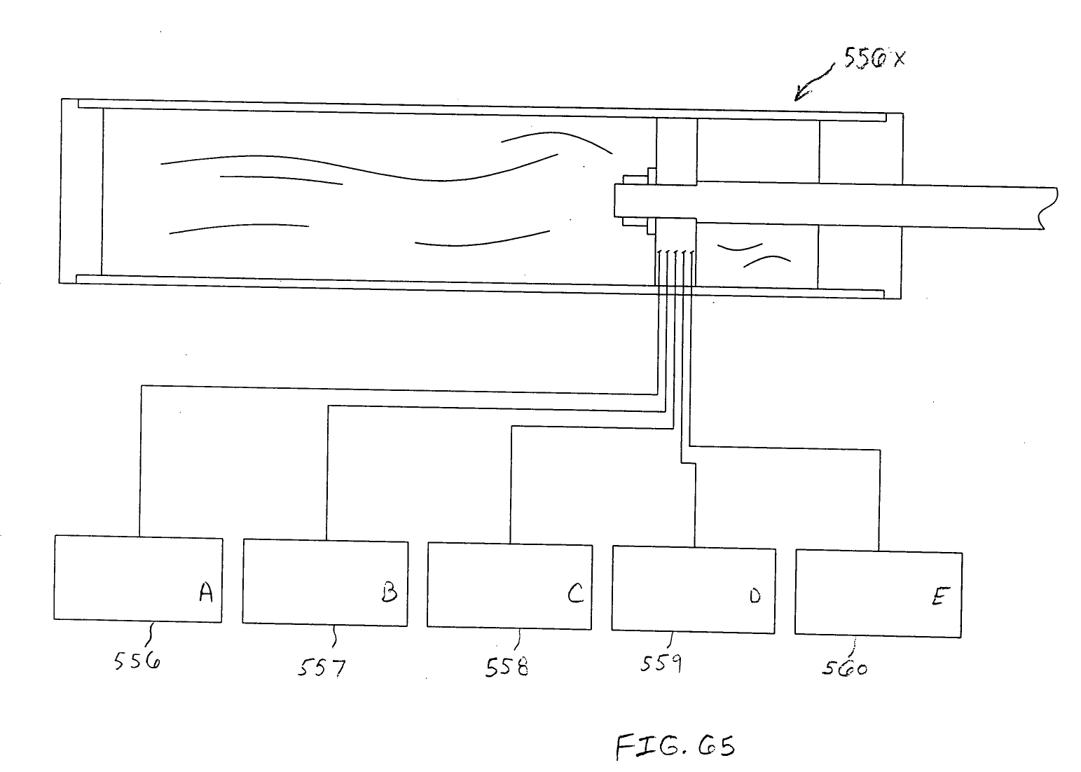

FIG. 63 is a graphical illustration of compression and rebound damping rate control functions. Cylinder/piston assembly 555 is representative of a compression rate control device. Control of a fluid through the piston enables control of compression rate cr. Cylinder/piston assembly 554 is representative of a rebound rate control device. Control of a fluid through the piston enables control of rebound rate rr.

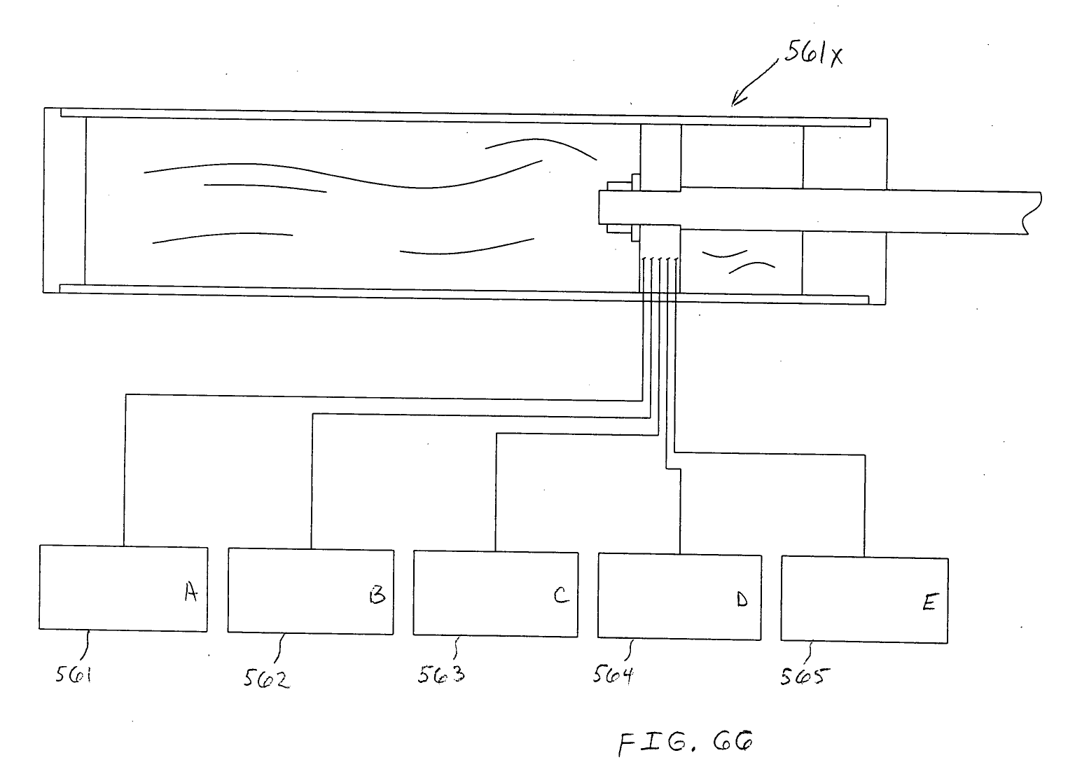

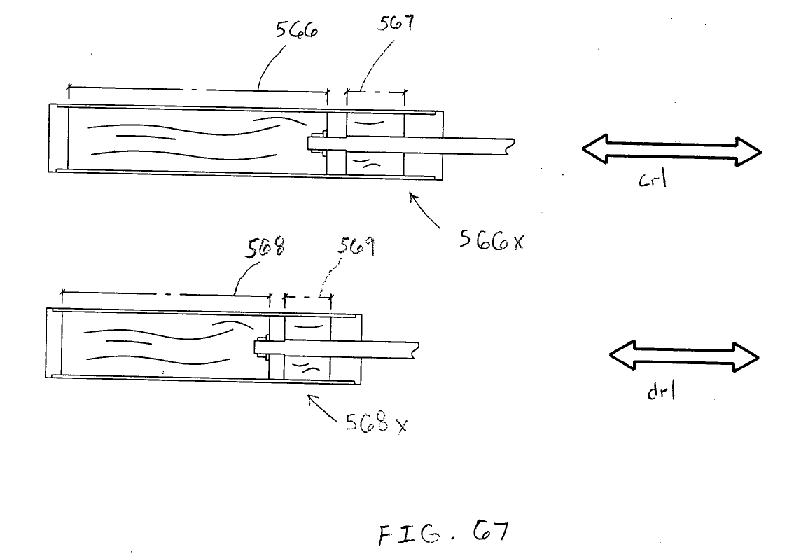

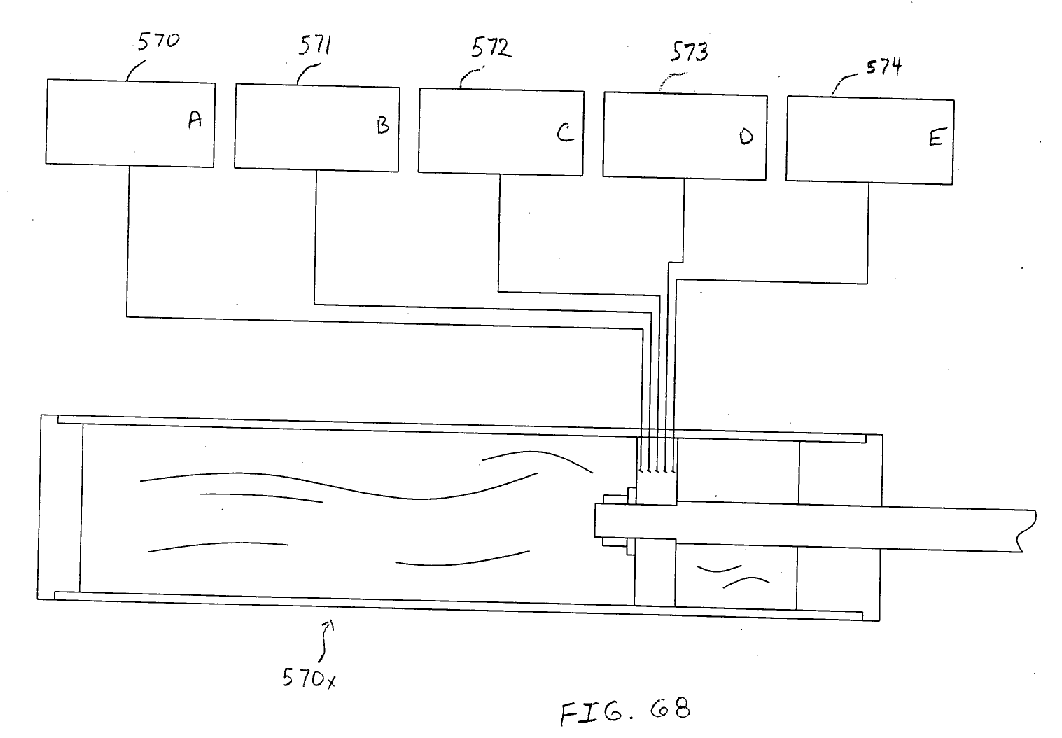

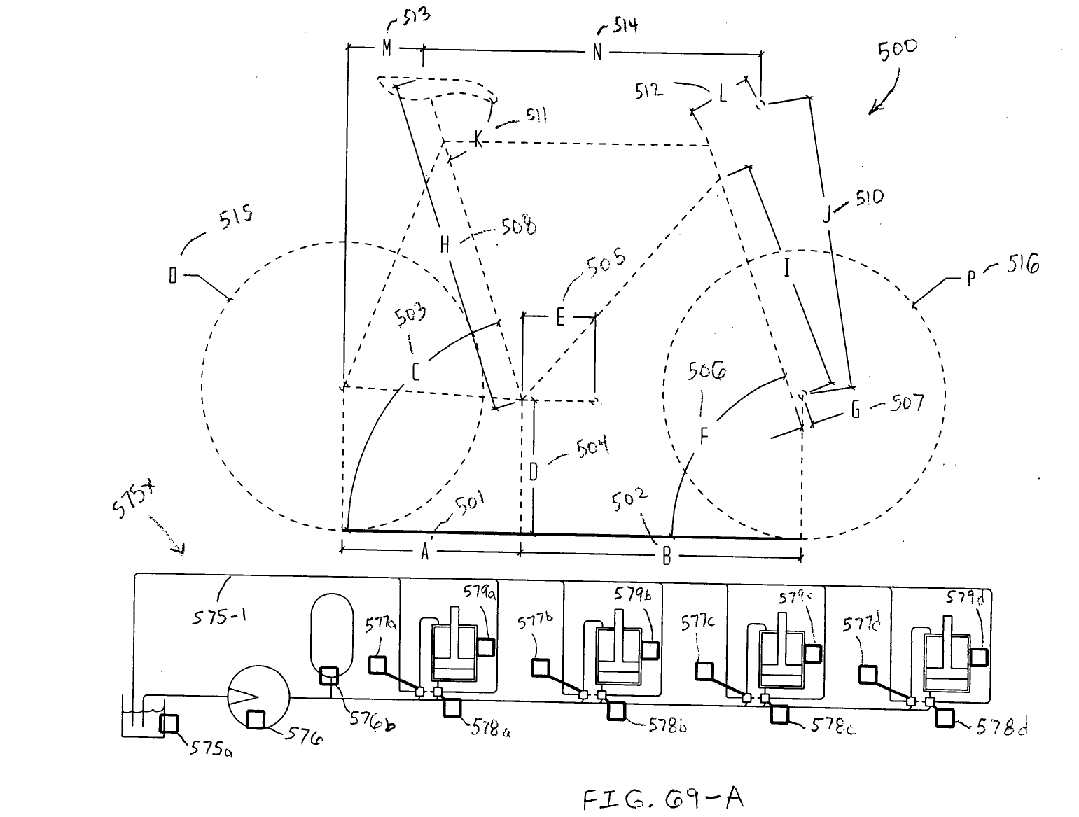

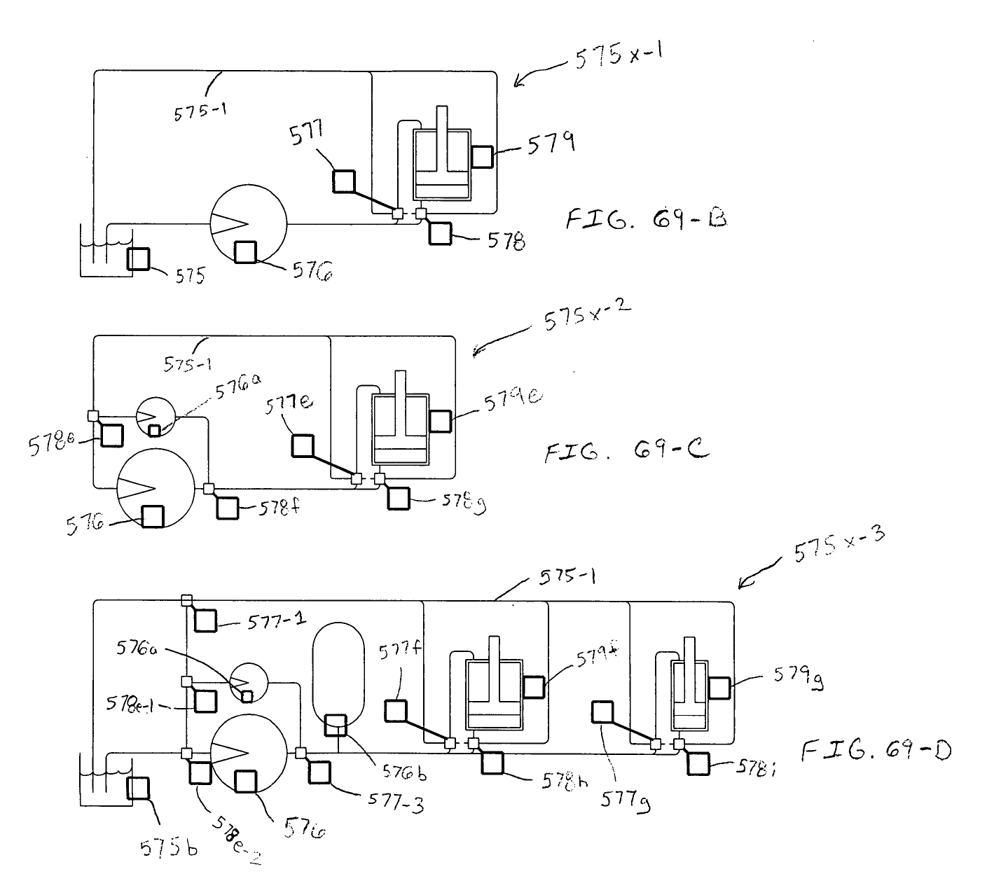

FIG. 64 is a chart representation of compression and rebound rates. Maximum and minimum values are established for control parameter limits. The control system adjusts to the mid level values.

FIG. 65 is a block diagram of compression rate control function types. Compression control function 556 is representative of air cylinder/piston assemblies, compression control function 557 is representative of air/hydraulic cylinder/piston assemblies, compression control function 558 is representative of air/hydraulic cylinder/piston assemblies with external reservoirs, compression control function 559 is representative of air/hydraulic cylinder/piston assemblies with one or more coil springs, and compression control function 560 is representative of air/hydraulic cylinder/piston assemblies with a secondary floating piston in the cylinder. Compression device assembly 556x represents the controllable feature of the control function device. Compression devices use compressible gases such as nitrogen and/or air in combination with uncompressible fluids to achieve controllable features such as fluid velocity control, internal cylinder pressure, and fluid viscosities. Coil springs, elastomers, and microcellular urethane materials are also used in combination for compression rate control.

FIG. 66 is a graphical illustration of rebound rate control function types. Rebound control function 561 is representative of air cylinder/piston assemblies, rebound control function 562 is representative of air/hydraulic cylinder/piston assemblies, rebound control function 563 is representative of air/hydraulic cylinder/piston assemblies with external reservoirs, rebound control function 564 is representative of air/hydraulic cylinder/piston assemblies with one or more coil springs, and rebound control function 565 is representative of air/hydraulic cylinder/piston assemblies with a secondary floating piston in the cylinder. Rebound rate device 561x represents the controllable feature of the control function device. Rebound rate control devices use compressible gases such as nitrogen and/or air in combination with uncompressible fluids to achieve controllable features such as fluid velocity control, internal cylinder pressure, and fluid viscosities. Coil springs, elastomers, and microcellular urethane materials are also used in combination for rebound rate control.

FIG. 67 is a graphical illustration of compression and rebound damping length control function. Compression damping length crl is controlled by cylinder/piston assembly 566x. Compression damping lengths 566 and 567 are representative of the compression damping length control function. Rebound damping length drl is controlled by cylinder/piston assembly 568x. Rebound damping lengths 568 and 569 are representative of the rebound damping length control function.

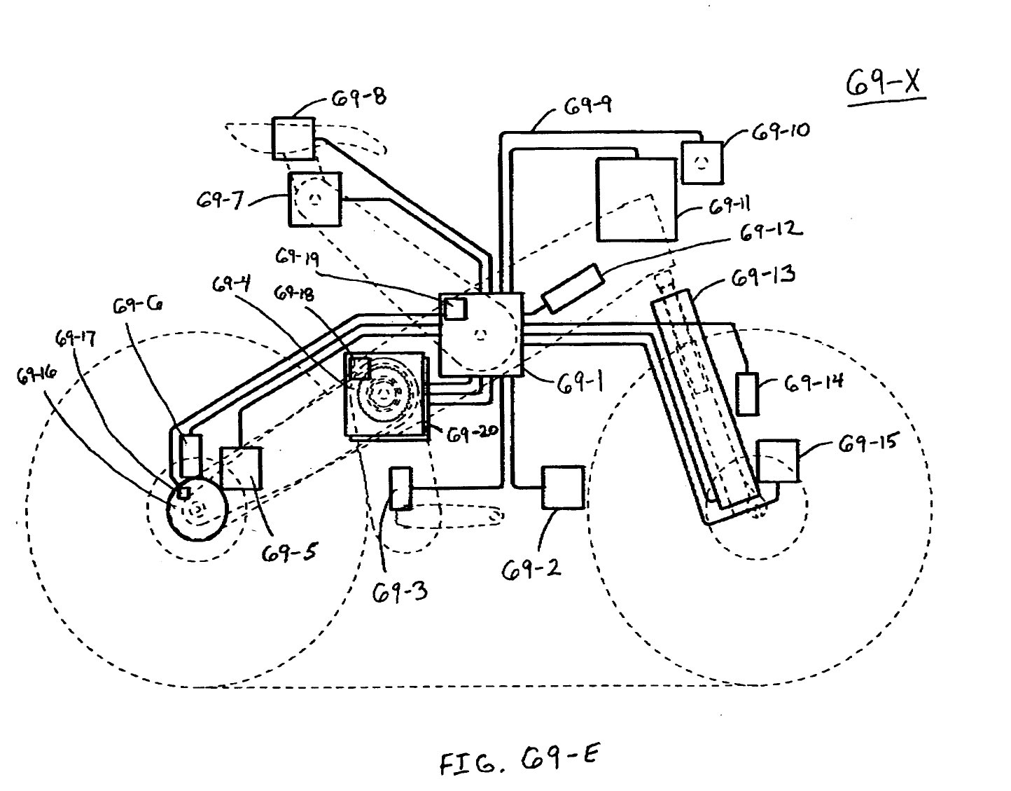

FIG. 68 is a block diagram of compression and rebound damping length control function types. Compression and rebound damping length control function 570 is representative of air cylinder/piston assemblies, compression and rebound damping length control function 571 is representative of air/hydraulic cylinder/piston assemblies, compression and rebound damping length control function 572 is representative of air/hydraulic cylinder/piston assemblies with external reservoirs, compression and rebound damping length control function 573 is representative of air/hydraulic cylinder/piston assemblies with one or more coil springs, and compression and rebound damping length control function 574 is representative of air/hydraulic cylinder/piston assemblies with a secondary floating piston in the cylinder. Compression and rebound damping length device 570x represents the controllable feature of the control function device. Compression and rebound damping length control devices use compressible gases such as nitrogen and/or air in combination with uncompressible fluids to achieve controllable features such as fluid velocity control, internal cylinder pressure, and fluid viscosities. Coil springs, elastomers, and microcellular urethane materials are also used in combination for rebound rate control.

FIG. 69-A is a flow diagram of an air and/or fluid system 575x which enables control functions for the geometric dimensions as represented by FIG. 51-A and control functions as represented in FIG. 51-B. Pump assembly 576 provides the transfer and pressurized supply of air and or fluid from reservoir and valve assembly 575a for air/fluid system 575x. Lines 575-1 provide the medium and connections for the air/fluid transfer between components. Lines 575-1 are pneumatic or fluid transfer capable lines in single line, double line, or bundled arrangements. Accumulator and valve assembly 576b supplies the capacity for system pressure maintenance and storage. An individual control circuit is formed by the arrangement of intake valve 577a, piston/cylinder assembly 579a, and exit valve 578a. The air and/or fluid control circuit is operable as a geometry adjustable pivot angle control function, geometry adjustable length control function, spring rate control function, spring travel length control function, damping rate control function, damping travel length control function, compression damping control function, rebound damping control function, pressure relief control function, variable damping bypass control function, or variable compression rate control function. In this way, the air and/or fluid circuit functionally controls geometric adjustable functions of the vehicle, suspension adjustable functions of the vehicle, and other adjustable control functions not described herein. The air and/or fluid control circuit allows control functions to make static adjustments for pre-set parameters and dynamic adjustments for operating control parameters. Additional control circuits are formed by the arrangement of intake valve 577b, piston/cylinder assembly 579b, and exit valve 578b; intake valve 577c, piston/cylinder assembly 579c, and exit valve 578c; and intake valve 577d, piston/cylinder assembly 579d, and exit valve 578d respectively. The air and/or fluid system 575x is applicable to multiple vehicle types.

FIG. 69-B is a simplified open air/fluid system flow diagram similar to FIG. 69-A wherein air and/or fluid system 575x-1 enables controllable functions. Reservoir and valve assembly 575 supply pump assembly 576 through air and/or fluid control medium lines 575-1. An individual control circuit is formed by the arrangement of intake valve 577, piston/cylinder assembly 579, and exit valve 578.

FIG. 69-C is a simplified closed air/fluid system flow diagram similar to FIG. 69-A wherein air and/or fluid system 575x-2 enables controllable functions. Pump assembly 576 and pump assembly 576a supply pressure through air and/or fluid control medium lines 575-1. The two pumps represent the ability to control variable line pressures for the attached control circuits through control valve 578e which may include but is not limited by a spool valve, ratio adjusting valve, on/off valve, pressure sensitive valve, or limiter valve. An individual control circuit is formed by the arrangement of intake valve 577e, piston/cylinder assembly 579e, and exit valve 578g.

FIG. 69-D is a simplified flow diagram of an air/fluid system similar to FIG. 69-A wherein air and/or fluid system 575x-3 is a combined open and closed air/fluid system enabling controllable functions. Reservoir and valve assembly 575b provides an open return and supply loop for air and/or fluid system 575x-3. Pump assembly 576a and pump assembly 576a supply pressure through air and/or fluid control medium lines 575-1. The two pumps represent the ability to control variable line pressures for the attached control circuits through control valves 578e-1 and 578e-2 which include a spool valve, ratio adjusting valve, on/off valve, pressure sensitive valve, and limiter valve. Accumulator 576b provides maintenance and storage for pressure. An individual control circuit is formed by the arrangement of intake valve 577f, piston/cylinder assembly 579f, and exit valve 578h. Another individual control circuit is formed by the arrangement of intake valve 577g, piston/cylinder assembly 579g, and exit valve 578i. The two circuits are representative of dual piston/cylinder controllable functions which are controllable individually, in series, in parallel, or in combinations thereof and are applicable as suspension control elements and or geometry adjust elements.

FIG. 69-E depicts an embodiment of a bicycle assembly similar to FIG. 80-A wherein bicycle assembly 69-X comprises logic control assembly 69-1 and dynamically adjustable control functions. Sensors send input signals to logic control assembly 69-1, which based on logic control parameters determines output signals for the dynamically adjustable control functions. Vehicle dynamically control functions including but not limited to; rear brake assembly 69-5, adjustable structural geometry suspension assembly 69-4, drive system assembly 69-20, adjustable structural geometry suspension assembly 69-7, adjustable structural geometry suspension assembly 69-8, adjustable steering assembly 69-11, adjustable structural geometry suspension assembly 69-13, front brake assembly 69-15, and clutch assembly 69-16 are dynamically adjusted through output signals from logic control assembly 69-1. Sensors including but not limited to; flow velocity sensor 69-14, vehicle velocity sensor 69-6, power input sensor 69-3, load sensor 69-12, wheel rotation sensor 69-17, and manual input device 69-10 send inputs to logic control assembly 69-1 for processing by logic control device 69-2. Logic control device 69-2 receives inputs routed through logic control assembly 69-1 and determines outputs for the dynamically controllable functions. Logic control device 69-2 is locatable within logic control assembly 69-1, within the vehicle structure, or external to the vehicle structure. Logic valve manifold 69-19 provides controls for manual input bias selection, device feedback loops, lock out functions, pre-set load limits, pressure relief, and manual override inputs through logic control assembly 69-1. Logic valve manifold 69-18 enables similar functions as logic valve manifold 69-19 at the critical regional location of the adjustable structural geometry suspension assembly 69-4 and drive system assembly 69-20 interface. Medium connections 69-9 connect sensors, adjustable control functions, and logic control device 69-2 to logic control assembly 69-1. Medium connections 69-9 include but are not limited to gas, fluid, mechanical, or electrical devices. Although the vehicle shown is in the form of a bicycle assembly, the application of the logic control circuit and dynamically adjustable controllable functions to additional vehicle assembly types is clearly apparent. Logic control assembly 69-1 is shown as centrally located on vehicle assembly 69-X, but the location is adaptable to each vehicle type and structure. Logic control assembly 69-1 outputs include but are not limited by mechanical, gas, fluid, and electrical methods. Logic control assembly 69-1 is powered by the stored logic system energy reacting to user and/or payload contacts to the vehicle and the vehicle contacts to the terrain as noted in U.S. Nonprovisional patent application: Ser. No. 10/113,931—Filed Apr. 2, 2002, Vehicles and Methods Using Center of Gravity and Mass Shift Control System, Inventor: Darrell W. Voss.

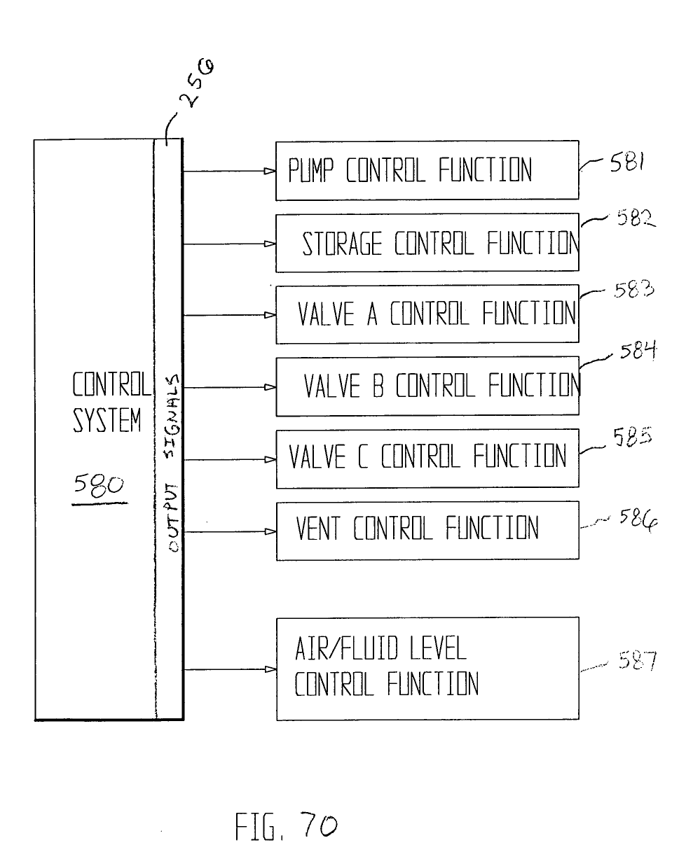

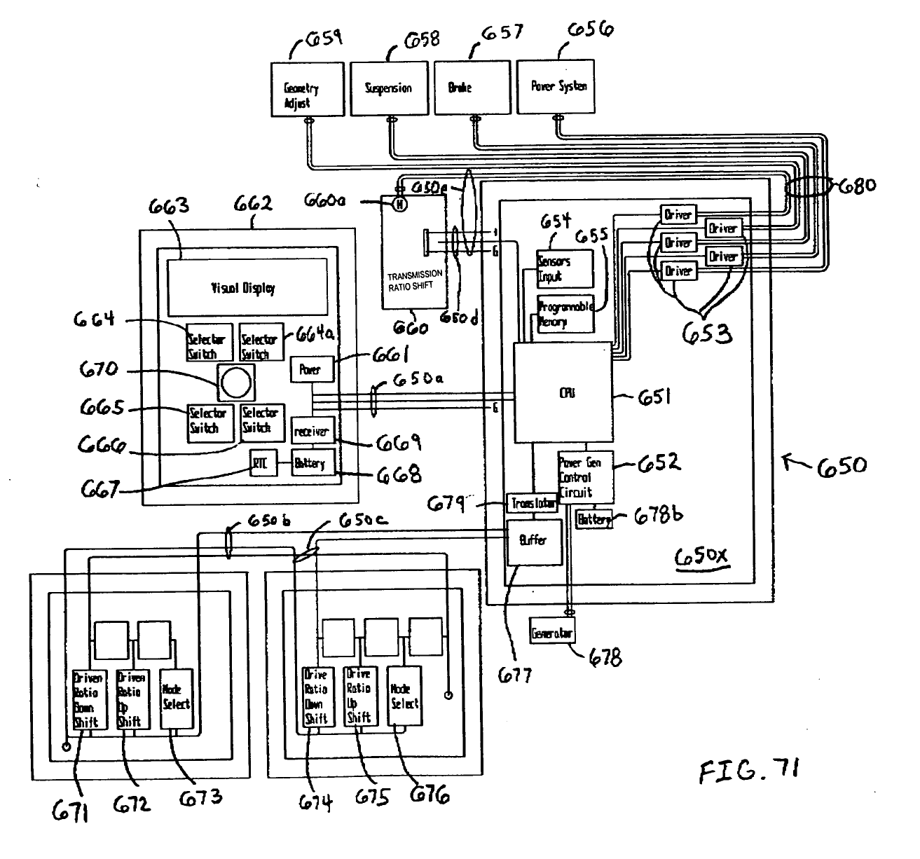

FIG. 70 is a block diagram of the control functions for a pump system and check valves similar to those shown in FIGS. 69-A and 69-B. Control system 580 sends output signals 256 to pump control function 581, storage control function 582, valve A control function 583, valve B control function 584, valve C control function 585, vent control function 586, and air/fluid level control function 587.

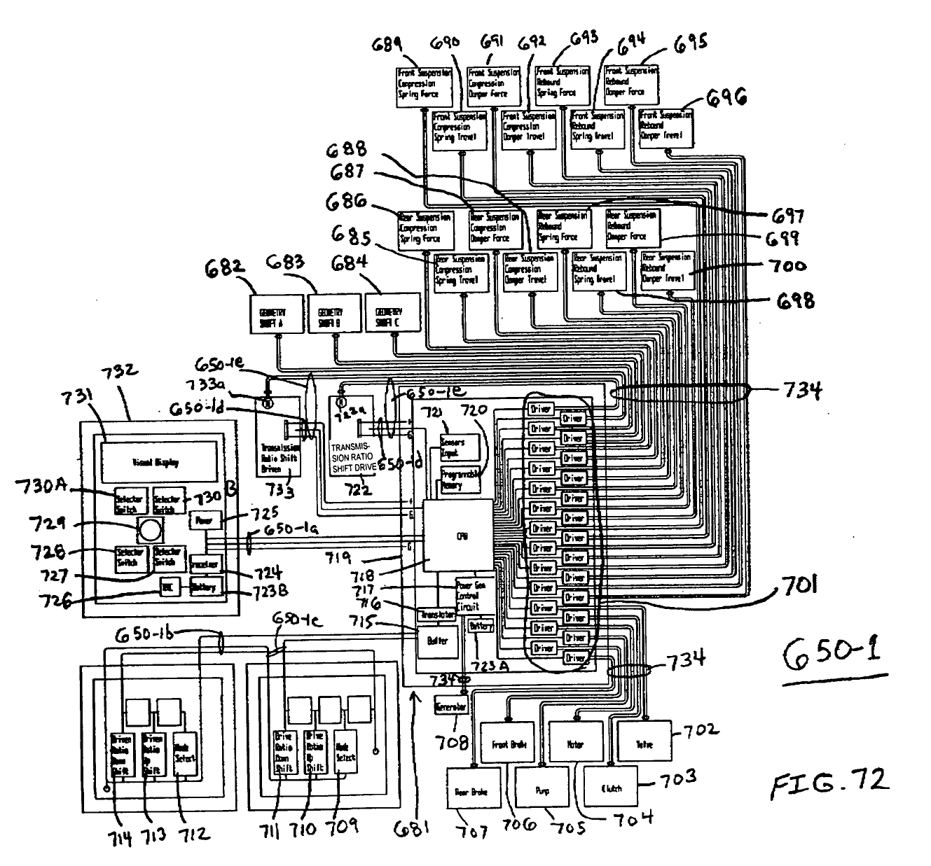

FIG. 71 is a conceptual electrical schematic diagram for a control system 650. As shown in FIG. 71, control assembly 650 receives manual inputs from selector switches 665, 666, 664, and 664a, sensor input signals from sensors input 654, and sensor inputs from translator 679. Translator 679 receives sensor signals via buffer 677 from drive ratio up shift 675, drive ratio downshift 674, driven ratio down shift 671, and driven ratio up shift 672 sensors. Control assembly 650 evaluates the input data information referencing parameter controls stored in programmable memory 655 through the processing of the data by central processing unit 651. Control assembly 650 has electric power supplied by power generator control circuit 652 that balances the system power requirements by using battery 678b or generator 678 or combinations of the two for operation. Visual display housing 662 houses selector switches 665, 666, 664, and 664a, potentiometer selector 670, receiver 669, clock/timer 667, battery 668, power circuit 661, and a visual display 663. Control system 650 processes the input data information through the parameter control algorithms to control vehicle control functions by generating outputs signals and sending them along control board 650x circuitry or wiring to control function motor circuit driver chipsets 653 which convert the output signals into control function specific values via communications channels 680 for power system 656, brake system 657, suspension system 658, geometry adjust system 659, transmission ratio shift system 660, and visual display 663. Connection wiring 650a provides signal routing from the visual display housing 662 to the controller board 650x, connection wiring 650b provides signal routing for the transmission ratio mode selector 673 to controller board buffer 677, connection wiring 650c provides signal routing for the transmission ratio mode selector 676 to the controller board buffer 677, connection wiring 650d provides signal routing for the transmission ratio shift system 660, and connection wiring 650e provides signal routing for the transmission ratio shift system motor 660a to controller board 650x.

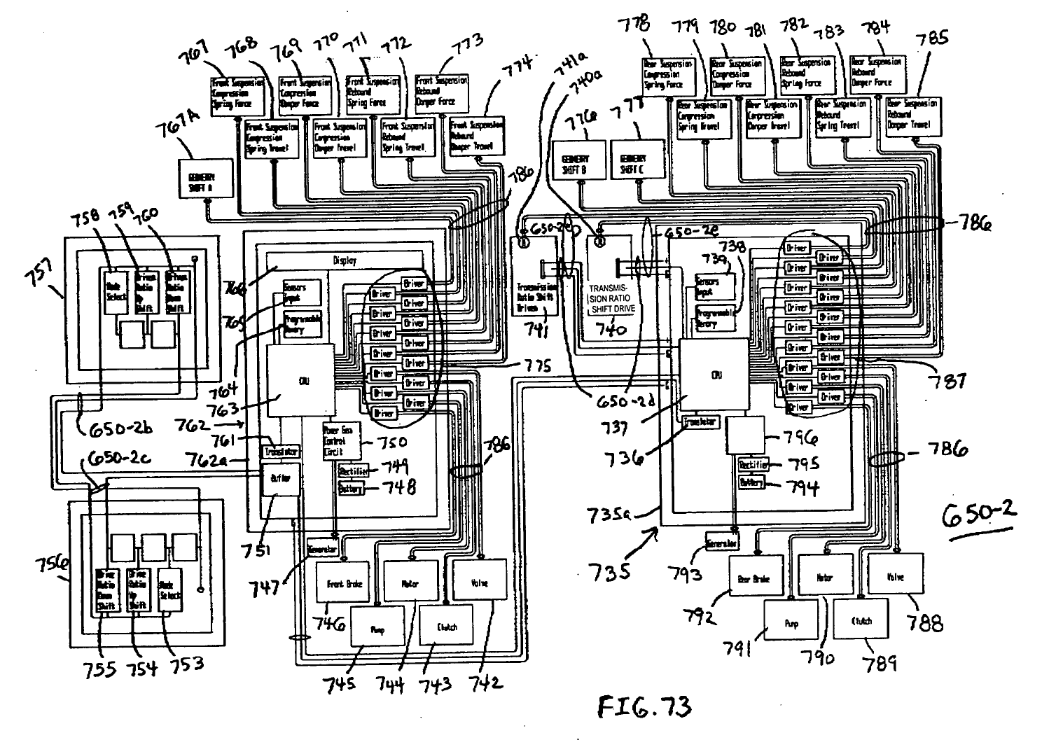

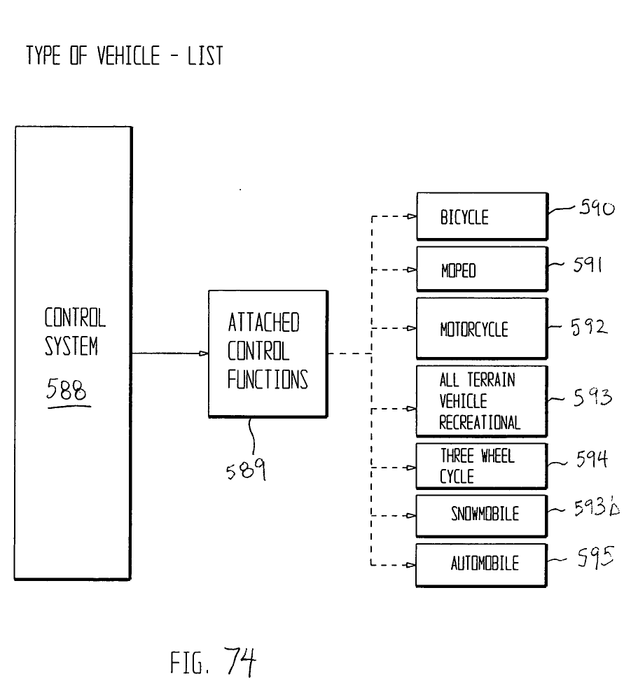

FIG. 72 depicts an embodiment of a control system similar to FIG. 71 wherein control system 650-1 comprises parameters for controlling one or more controllable functions which include geometry adjust functions, suspension functions, transmission ratio functions, braking functions, motor control functions, clutch control function, pump and valve control functions, and power generation control functions. Control system 650-1 receives manual inputs from selector switches 730-A, 730-B, 728, 728, and 726 and from potentiometer 729, sensor input signals from sensors input 721, and sensor inputs from translator 716. Translator 716 receives sensor signals via buffer 715 from drive ratio up shift 710, drive ratio downshift 711, driven ratio down shift 714, and driven ratio up shift 713 sensors. Control assembly 650-1 evaluates the input data information referencing parameter controls stored in programmable memory 720 through the processing of the data by central processing unit (CPU) 718. Control assembly 650-1 has electrical power supplied by power generator control circuit 717 that balances the system power requirements by using battery 723A or generator 708 or combinations of the two for operation. Visual display housing 732 houses selector switches 730-A, 730-B, 728, 728, and 726 and from potentiometer 729, receiver 724, clock/timer (RTC) 726, battery 723B, power circuit 725, and a visual display 731. Control system 650-1 processes the input data information through the parameter control algorithms to control vehicle control functions by generating outputs signals and sending them along control board 719 circuitry or wiring to control function motor circuit driver chips 701 which convert the output signals into control function specific values via communications channels 734 for motor system 704, rear brake system 707, front brake system 706, pump system 705, clutch system 703, valve system 702, front suspension compression spring force system 689, front suspension compression damper force system 691, front suspension rebound spring force system 693, front suspension rebound damper force system 695, front suspension compression spring travel system 690, front suspension compression damper travel system 692, front suspension rebound spring travel system 694, front suspension rebound damper travel system 696, rear suspension compression spring force system 686, rear suspension compression damper force system 687, rear suspension rebound spring force system 697, rear suspension rebound damper force system 699, rear suspension compression spring travel system 685, rear suspension compression damper travel system 688, rear suspension rebound spring travel system 698, rear suspension rebound damper travel system 700, geometry adjust shift system A 682, geometry adjust shift system B 683, geometry adjust shift system C 684, transmission ratio shift driven system 722, transmission ratio shift drive system 733, generator system 708, and visual display 731. Connection wiring 650-1a provides signal routing from the visual display housing 732 to the controller board assembly 681, connection wiring 650-1b provides signal routing for the transmission ratio mode selector 712 to controller board buffer 715, connection wiring 650-1c provides signal routing for the transmission ratio mode selector 709 to the controller board buffer 715, connection wiring 650-1d provides signal routing for the transmission ratio shift driven system 733 and transmission ratio shift drive system 722, and connection wiring 650-1e provides signal routing for the transmission ratio shift driven system motor 733a and transmission ratio shift drive system motor 722a to controller board assembly 681.

FIG. 73 is an embodiment of a control system similar to FIG. 71 wherein control system 650-2 comprises controller board assembly 762 and controller board assembly 735 each having a central processing unit and sensor inputs for controllable vehicle systems. The controller board assemblies are locatable in close proximity to each other or located apart to facilitate overall vehicle controllable system response times. Control system 650-2 comprises parameters for controlling one or more controllable functions which include geometry adjust functions, suspension functions, transmission ratio functions, braking functions, motor control functions, clutch control function, pump and valve control functions, and power generation control functions. Controller board assembly 762 receives sensor input signals from sensors input 765 and sensor inputs from translator 761. Translator 761 receives sensor signals via buffer 751 from drive ratio up shift 754, drive ratio downshift 755, driven ratio down shift 760, and driven ratio up shift 759 sensors. Controller board assembly 762 evaluates the input data information referencing parameter controls stored in programmable memory 764 through the processing of the data by central processing unit (CPU) 763. Controller board assembly 762 has electrical power supplied by power generator control circuit 750 that balances the system power requirements by using battery 748 through rectifier 749, generator 747, or combinations of the two for operation. Controller board assembly 762 processes the input data information through the parameter control algorithms to control vehicle control functions by generating outputs signals and sending them along control board 762a circuitry or wiring to control function motor circuit driver chips 775 which convert the output signals into control function specific values via communications channels 786 for motor system 744, front brake system 746, pump system 745, clutch system 743, valve system 742, front suspension compression spring force system 767, front suspension compression damper force system 769, front suspension rebound spring force system 771, front suspension rebound damper force system 773, front suspension compression spring travel system 768, front suspension compression damper travel system 770, front suspension rebound spring travel system 772, front suspension rebound damper travel system 774, geometry adjust shift system A 767, generator system 747, and visual display 766. Controller board assembly 735 receives sensor input signals from sensors input 739 and sensor inputs from translator 736. Translator 736 receives sensor signals via buffer 751 from CPU 763. On controller board assembly 735, central processing unit (CPU) 737 processes the input data information through parameter control algorithms in programmable memory 738 to control vehicle control functions by generating outputs signals and sending them along control board 735a circuitry or wiring to control function motor circuit driver chips 787 which convert the output signals into control function specific values via communications channels 786 for motor system 790, rear brake system 792, pump system 791, clutch system 789, valve system 788, rear suspension compression spring force system 778, rear suspension compression damper force system 780, rear suspension rebound spring force system 782, rear suspension rebound damper force system 784, rear suspension compression spring travel system 779, rear suspension compression damper travel system 781, rear suspension rebound spring travel system 782, rear suspension rebound damper travel system 785, geometry adjust shift system B 776, geometry adjust shift system C 777, transmission ratio shift driven system 741, transmission ratio shift drive system 740, and generator system 793. Controller board assembly 735 has electrical power supplied by power generator control circuit 796 that balances the system power requirements by using battery 794 through rectifier 795, generator 793, or combinations of the two for operation. Connection wiring 650-2b provides signal routing for the transmission ratio mode selector 758 to controller board buffer 751, connection wiring 650-2c provides signal routing for the transmission ratio mode selector 753 to the controller board buffer 751, connection wiring 650-2d provides signal routing for the transmission ratio shift driven system 741 and transmission ratio shift drive system 740 to controller board assembly 735, and connection wiring 650-2e provides signal routing for the transmission ratio shift driven system motor 741a and transmission ratio shift drive system motor 740a to controller board assembly 735.

FIG. 74 depicts a control system 588 with attached control functions 589 and representative vehicle types applicable, such as; bicycle assembly 590, moped assembly 591, motorcycle assembly 592, all terrain vehicle-recreational 593, three wheel cycle 594, snowmobile 593b, and automobile 595.

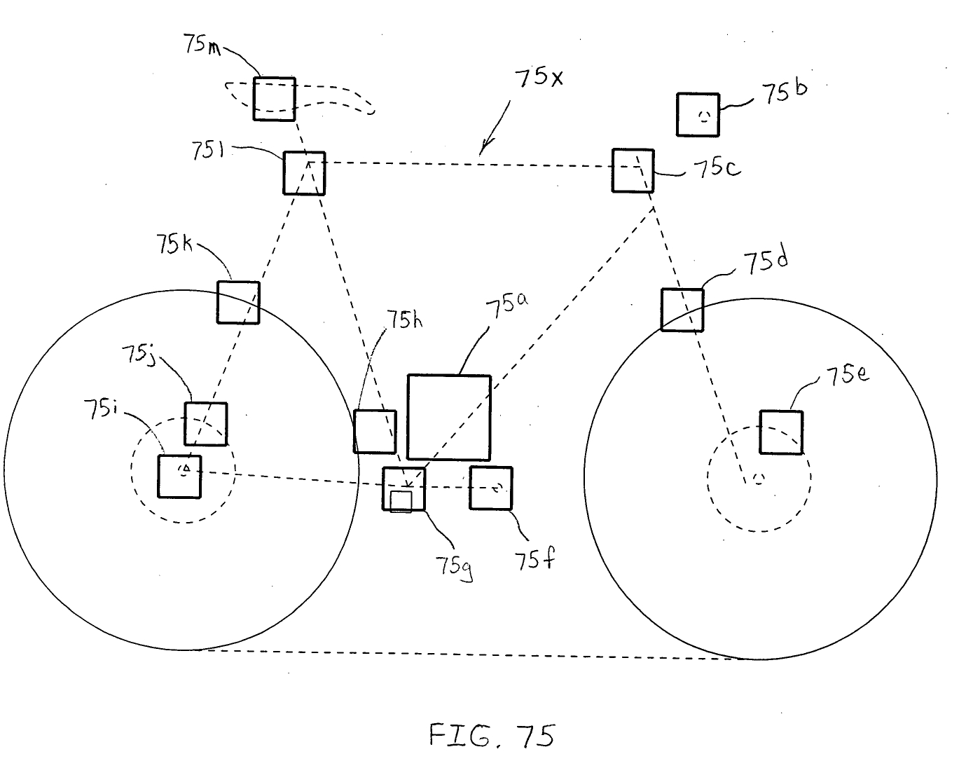

FIG. 75 depicts a bicycle assembly with a control system assembly and with multiple device control functions attached. Two or more controllable functions work independently from each other or interdependently based on the control system assembly mechanism. Road bicycle assembly 75x is an embodiment of a vehicle comprised of multiple attached dynamic functions and control system assembly 75a. Road bicycle assembly 75x has a steering assembly 75b, adjustable frame geometry assembly 75c, adjustable frame geometry assembly 75d, front brake assembly 75e, adjustable crank geometry assembly 75f, drive ratio function 75g, adjustable frame geometry assembly 75h, rear drive assembly 75i, rear brake assembly 75j, adjustable frame geometry assembly 75k, adjustable frame geometry assembly 75l, and adjustable frame geometry 75m which are adjusted through output signals from control system assembly 75a. Control system assembly 75a includes sensor devices and a control system as described in FIG. 1. Control system assembly 75a sensors send input signals to the controller, which based on control parameters, determines the output signals for the attached control functions. Control system assembly 75a outputs control signals to the attached dynamic functions 75b, 75c, 75d, 75e, 75f, 75g, 75h, 75i, 75j, 75k, 75l, and 75m through wire harness assemblies.

In FIG. 76, an embodiment of an off road bicycle assembly 76x with dynamically adjustable functions and a control system is shown. The off road bicycle 76x is comprised of front steering assembly 76b, front suspension assembly 76c, front brake assembly 76d, power input adjustable geometry assembly 76e, transmission drive ratio system 76f, rear arm assembly to drive arm assembly ratio geometry adjust assembly 76g, rear arm assembly to seat pillar assembly ratio geometry adjust assembly 76i, rear drive gear assembly 76j, seat pillar geometry adjust assembly 76h, rear brake assembly 76k, seat geometry adjust assembly 76l, and frame adjustable geometry assembly 76m which are dynamically adjusted through control system assembly 76a. Control system assembly 76a includes sensor devices and a control system as described in FIG. 1. Control system assembly 76a sensors send input signals to the controller, which based on control parameters, determines the output signals for the attached control functions. Control system assembly 76a outputs control signals to the attached dynamic functions 76b, 76c, 76d, 76e, 76f, 76g, 76i, 76j, 76k, 76l, and 76m through wire harness assemblies.

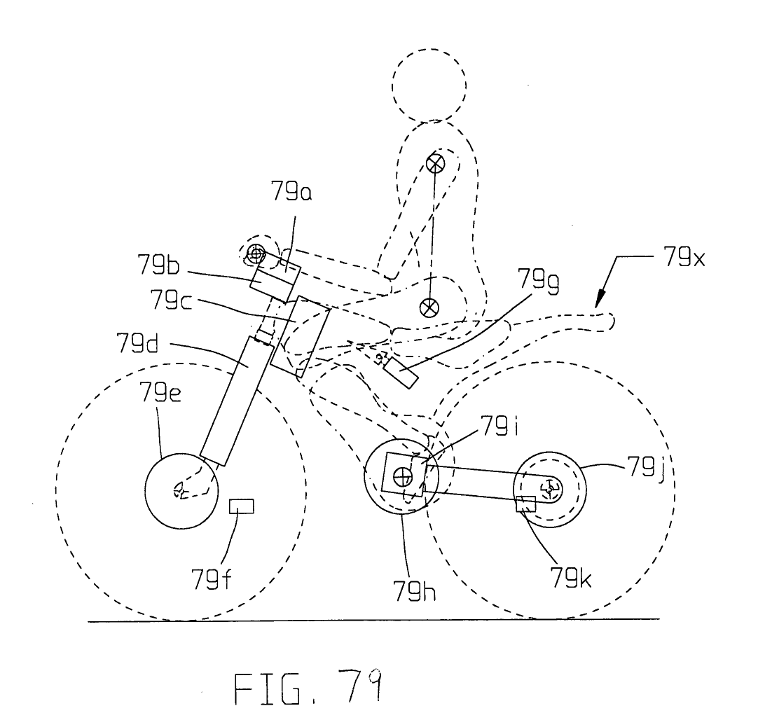

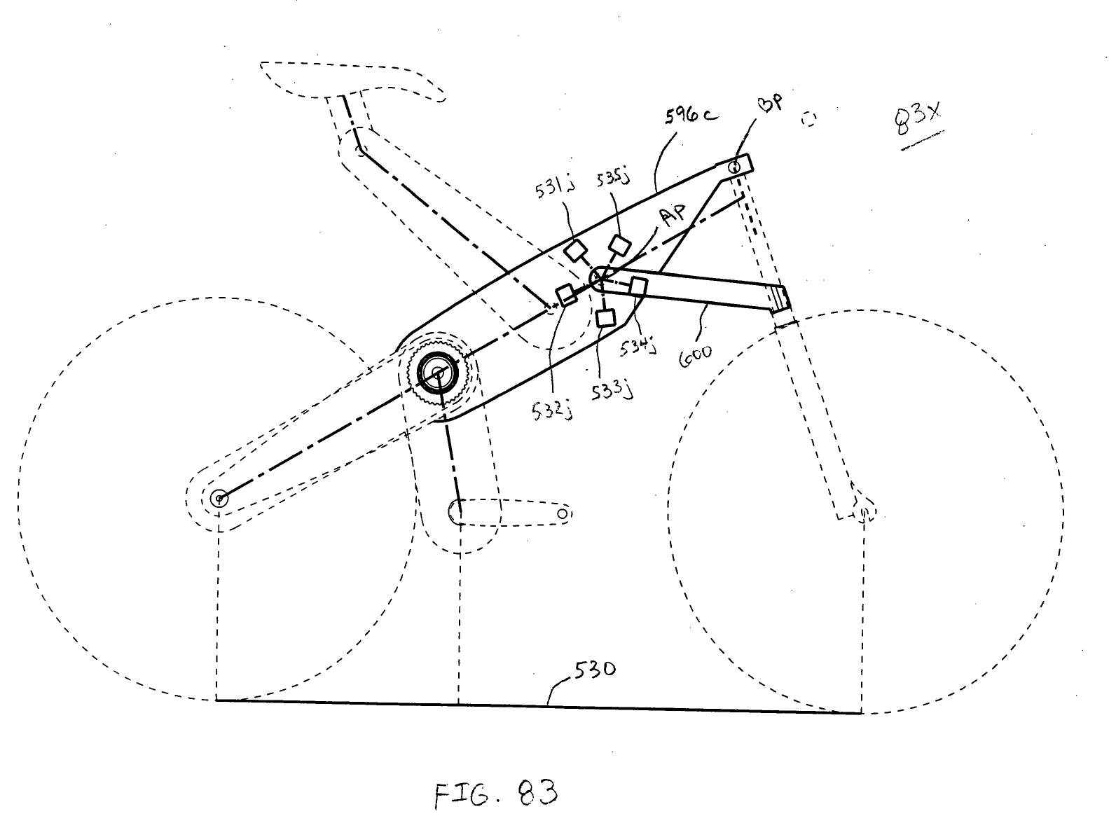

FIG. 77 depicts a recumbent bicycle assembly 77x with multiple attached dynamic devices and a control system 77b (referenced from FIG. 81 of U.S. Nonprovisional patent application: Ser. No. 10/113,931—Filed Apr. 2, 2002, Vehicles and Methods Using Center of Gravity and Mass Shift Control System, Inventor: Darrell W. Voss). The recumbent bicycle assembly 77x front steering assembly 77c, front gear system 77d, front suspension assembly 77f, front brake assembly 77g, front drive system 77e, rear suspension assembly 77i, rear drive gear assembly 77k, and rear brake assembly 77j are adjusted through control system assembly 77b. Control system assembly 77b includes sensor devices and a control system as described in FIG. 1. Control system assembly 77a sensors send input signals to the controller, which based on control parameters, determines the output signals for the attached control functions. Control system assembly 77b outputs control signals to the attached dynamic devices 77c, 77d, 77f, 77g, 77e, 77i, 77k, and 77j through wire harness assemblies.

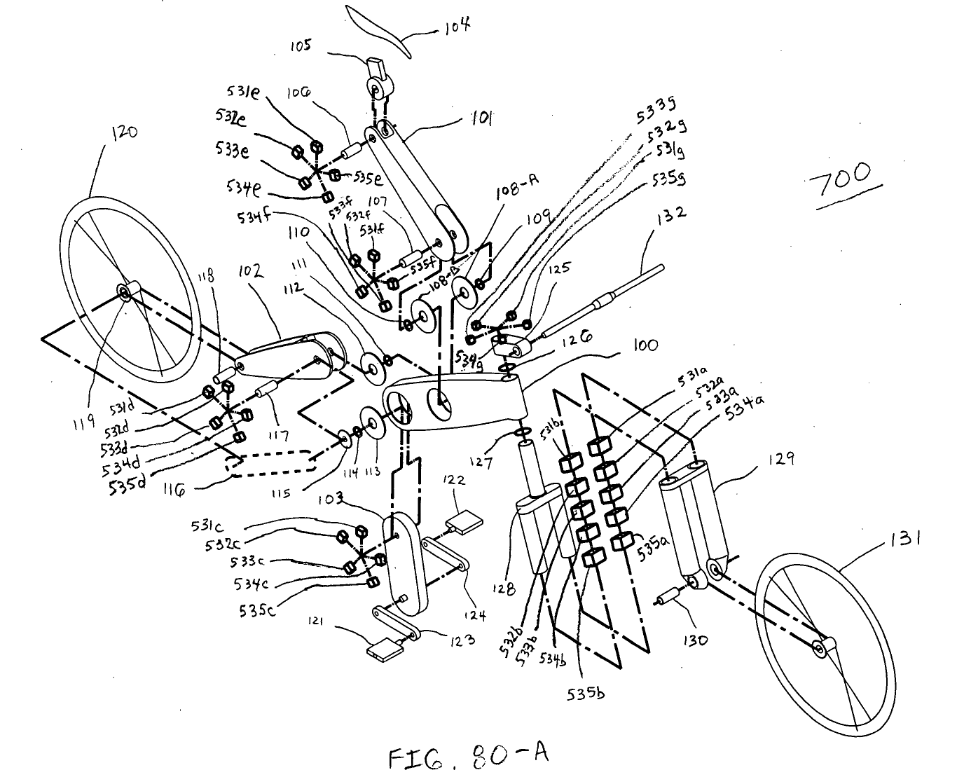

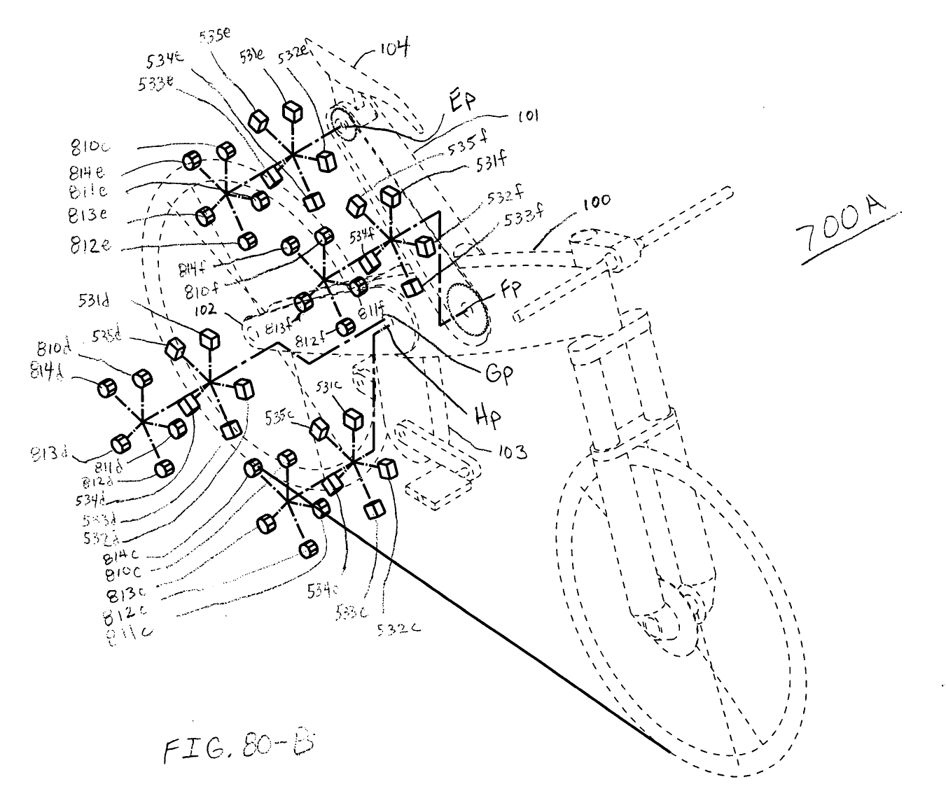

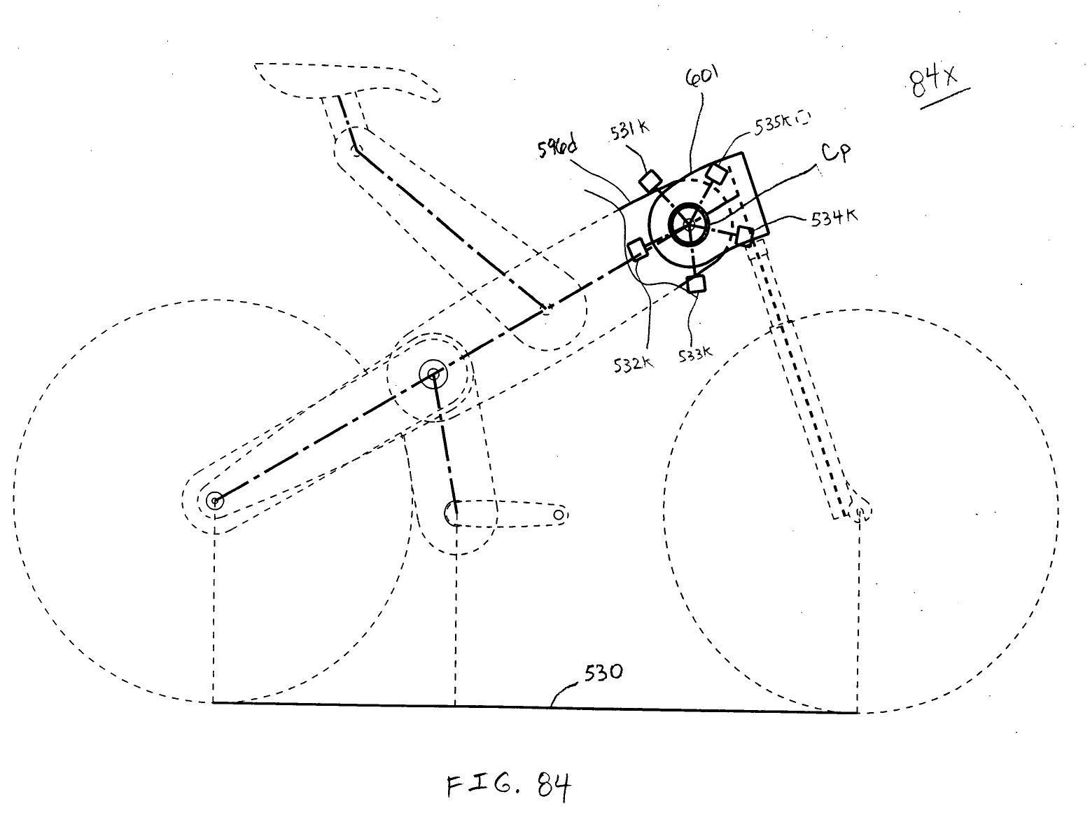

FIG. 78 is an embodiment of a tandem bicycle assembly 78x with multiple attached dynamic devices and a control system assembly 78c (referenced from FIG. 82 of U.S. Nonprovisional patent application: Ser. No. 10/113,931—Filed Apr. 2, 2002, Vehicles and Methods Using Center of Gravity and Mass Shift Control System, Inventor: Darrell W. Voss). The tandem bicycle assembly 78x front steering assembly 78d, front light system 78g, front suspension assembly 78f, frame adjustable geometry assembly 78e, front brake assembly 78h, front drive system 78i, front shoe retention assembly 78j, rear frame suspension assembly 78p, rear drive gear assembly 78k, middle suspension assembly 78o, rear frame geometry adjusting system 78n, rear safety lighting system 78m, rear steering suspension assembly 78q, middle drive assembly 78r, middle retention assembly 78s, and rear brake assembly 78l are adjusted through control system 78c. Control system assembly 78c will sensor conical areas 78a and 78b for C/G shift data. Control system assembly 78c includes sensor devices and a control system as described in FIG. 1. Control system assembly 78a sensors send input signals to the controller, which based on control parameters, determines the output signals for the attached control functions. Control system assembly 78c outputs control signals to the attached dynamic devices 78d, 78g, 78f, 78e, 78h, 78i, 78j, 78p, 78k, 78o, 78n, 78m, 78q, 78r, 78s, and 78L through wire harness assemblies.

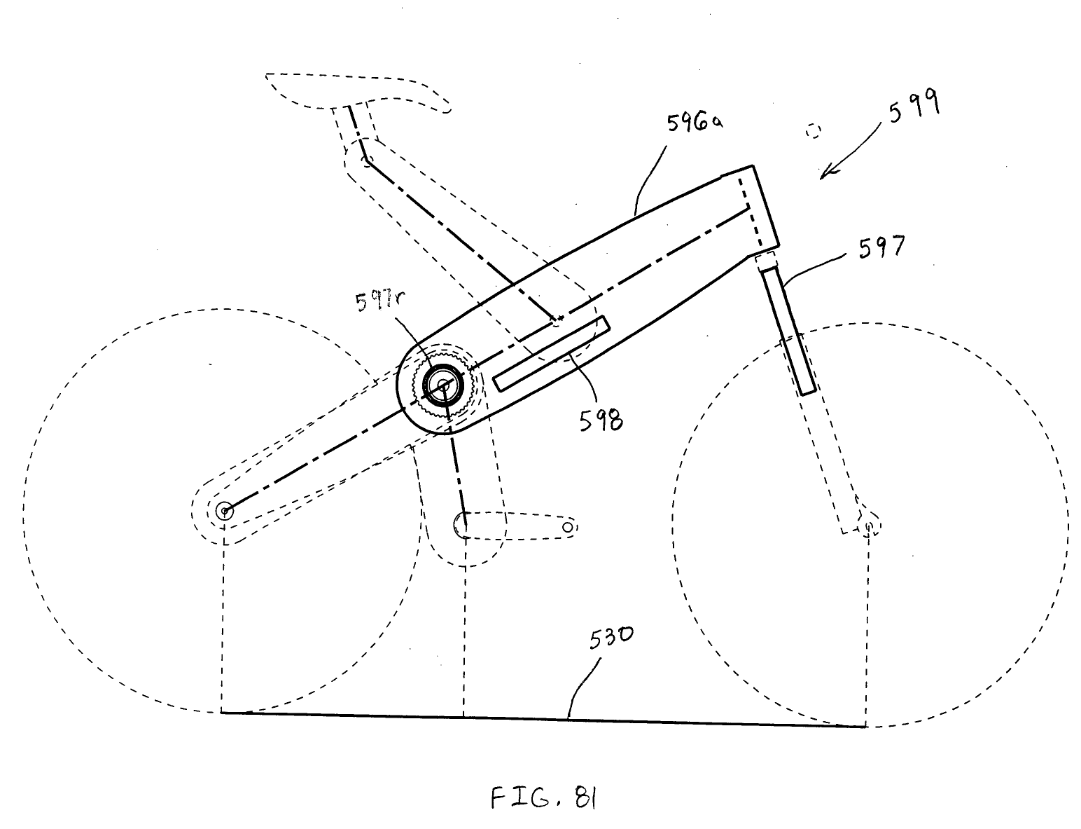

FIG. 79 is a depiction of an embodiment of a motorcycle assembly 79x with a control system assembly 79l and with dynamically controllable functions attached (referenced from FIG. 72 of U.S. Nonprovisional patent application: Ser. No. 10/113,931—Filed Apr. 2, 2002, Vehicles and Methods Using Center of Gravity and Mass Shift Control System, Inventor: Darrell W. Voss). The motorcycle front steering assembly 79b, frame adjustable geometry system 79c, front suspension 79d, front brake assembly 79f, front drive system 79e, rear suspension assembly 79g, power input assembly 79i, drive ratio assembly 79h, rear brake assembly 79k, and rear drive gear assembly 79j are adjusted through control system 79l. Control system assembly 79l will sensor c/g shift of user/payload 79a and terrain condition 79n to determine corrective outputs for the attached functions. Control system assembly 79l includes sensor devices and a control system as described in FIG. 1. Control system assembly 79l sensors send input signals to the controller, which based on control parameters, determines the output signals for the attached control functions. Control system assembly 79l outputs control signals to the attached dynamic functions 79b, 79c, 79d, 79e, 79f, 79g, 79h, 79i, 79j, and 79k through wire harness assemblies.

FIG. 80-A is an exploded view of a geometry adjustable suspension bicycle assembly 700 comprised of a main frame 100, seat pillar 101, rear support arm 102, and transmission drive ratio assembly 103. Seat 104 is connected to seat support arm 105 which is pivotably rotatable around seat support arm pin 106. A group of geometric adjust and suspension functions similar to those described in FIG. 54-B; including geometry adjust function 531e, spring rate function 532e, spring travel length function 533e, damping rate function 534e, and damping travel length function 535e control the geometry adjust ratio and suspension characteristics of the seat pillar 101 relationship to seat support 105 through seat support arm pin 106. Seat pillar 101, seat pillar bushing 108-A, seat pillar bushing 108-B, seat pillar bearing 109, and seat pillar bearing 110 to main frame 100 by seat pillar pin 107. Seat pillar 101 is pivotably rotatable around seat pillar pin 107. A group of geometric adjust and suspension functions similar to those described in FIG. 54-B, geometry adjust function 531f, spring rate function 532f, spring travel length function 533f, damping rate function 534f, and damping travel length function 535f control the geometry adjust ratio and suspension characteristics of the seat pillar 101 relationship to main frame 100 through seat pillar pin 107. Rear support arm 102, rear support arm bushing 112, rear support arm bushing 113, and rear support arm bearing 114 are connected to main frame 100 by rear arm support pin 117. Rear arm support 102 is pivotably rotatable around rear arm support pin 117. A group of geometric adjust and suspension functions similar to those described in FIG. 54-B, geometry adjust function 531d, spring rate function 532d, spring travel length function 533d, damping rate function 534d, and damping travel length function 535d control the geometry adjust ratio and suspension characteristics of the rear support arm 102 relationship to main frame 100 through rear arm support pin 117. Drive sprocket 115 is attached externally to the rear support arm 102 onto rear arm support pin 117. Wheel assembly 120 is connected to the rear arm assembly by wheel assembly hub pin 118. Hub driven sprocket 119 is attached to the wheel assembly 120. Endless loop assembly 116 couples drive sprocket 115 and hub driven sprocket 119 to transfer the output force of the transmission drive ratio assembly 103 to the wheel assembly 120. Transmission drive ratio assembly 103 is connected to main frame 100 by rear arm support pin 117. Transmission drive ratio assembly 103 is pivotable rotatable around rear arm support pin 117. A group of geometric adjust and suspension functions similar to those described in FIG. 54-B, geometry adjust function 531c, spring rate function 532c, spring travel length function 533c, damping rate function 534c, and damping travel length function 535c control the geometry adjust ratio and suspension characteristics of the transmission drive ratio assembly 103 to main frame 100 through rear arm support pin 117. The right pedal assembly 121 is connected to left crank arm 123 and left pedal assembly 122 is connected to left crank arm 123 wherein the vehicle user inputs energy via the rotatable pedal assemblies to the transmission drive ratio assembly 103. Handlebar 132 is connected to steering stem 125. Steering stem assembly 125 is connected to upper front arm assembly 128 and is rotatably pivotable to main frame 100 from support of the head tube bearing 126 and head tube bearing 127. A group of geometric adjust and suspension functions similar to those described in FIG. 54-B, geometry adjust function 531g, spring rate function 532g, spring travel length function 533g, damping rate function 534g, and damping travel length function 535g control the geometry adjust ratio and suspension characteristics of the steering stem assembly 125 relationship to main frame 100. Wheel assembly 131 is connected to lower leg assembly 129 by wheel hub axle 130. Lower front arm assembly 129 is connected to upper front arm assembly 128 and a group of geometric adjust and suspension functions similar to those described in FIG. 54-B, geometry adjust function 531b, spring rate function 532b, spring travel length function 533b, damping rate function 534b, and damping travel length function 535b, geometry adjust function 531a, spring rate function 532a, spring travel length function 533a, damping rate function 534a, and damping travel length function 535a control the geometry adjust ratio and suspension characteristics of the lower leg 129 and wheel assembly 131 relationship to main frame 100. Each grouping of geometry adjust and suspension functions shown are controlled individually and/or controlled together as ratios between two or more of the groups shown. An example of this is where the control system makes a geometry adjust of the seat pillar 101 angle to main frame 100 and a geometry adjust of the transmission drive ratio assembly 103 angle to main frame 100. Another example is where the control system makes an adjustment only to spring rate function 532d and to spring travel length function 533d. Although a group of geometry adjust and suspension functions similar to those described in FIG. 54-B, are shown herein for bicycle assembly 700, the control system is not limited to those control function types. As shown in FIG. 10, the control system is capable of processing an array of vehicle types and a vast array of vehicle system control function combinations.

FIG. 80-B is an embodiment of the bicycle assembly of FIG. 80-A wherein bicycle assembly 700A comprises multiple control function devices for geometry adjust and suspension control at pivotable locations on the vehicle frame identified in FIG. 80-A. Pivotable location Ep comprises one or more control functions including but not limited to geometry adjust individual control functions 810e, geometry adjust ratio function 811e, geometry adjust ratio function 812e, geometry adjust ratio function 813e, geometry adjust ratio function 814e, geometry adjust function 531e, spring rate function 532e, spring travel length function 533e, damping rate function 534e, and damping travel length function 535e to control the rotational geometric position of seat 104 in relation to seat pillar 101, main frame 100, rear support arm 102, and transmission drive ratio assembly 103. Pivotable location Fp comprises one or more control functions including but not limited to geometry adjust individual control function 810f, geometry adjust ratio function 811f, geometry adjust ratio, function 812f, geometry adjust ratio function 813f, geometry adjust ratio function 814f, geometry adjust function 531f, spring rate function 532f, spring travel length function 533f, damping rate function 534f, and damping travel length function 535f to control the rotational geometric position of seat pillar 101 to seat 104, main frame 100, rear support arm 102, and transmission drive ratio assembly 103. Pivotable location Gp comprises one or more control functions including but not limited to geometry adjust individual control function 810d, geometry adjust ratio function 811d, geometry adjust ratio function 812d, geometry adjust ratio function 813d, geometry adjust ratio function 814d, geometry adjust function 531d, spring rate function 532d, spring travel length function 533d, damping rate function 534d, and damping travel length function 535d to control the rotational geometric position of rear support arm 102 in relation to seat pillar 101, seat 104, main frame 100, and transmission drive ratio assembly 103. Pivotable location Hp comprises one or more control functions including but not limited to geometry adjust individual control function 810c, geometry adjust ratio function 811c, geometry adjust ratio function 812c, geometry adjust ratio function 813c, geometry adjust ratio function 814c, geometry adjust function 531c, spring rate function 532c, spring travel length function 533c, damping rate function 534c, and damping travel length function 535c to control the rotational geometric position of transmission drive ratio assembly 103 in relation to seat pillar 101, main frame 100, rear support arm 102, and seat 104.

FIG. 81 is an embodiment of a geometry adjustable full suspension bicycle assembly similar to FIG. 80-A wherein bicycle assembly 599 is comprised of a frame assembly 596a, a front assembly controllable geometry adjust and suspension system 597, a rear assembly and drive assembly connection 597r, and a controllable geometry adjust and suspension system 598 to adjust to terrain referenced by baseline 530.

FIG. 82 is an embodiment of the bicycle assembly of FIG. 81 wherein bicycle assembly 599b is comprised of a frame assembly 596b, a front assembly 597a with controllable suspension functions within; such as geometry adjust function 531h, spring rate adjust function 532h, spring travel length adjust function 533h, damping rate adjust function 534h, damping travel length adjust function 535h and a rear assembly and drive connection 597r-1 which incorporates controllable suspension system functions within; such as geometry adjust function 531i, spring rate adjust function 532i, spring travel length adjust function 533i, damping rate adjust function 534i, and damping travel length adjust function 535i to adjust to terrain referenced by baseline 530.

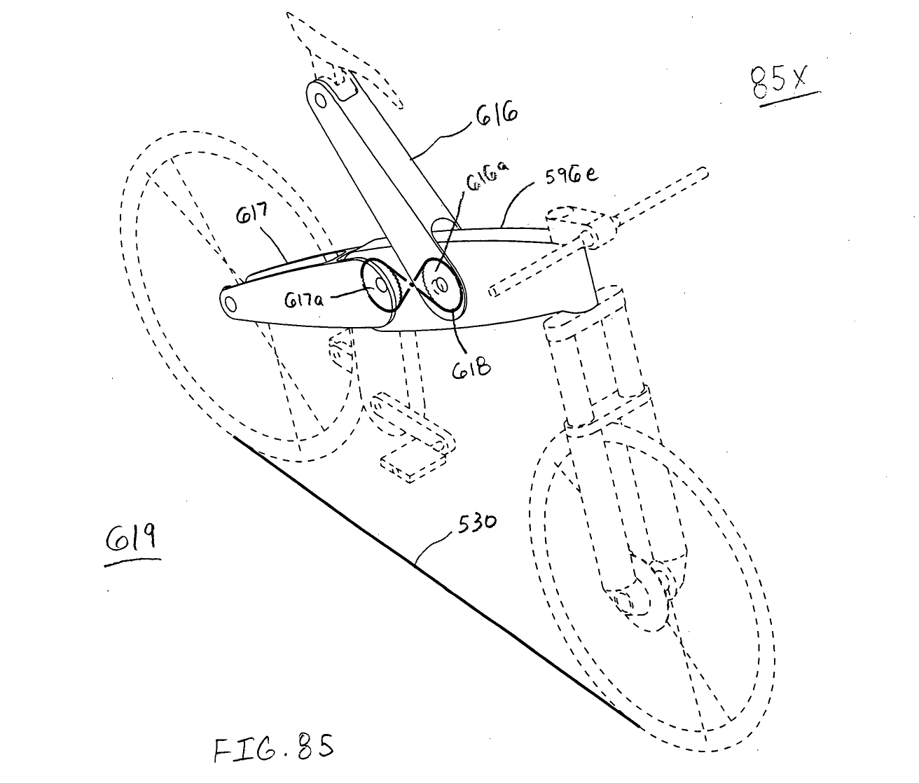

FIG. 83 is an embodiment of a bicycle assembly similar to FIG. 81 wherein bicycle assembly 83x is comprised of frame assembly 596c having an adjustable front angle through the connection of forward strut assembly 600 to the frame assembly 596c at pivot point Ap and connection Bp. Geometry adjust function 531j, spring rate adjust function 532j, spring travel length adjust function 533j, damping rate adjust function 534j, and damping travel length adjust function 535j adjust to improve the ride characteristics of bicycle assembly 83x in relation to the terrain referenced by baseline 530.

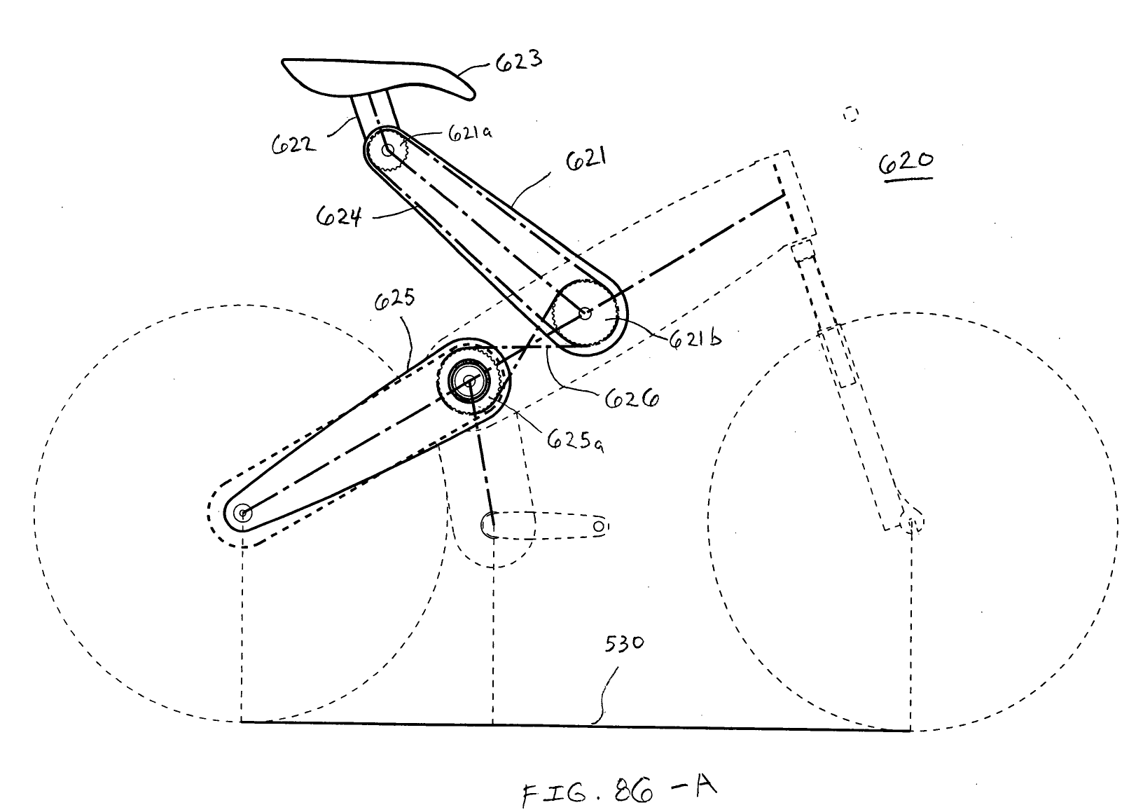

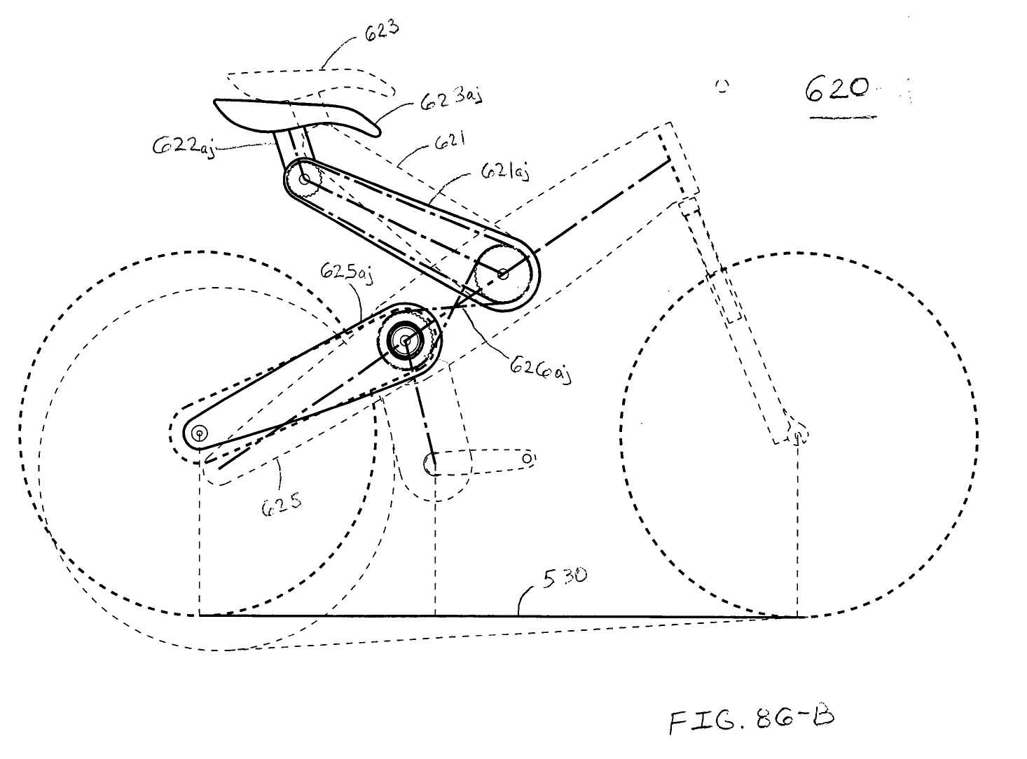

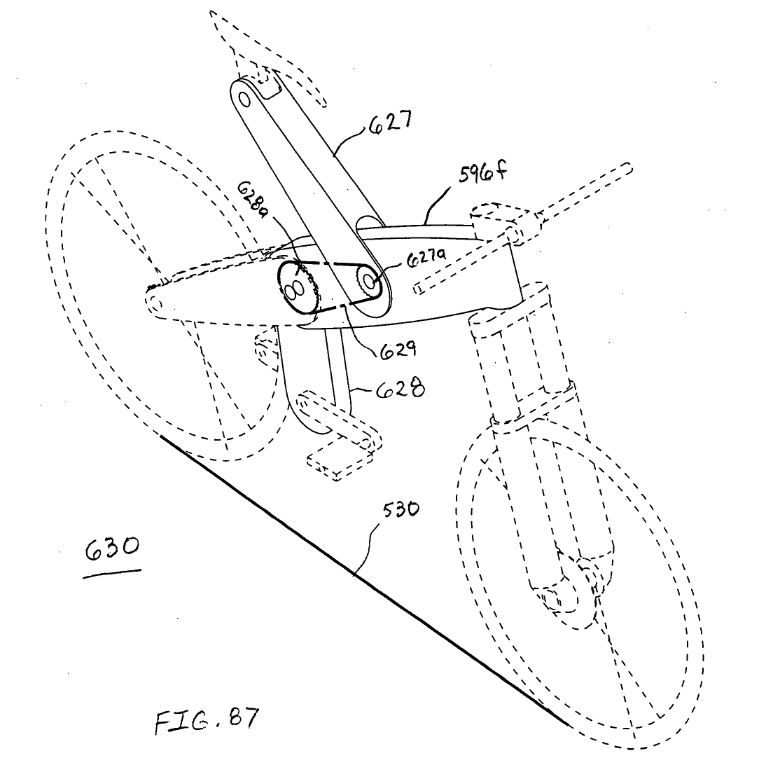

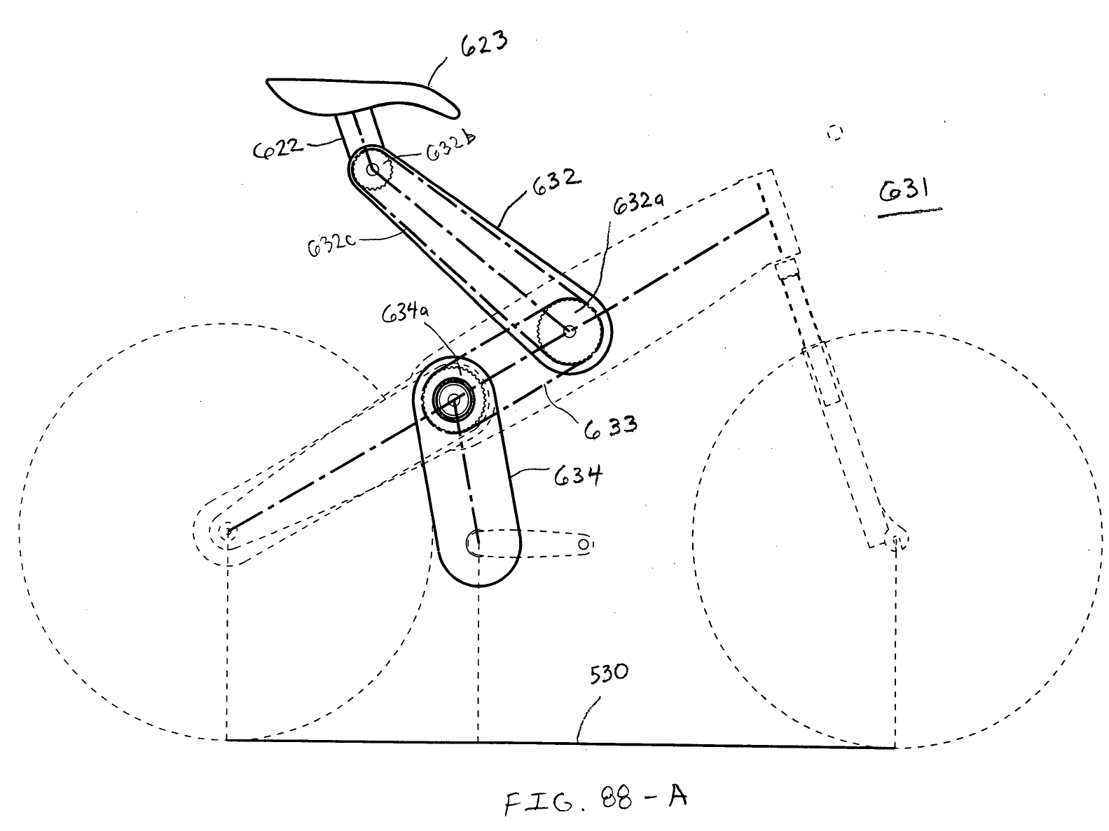

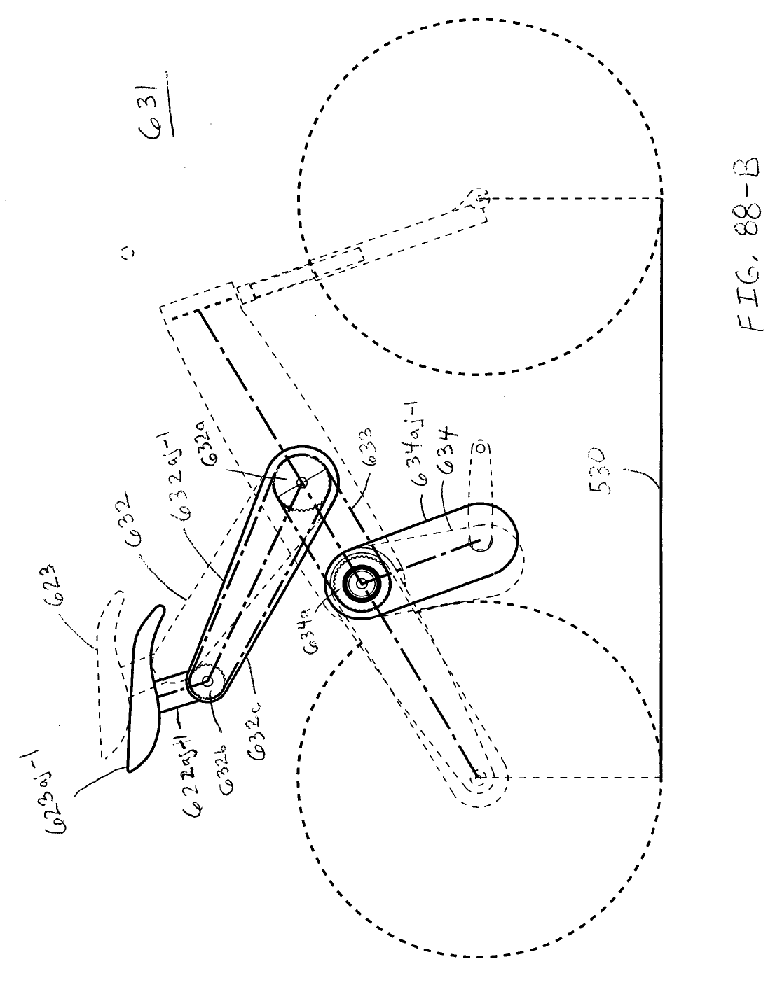

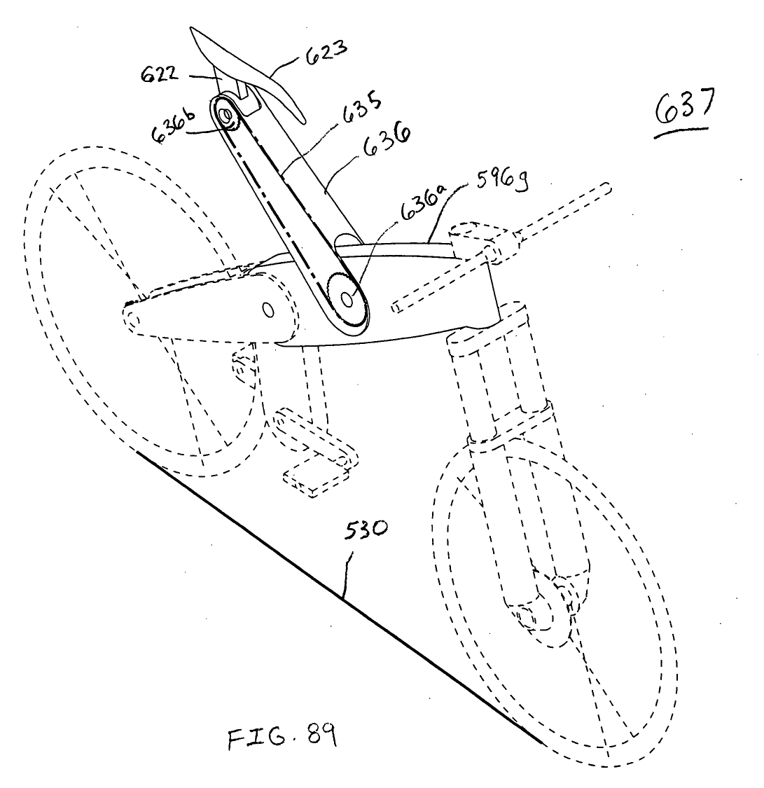

FIG. 84 is an embodiment of a bicycle assembly similar to FIG. 81 wherein bicycle assembly 84x is comprised of frame assembly 596d which has an adjustable front angle through the connection of forward pivoting assembly 601 to frame assembly 596d at connection Cp. Geometry adjust function 531k, spring rate adjust function 532k, spring travel length adjust function 533k, damping rate adjust function 534k, and damping travel length adjust function 535k adjust to improve the ride characteristics of bicycle assembly 84x in relation to the terrain referenced by baseline 530.

FIG. 85 is an embodiment of the bicycle assembly of FIG. 80-A wherein bicycle assembly 85x comprises an adjustable seat pillar 616 and rear arm assembly 617 connected to frame assembly 596e. Adjustable seat pillar 616 and rear arm assembly 617 are geometrically adjustable individually or in combination as a ratio to each other through the rotational movement of connecting element 618 to index elements 617a and 616a to adjust in relation to the terrain referenced by baseline 530.

FIG. 86-A is an embodiment of the bicycle assembly of FIG. 80-A wherein bicycle assembly 620 comprises an adjustable seat pillar 621 and adjustable rear arm assembly 625 connected to a frame assembly. Adjustable seat pillar 621 and seat support assembly 622 are geometrically adjustable individually or together as a ratio to each other through the rotational movement of connecting element 624 coupled to index elements 621a and 621b to adjust the seat 623 position. Adjustable seat pillar 621 and adjustable rear arm assembly 625 are geometrically adjustable individually or in combination as a ratio to each other through the rotational movement of connecting element 626 which is coupled to index elements 621b and 625a to adjust to the terrain represented by baseline 530.

FIG. 86-B is a depiction of the bicycle assembly 620 of FIG. 86-A with geometry adjusted positions of seat 623, adjustable seat support 623, adjustable seat pillar 621, and adjustable rear arm assembly 625 and the adjusted geometry positions represented by seat 623aj, adjustable seat support 622aj, and adjustable seat pillar 621aj. Connecting element 626aj is connected element 626 rotated. Rear arm assembly 625aj represents the adjusted position of rear arm assembly 625 in relation to the baseline 530.

FIG. 87 is an embodiment of the bicycle assembly of FIG. 80-A wherein bicycle assembly 630 comprises a geometrically adjustable seat pillar 627 and geometrically adjustable drive assembly 628 connected to frame assembly 596f. Geometrically adjustable seat pillar 627 and geometrically adjustable drive assembly 628 are controlled individually or in combination as a ratio to each other by the rotational movement of coupling element 629 which engages with index elements 627a and 628a to effect changes in the ride characteristics of bicycle assembly 630 as referenced by baseline 530.

FIG. 88-A is an embodiment of the bicycle assembly of FIG. 80-A wherein bicycle assembly 631 comprises an adjustable seat pillar 632 and an adjustable drive assembly 634 connected to a frame assembly. Adjustable seat pillar 632 and seat support assembly 622 are geometrically adjustable individually or in combination as a ratio to each other through the rotational movement of connecting element 632c coupled to index elements 632a and 632b to adjust the seat 623 position. Adjustable seat pillar 632 and adjustable drive assembly 634 are geometrically adjustable individually or in combination as a ratio to each other through the rotational movement of connecting element 633 which is coupled to index elements 634a and 632a to adjust to terrain referenced as baseline 530.

FIG. 88-B is a depiction of the bicycle assembly 631 of FIG. 88-A having geometrically adjusted positions of seat 623, adjustable seat pillar 632, and adjustable drive assembly 634. Seat 623aj-1, adjustable seat support 622aj-1, adjustable seat pillar 632aj-1, and adjustable drive assembly 634aj-1 represent the adjusted geometry positions in relation to baseline 530.

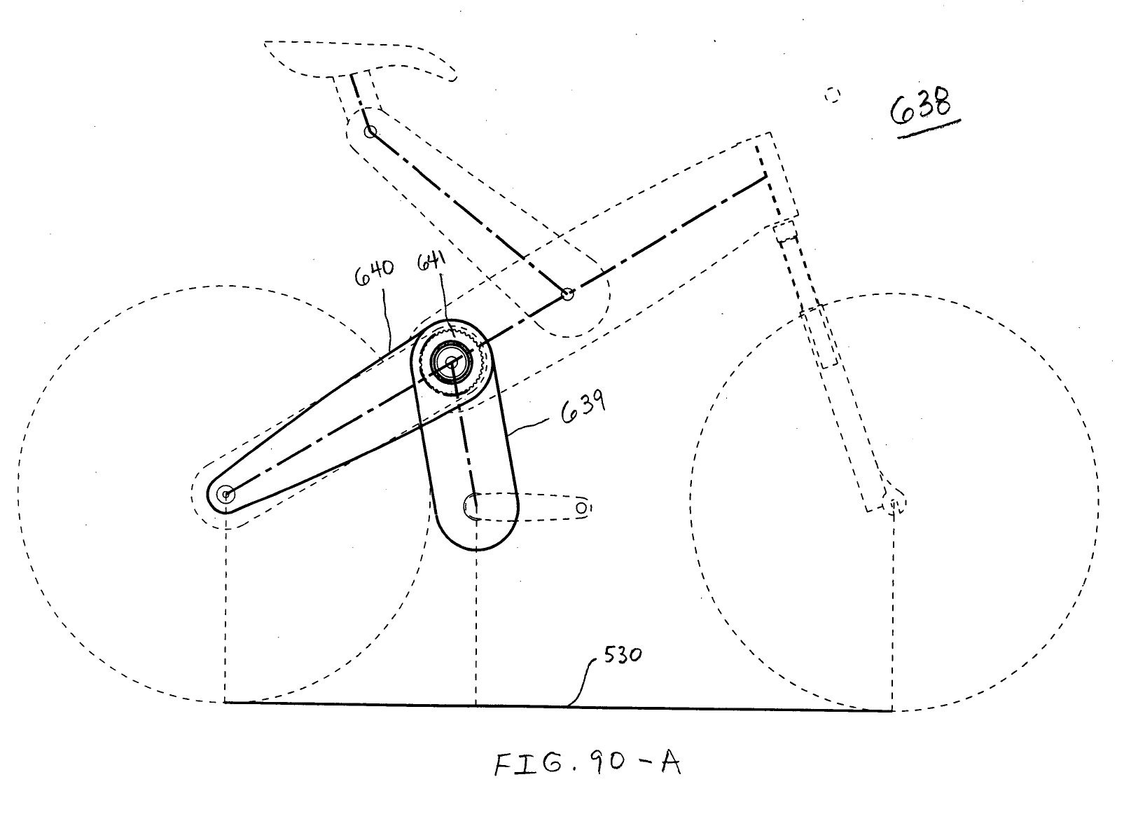

FIG. 89 is an embodiment of the bicycle assembly of FIG. 80-A wherein bicycle assembly 637 comprises a geometrically adjustable seat pillar 636 and seat support assembly 622 each connected to frame assembly 596g. Adjustable seat pillar 636 and seat support assembly 622 are geometrically adjustable individually or in combination as a ratio to each other through the rotational movement of connecting element 635 coupled to index elements 636a and 636b to adjust the seat 623 position to adjust to terrain referenced as baseline 530.

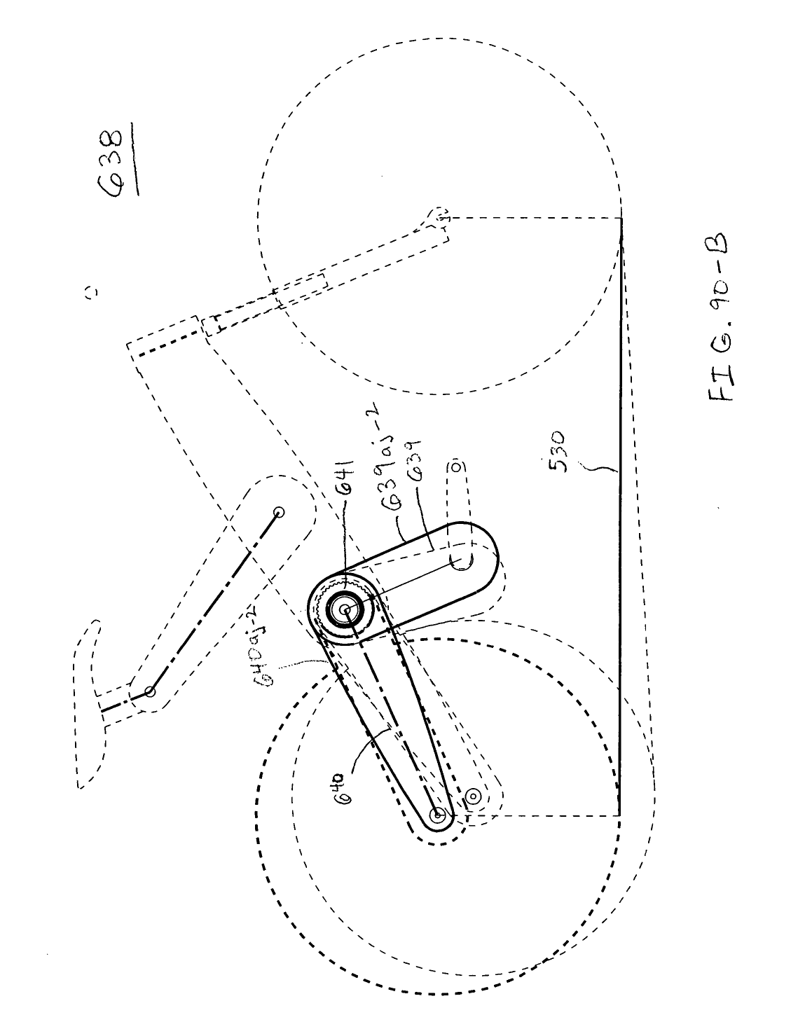

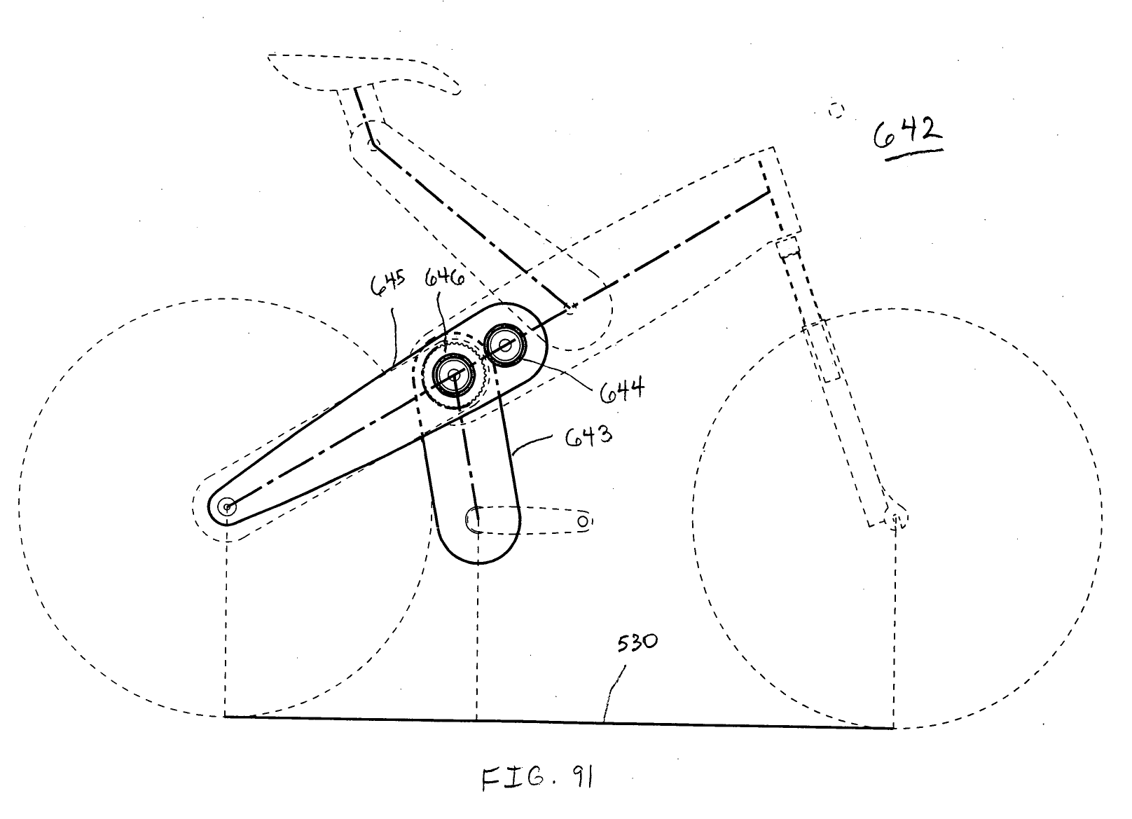

FIG. 90-A is an embodiment of the bicycle assembly of FIG. 80-A wherein bicycle assembly 638 comprises a geometrically adjustable rear arm assembly 640 and a geometrically adjustable drive assembly 639, each connected to a frame assembly. Geometrically adjustable rear arm assembly 640 and geometrically adjustable drive assembly 639 are controlled individually or in combination as a ratio to each other by the rotational movement of coupling element 641 to effect changes in the ride characteristics of bicycle assembly 638 when referenced to baseline 530.

FIG. 90-B is a depiction of the bicycle assembly 638 of FIG. 90-A with geometry adjusted positions of rear arm assembly 640 and drive assembly 639. Rear arm assembly 640aj-2 and drive assembly 639aj-2 represent adjusted geometry positions in relation to baseline 530.

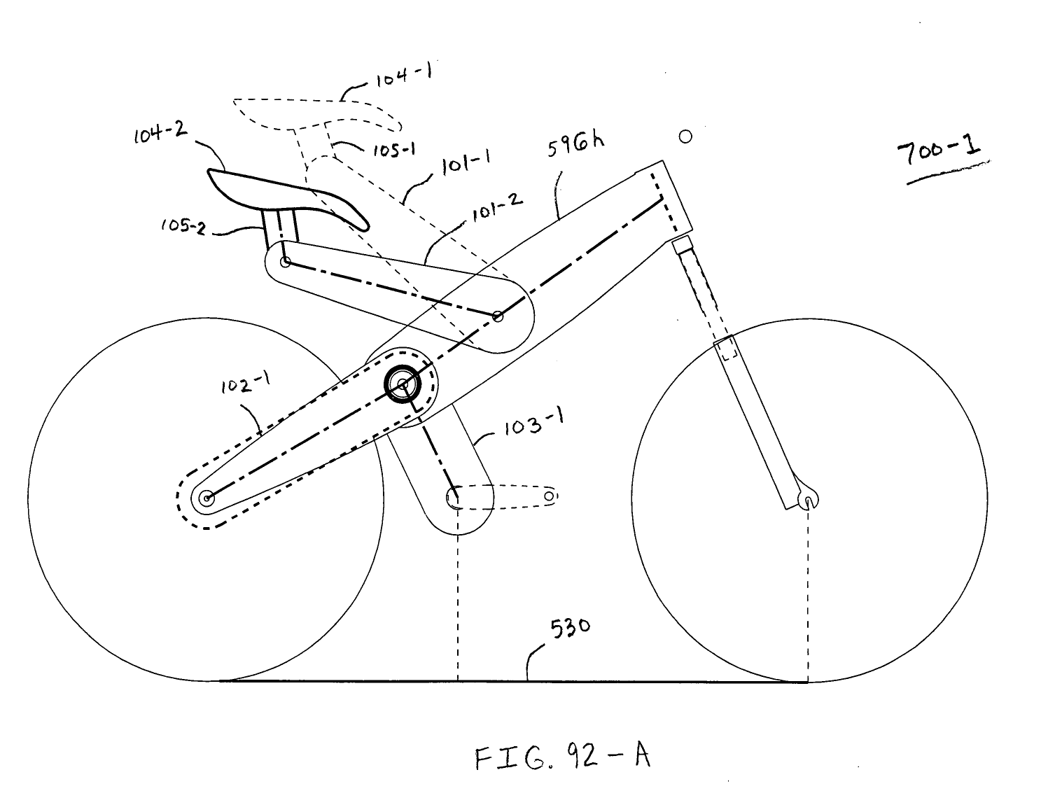

FIG. 91 is an embodiment of the bicycle assembly of FIG. 80-A wherein bicycle assembly 642 comprises a geometrically adjustable rear arm assembly 645 and a geometrically adjustable drive assembly 643 connected to a frame assembly. Geometrically adjustable rear arm assembly 645 and geometrically adjustable drive assembly 643 are controlled individually or in combination as a ratio to each other by the rotational movements of index elements 646 and 644 respectively to effect changes in the ride characteristics of bicycle assembly 642 when referenced to baseline 530.

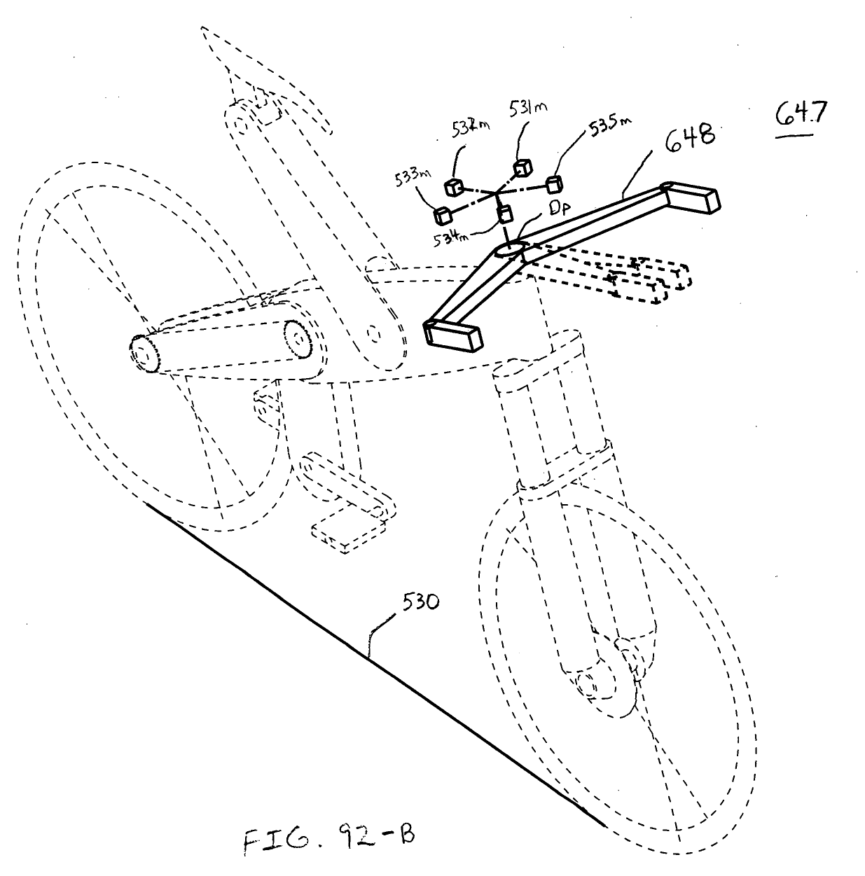

FIG. 92-A is an embodiment of the bicycle assembly of FIG. 80-A wherein bicycle assembly 700-1 comprises a geometrically adjustable rear arm assembly 102-1, a geometrically adjustable drive assembly 103-1, and a geometrically adjustable seat pillar assembly 101-1 connected to frame assembly 596h. Geometrically adjustable rear arm assembly 102-1, geometrically adjustable drive assembly 103-1, and geometrically adjustable seat pillar assembly 101-1 are controlled individually or in combinations as ratios to each other to affect ride characteristics of bicycle assembly 700-1 when referenced to baseline 530. Seat pillar assembly 101-2 is an example of a positional geometric adjustment. Seat 104-1 and seat support 105-1 are repositioned to seat 104-2 and seat support 105-2 locations, also. The rear arm assembly 102-1 and drive assembly 103-1 remain in position. This is only one example of multiple combinations of geometry adjustment available. The geometrically adjustable assemblies are adjustable individually, as ratios to one another individually, or as ratios pre-set for a group, or as ratios biased for a particular vehicle application; such as downhill, cross country, level, road, or rough terrain types of travel.

FIG. 92-B is an embodiment of the bicycle assembly of FIG. 80-A wherein bicycle assembly 647 comprises a geometrically adjustable steering assembly 648 having adjustable geometry positions rotatable about connection Dp. Control functions geometry adjust function 531m, spring rate adjust function 532m, spring travel length adjust function 533m, damping rate adjust function 534m, and damping travel length adjust function 535m are controllable singly or in combinations with each other to adjust the ride characteristics of bicycle assembly 647 in relation to baseline 530.

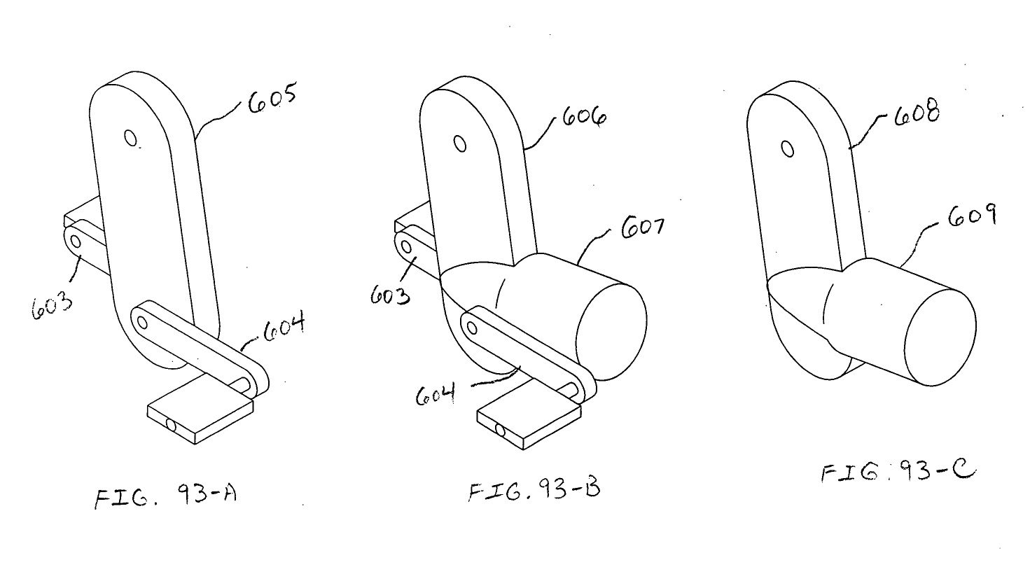

FIG. 93-A depicts an embodiment of a drive assembly similar to that shown in FIG. 80-A wherein drive assembly 605 with right pedal assembly 604 and left pedal assembly 603 is adaptable for the addition of accessory power supplies.

FIG. 93-B depicts a drive assembly similar to that shown in FIG. 93-A wherein the drive assembly 606 with right pedal assembly 604 and left pedal assembly 603 comprises a secondary power supply 607.

FIG. 93-C depicts a drive assembly similar to that shown in FIG. 93-B wherein the drive assembly 608 is adapted for the addition of power supply 609.

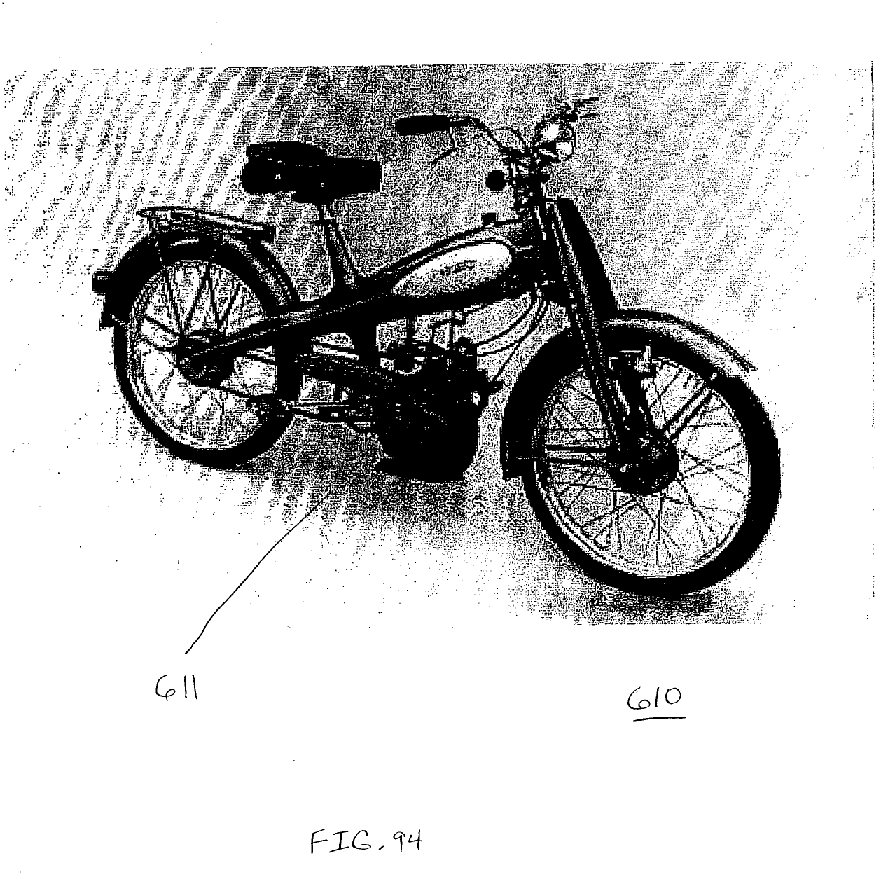

FIG. 94 depicts moped vehicle assembly 610 with moped control system 611 attached. The moped control system 611 is specifically designed to control the power input ratios common to a moped vehicle design.

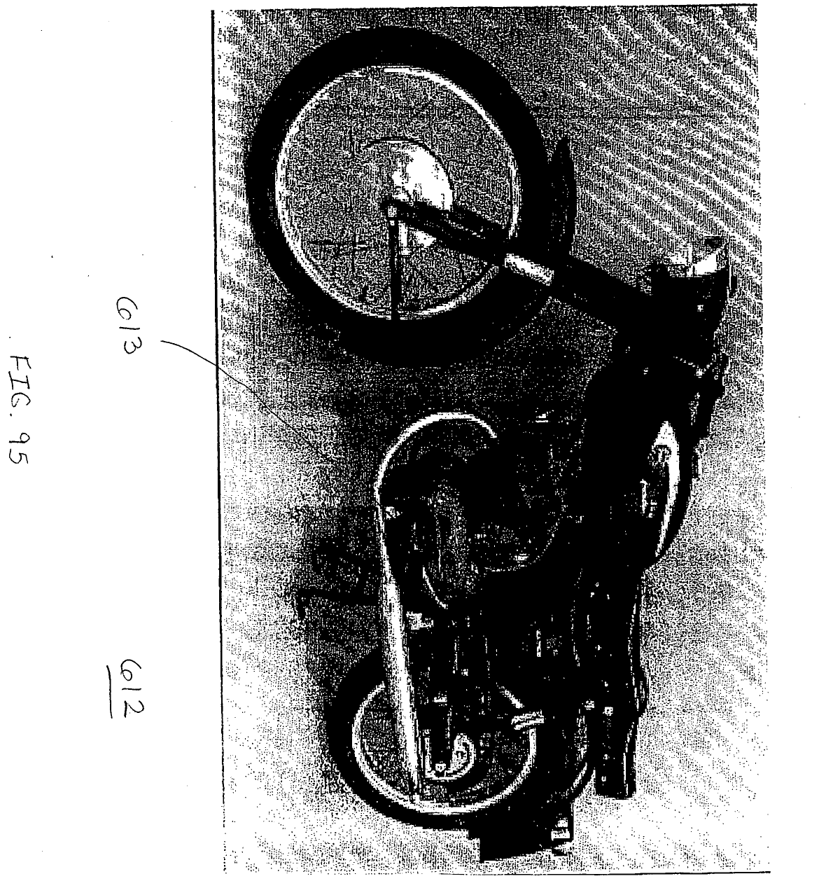

FIG. 95 depicts a motorcycle vehicle assembly 612 with motorcycle control system 613 attached. The motorcycle control system 613 is specifically designed to control the geometry ratios and suspension control functions of a motorcycle.

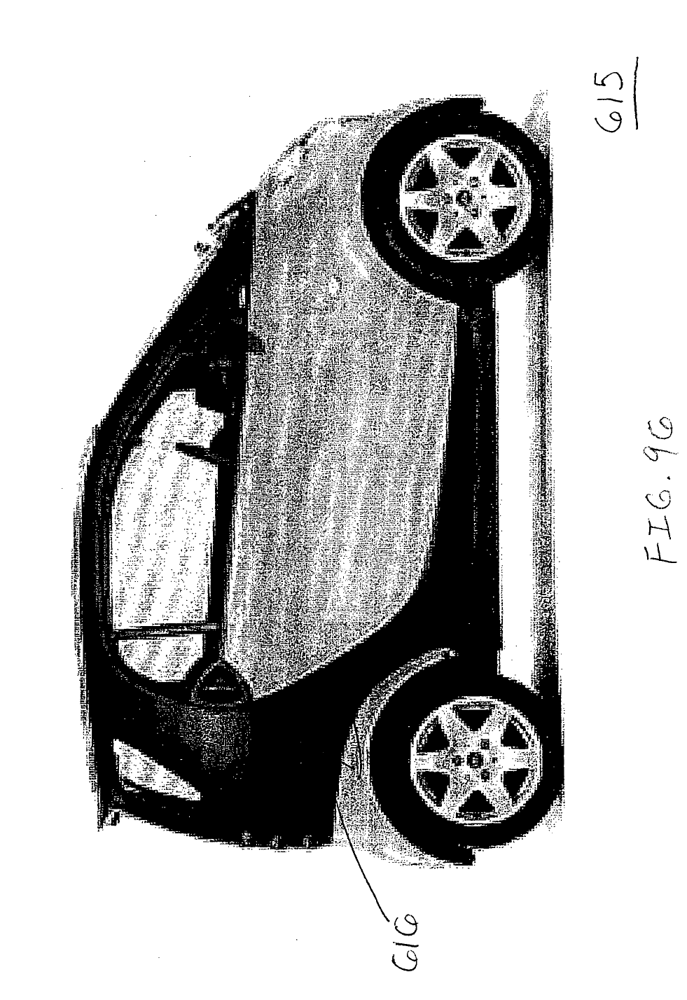

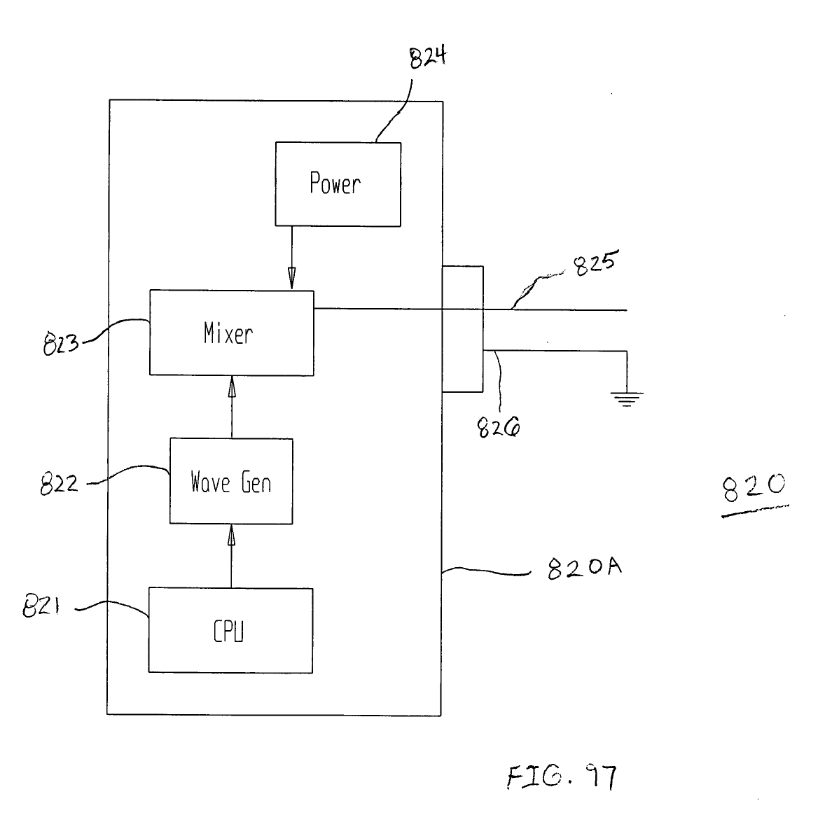

FIG. 96 depicts a vehicle assembly 615 with vehicle control system 616 attached. The vehicle control system 616 is specifically designed to control the frame geometry adjust ratios and suspension control functions of a small automobile.

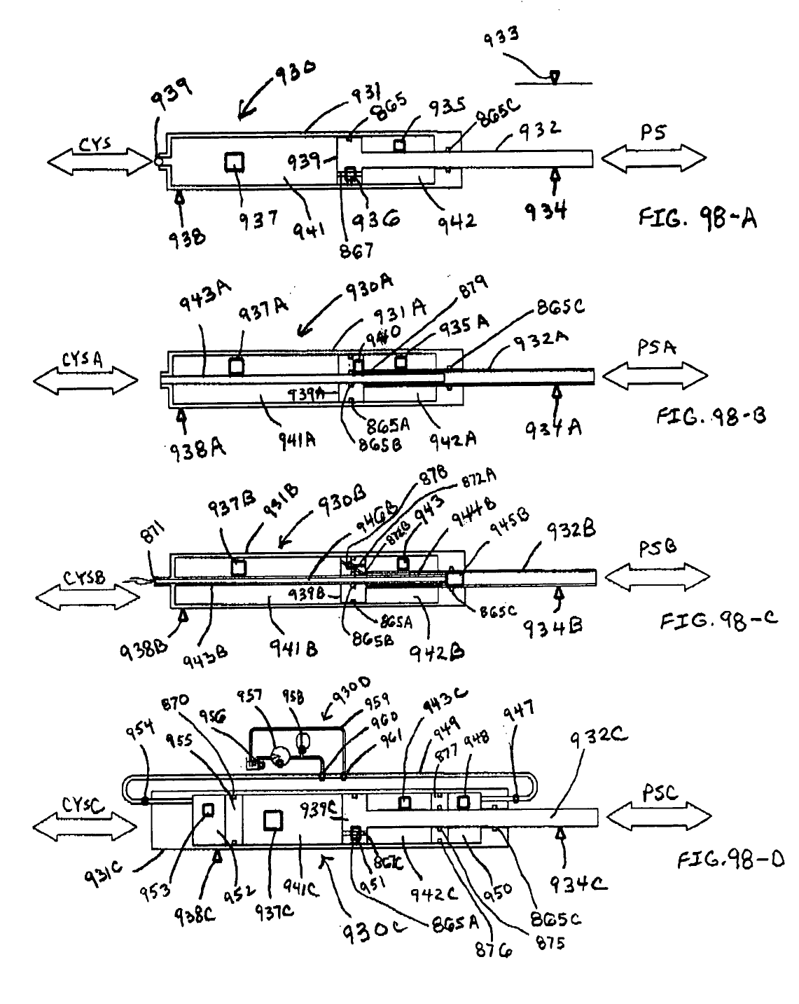

FIG. 97 depicts a simplified power supply control circuit 820 for a control system. Power supply circuit board 820A comprises central processing unit (CPU) 821, wave generator chip 822, power mixer chipset 823, and power inputs 824. Wire connection assembly 825 sends data and receives electrical power from power supply circuit board 820A and is grounded through ground connector 826. CPU 821 processes a balancing wave signal based on control system requirements and outputs through wave generator 822 to power mixer chipset 823. Power mixer chipset 823 processes power inputs 824 singly or in combinations to create a balanced power supply current through wire connection assembly 825 to a control system. The power supply control circuit 820 enables a control system to function using one or more power supply types including but not limited to a battery, generator, fuel cell electrical converter, solar power cell, or capacitor.

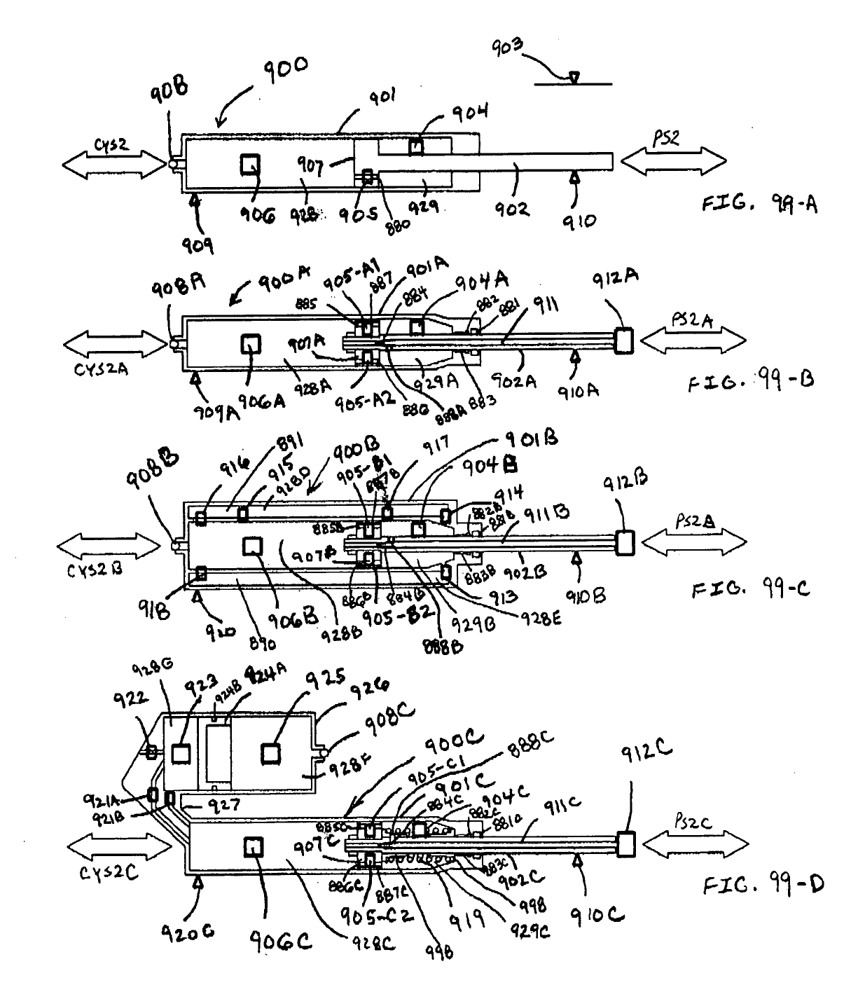

FIG. 98-A depicts a dynamically adjustable gas piston/cylinder suspension assembly 930 comprised of a piston shaft internal to a cylinder. Piston 939 mounted on shaft 932 has a hole through the piston where gas flow through piston port 867 is controlled by valve 936. Seal 865 is circularly mounted on piston 939 and seals to the internal cylinder diameter providing two separate chambers inside cylinder 931. Chamber 941 is ahead of the piston face and chamber 942 is on the shaft side of the cylinder. Sensor 937 measures gas pressure in chamber 941 and sensor 935 measures gas pressure in chamber 942. Gas is inserted into cylinder 931 through fill valve 939. Seal 865C is housed inside the cylinder 931 body and seals around shaft 932. Shaft location sensor 934 measures the location of the shaft as force PS is applied to the shaft end. Shaft velocity sensor 933 measures the speed of the shaft 932 movement. CYS is the vector of the cylinder shift force. Sensor 938 measures the cylinder temperature during operation. Port valve 936 provides adjustable control function of the gas piston cylinder as a spring with an adjustable spring rate.

FIG. 98-B depicts a dynamically adjustable gas piston/cylinder suspension assembly 930A comprised of a piston shaft internal to cylinder 931A. Piston 939A mounted on shaft 932A has a hole through the piston where gas flow through piston port 879 is controlled by valve 940. Seal 865A is circularly mounted on piston 939A and seals to the internal cylinder diameter providing two separate chambers inside cylinder 931A. Chamber 941A is ahead of the piston face and chamber 942A is on the shaft side of the cylinder. Sensor 937A measures gas pressure in chamber 941A and sensor 935A measures gas pressure in chamber 942A. Seal 865C is housed inside the body of cylinder 931A and seals around shaft 932A. Shaft location sensor 934A measures the location of the shaft as force PSA is applied to the shaft end. CYSA is the vector of the cylinder shift force. Sensor 938A measures the cylinder temperature during operation. Port valve 940A provides adjustable control function of the gas piston cylinder as a spring with an adjustable spring rate. Rod 943A mounted internal to shaft 932A creates a secondary piston action and is the output chamber for port 879. Seal 865B seals around the outer diameter of rod 943A and the inner piston 939A diameter.

FIG. 98-C depicts an embodiment similar to FIG. 98-A wherein dynamically adjustable gas piston/cylinder suspension assembly 930B is comprised of a piston shaft internal to cylinder 931B. Piston 939B mounted on shaft 932B has a hole through the piston where gas flows through piston ports 872A and 872B are controlled by valve 878. Seal 865A is circularly mounted on piston 939B and seals to the internal cylinder diameter providing two separate chambers inside cylinder 931B. Chamber 941B is ahead of the piston face and chamber 942B is on the shaft side of the cylinder. Sensor 937B measures gas pressure in chamber 941B and sensor 943 measures gas pressure in chamber 942B. Seal 865C is housed inside the body of cylinder 931B and seals around shaft 932B. Shaft location sensor 934B measures the location of the shaft as force PSB is applied to the shaft end. CYSB is the vector of the cylinder shift force. Sensor 938B measures the cylinder temperature during operation. Port valve 945B provides a gas flow from chamber 944B out through hollow chamber 946B of shaft 943B to exhaust 871. Port valves 878 and 945B provide adjustable control functions of the gas piston cylinder as a spring with an adjustable spring rate. Rod 943B mounted internal to shaft 932B creates a secondary piston action and is the output chamber for port 945B. Seal 865B seals around the outer diameter of rod 943B and the inner piston 939B diameter.

FIG. 98-D depicts a dynamically adjustable gas piston/cylinder suspension assembly 930C comprised of a piston shaft internal to cylinder 931C. Piston 939C mounted on shaft 932C has a hole through the piston where gas flow through piston port 867C is controlled by valve 951. Seal 865A is circularly mounted on piston 939C and seals to the internal cylinder diameter providing two main chambers inside cylinder 931C. Chamber 941C is ahead of the piston face and chamber 942C is on the shaft side of cylinder 931C. Sensor 937C measures gas pressure in chamber 941C and sensor 943C measures gas pressure in chamber 942C. Seal 865C is housed inside the body of cylinder 931C and seals around shaft 932C. Shaft location sensor 934C measures the location of the shaft as force PSC is applied to the shaft end. CYSC is the vector of the cylinder shift force. Sensor 938C measures the cylinder temperature during operation. Port valve 951 provides an adjustable control function of the gas piston cylinder as a spring with an adjustable spring rate. Floating piston 955 outer diameter has seal 870 circularly mounted to seal against the internal diameter of cylinder 931C inside the chamber 941C effectively forming a chamber 952 at the end of chamber 941C. Sensor 953 measures the internal pressure of chamber 952. The outer diameter of floating piston 877 has seal 876 circularly mounted to form a seal to cylinder 931C inner diameter thus forming another chamber 950. Seal 875 is mounted between shaft 932C and floating piston 877. External circuit assembly 930D connects to cylinder 931C at each end by connecting line 949. Valves 947 and 954 control gas flow in and out of outer chambers 950 and 952. The valve controls provide adjustable control functions of the gas piston cylinder as an adjustable spring travel device, adjustable rebound, and adjustable rebound travel. Line valves 960 and 961 provide for storage assembly 956, pump assembly 957, and accumulator and valve assembly 958 input through line 959.

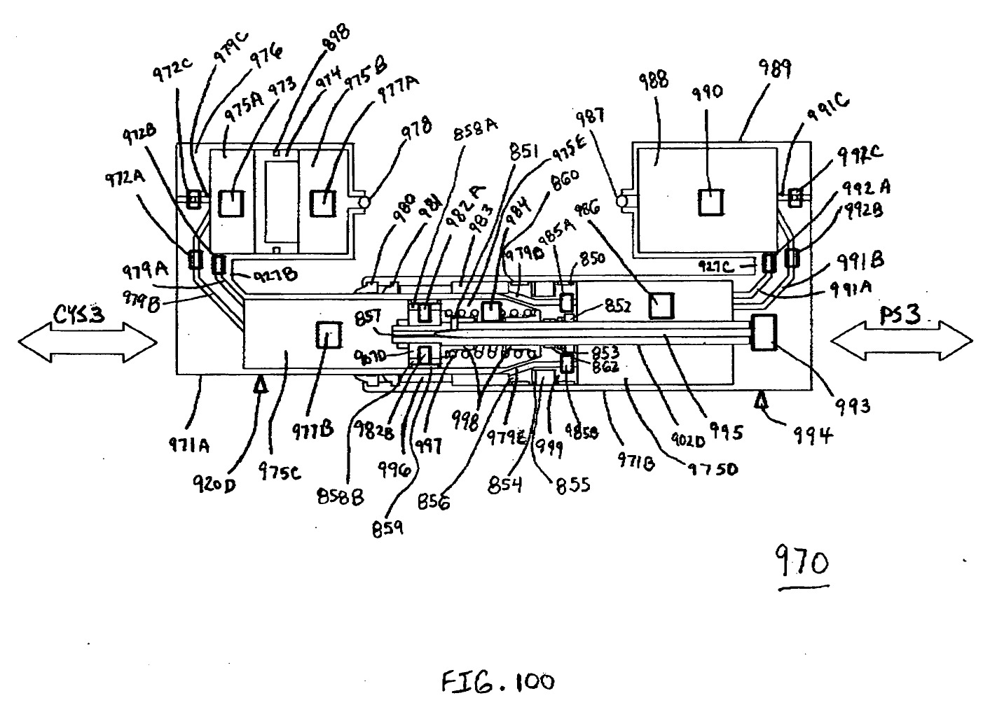

FIG. 99-A depicts dynamically adjustable fluid piston/cylinder suspension assembly 900 comprised of cylinder 901 with a piston shaft assembly. Piston 907 having a through hole 880 is mounted to shaft 902. The piston divides cylinder 901 into chamber 928 and chamber 929. Sensors 906 and 904 measure internal pressures of chamber 928 and chamber 929 respectively. Sensor 909 measures cylinder temperature. Port 908 is the fluid fill port for the cylinder. Shaft location sensor 910 measures the location of the shaft as force PS2 is applied to the shaft end. Shaft velocity sensor 903 measures the speed of the shaft 910 movement. CYS2 is the vector of the cylinder shift force. Port valve 905 controls the fluid flow through hole 880 providing an adjustable damping function for a suspension assembly.

FIG. 99-B depicts a dynamically adjustable fluid piston/cylinder suspension assembly 900A comprised of cylinder 901A with a piston shaft assembly. Piston 907A having through holes 885 and 886 with port valves 905-A1 and 905-A2 respectively controlling flow through the holes is mounted to shaft 902A. The piston divides cylinder 901A into chamber 928A and chamber 929A. Bushing sleeve 887 is mounted on the outside of piston 907A as a guide along the inner diameter of cylinder 901A. Sensors 906A and 904A measure internal pressures of chamber 928A and chamber 929A respectively. Sensor 909A measures cylinder temperature. Port 908A is the fluid fill port for the cylinder. Shaft 902A has an internal rod 911A with an adjuster 912A on the external end and a tapered needle shape 884 on the piston end. Tapered needle shape 884 seats across port 888A and acts as a return speed adjustment control. Piston shaft sleeve 883 supports the piston shaft 902A against the cylinder 901A body. Seal 882 is between shaft 902A and cylinder 901A. Wiper 881 prevents external debris from entering the cylinder along the shaft 902A outer diameter. Shaft location sensor 910A measures the location of the shaft as force PS2A is applied to the shaft end. CYS2A is the vector of the cylinder shift force. Port valves 905-A1 and 905-A2 control the fluid flow through the piston providing an adjustable damping function for a suspension assembly.

FIG. 99-C depicts a dynamically adjustable fluid piston/cylinder suspension assembly 900B comprised of cylinder 901B with a piston shaft assembly. Piston 907B having through holes 885B and 886B with port valves 905-B1 and 905-B2 respectively controlling flow through the holes is mounted to shaft 902B. The piston divides cylinder 901B into chamber 928B and chamber 929B. Cylinder 901B has an additional pair of outer cylinder chambers 928D and 928E where port valves 913 and 914 control return flow into the chambers. Port valves 915, 916, 917, 918 control the bypass flow from the outer cylinder chambers 928D and 928E to and from chambers 928B and 929B to provide an adjustable compression and rebound rate function. Bushing sleeve 887B is mounted on the outside of piston 907B as a guide along the inner diameter of cylinder 901B. Sensors 906B and 904B measure internal pressures of chamber 928B and chamber 929B respectively. Sensor 920 measures cylinder temperature. Port 908B is the fluid fill port for the cylinder. Shaft 902B has an internal rod 911B with an adjuster 912B on the external end and a tapered needle shape 884B on the piston end. Tapered needle shape 884B seats across port 888B and acts as a return speed adjustment control. Piston shaft sleeve 883B supports the piston shaft 902B against the cylinder 901B body. Seal 882B is between shaft 902B and cylinder 901B. Wiper 881B prevents external debris from entering the cylinder along the shaft 902B outer diameter. Shaft location sensor 910B measures the location of the shaft as force PS2B is applied to the shaft end. CYS2B is the vector of the cylinder shift force. Port valves 905-B1 and 905-B2 control the fluid flow through the piston providing an adjustable damping rate function for a suspension assembly.

FIG. 99-D depicts a dynamically adjustable fluid piston/cylinder suspension assembly 900C comprised of cylinder 901C with a piston shaft assembly and reservoir body 926 attached. Piston 907C having through holes 885C and 886C with port valves 905-C1 and 905-C2 respectively controlling flow through the holes is mounted to shaft 902C. The piston divides cylinder 901C into chamber 928C and chamber 929C. Reservoir body 926 having chambers 928G and 928F with pressure sensors 923 and 925 respectively has an internal piston 924A. Seal 924B is externally mounted between internal piston 924A and the reservoir body 926 inner diameter. Fill port 908C inputs into chamber 928F. The reservoir body 926 mounts to the cylinder 901C by connecting section 927. Connecting section 927 includes flexible connections and hard mounted connections to cylinder 901C. Port valves 921A and 921B control return flow into and from chamber 928G. Port valves 921A and 921B control the bypass flow from cylinder chamber 928C to and from chamber 928G to provide an adjustable compression and rebound rate function. Bushing sleeve 887C is mounted on the outside of piston 907C as a guide along the inner diameter of cylinder 901C. Sensors 906C and 904C measure internal pressures of chamber 928C and chamber 929C respectively. Sensor 920C measures cylinder temperature. Port 922 is the fluid fill port for the cylinder. Shaft 902C has an internal rod 911C with an adjuster 912C on the external end and a tapered needle shape 884C on the piston end. Tapered needle shape 884C seats across port 888C and acts as a return speed adjustment control. In chamber 929C a spring 919 is wrapped around shaft 902C and is mounted to spring seats 998 to provide an additional rebound rate. Piston shaft sleeve 883C supports the piston shaft 902C against the cylinder 901C body. Seal 882C is between shaft 902C and cylinder 901C. Wiper 881C prevents external debris from entering the cylinder along the shaft 902C outer diameter. Shaft location sensor 910C measures the location of the shaft as force PS2C is applied to the shaft end. CYS2C is the vector of the cylinder shift force. Port valves 905-C1 and 905-C2 control the fluid flow through the piston providing an adjustable damping rate function for a suspension assembly.

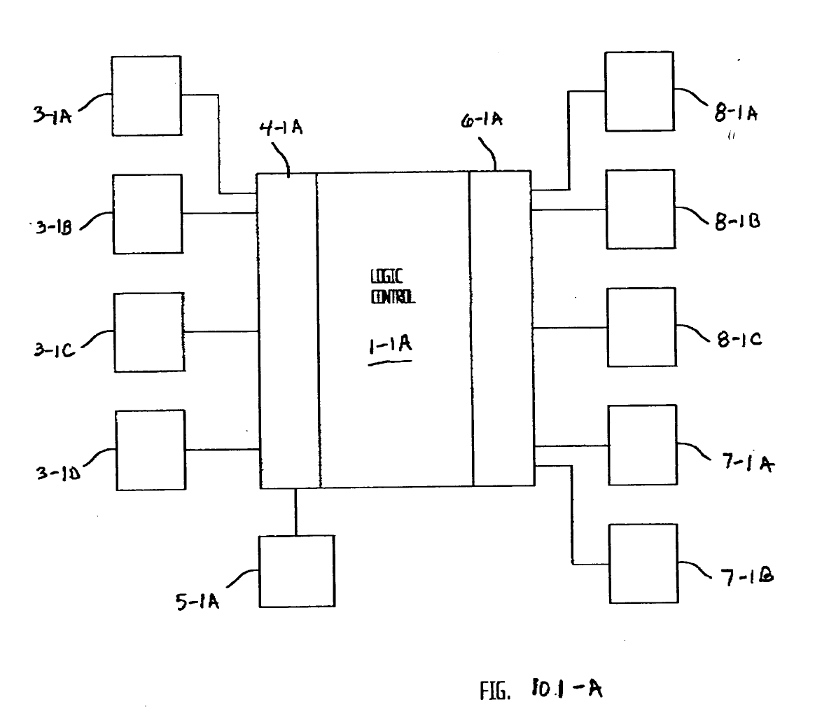

FIG. 100 depicts a dynamically adjustable gas and fluid piston/cylinder suspension assembly 970 comprised of cylinders 971A and 971B with a piston shaft assembly, reservoir body 976, and reservoir body 989 attached. Piston 907D having through holes 858A and 858B with port valves 982A and 982B respectively controlling flow through the holes is mounted to shaft 902D. The piston divides cylinder 971A into chamber 975C and chamber 983. Reservoir body 976 having chambers 975A and 975B with pressure sensors 973 and 977A respectively has an internal piston 974. Seal 898 is externally mounted between internal piston 974 and the reservoir body 976 inner diameter. Fill port 978 inputs into chamber 975B. The reservoir body 976 mounts to cylinder 971A by connecting section 927B. Connecting section 927B includes flexible connections and hard mounted connections to cylinder 971A. Port valves 972A and 972B control return flow into and from chamber 975A through channels 979A and 979B respectively. Port valves 972A and 972B control the bypass flow from cylinder chamber 975C to and from chamber 975A to provide an adjustable compression and rebound rate function. Bushing sleeve 859 is mounted on the outside of piston 907D as a guide along the inner diameter of cylinder 971A. Sensors 977B and 986 measure internal pressures of chamber 975C and chamber 983 respectively. Sensor 920D measures cylinder 971A operating temperature. Port 972C is the fluid fill port for the cylinder. Shaft 902D has an internal rod 995 with an adjuster 993 on the external end and a tapered needle shape 857 on the piston end. Tapered needle shape 857 seats across port 851 and acts as a return speed adjustment control. In chamber 975E a spring 997 is wrapped around shaft 902D and is mounted to spring seats 998 to provide an additional rebound rate. Piston shaft sleeve 862 supports the piston shaft 902D against the cylinder 971A body. Seal 853 is between shaft 902D and cylinder 971A. Wiper 852 prevents external debris from entering the cylinder along the shaft 902D outer diameter. Shaft location sensor 994 measures the location of the shaft as force PS3 is applied to the shaft end. CYS3 is the vector of the cylinder shift force. Port valves 982-A and 982-B control the fluid flow through the piston providing an adjustable damping rate function for a suspension assembly. Cylinder 971B is a gas spring system overlapping cylinder 971A. Support bushing 996 is mounted within cylinder 971B and provides a guide interface along the outer diameter of cylinder 971A. Seal 981 is housed in cylinder 971B to maintain pressure against cylinder 971A. Cylinder 971A has piston supports 856 and 999 engaging the inner diameter of cylinder 971B. Sleeves 850 and 860 provide a wear surface for piston supports 856 and 999. Cylinder 971B connects to reservoir 989 by connector 927C. Reservoir body 976 having chambers 975A and 975B with pressure sensors 973 and 977A respectively has an internal piston 974. Seal 898 is externally mounted between internal piston 974 and the inner diameter of reservoir body 976. Shim stack 854 provides additional shock adjustability in cavity 855. Wiper seal 980 is mounted within cylinder 971B and contacts the outer diameter of 971A. Fill port 987 inputs into chamber 988. The reservoir body 989 mounts to cylinder 971B by connecting section 927C. Connecting section 927C includes flexible connections and hard mounted connections to cylinder 971B. Port valves 992A and 992B control return flow into and from chamber 975A through channels 991A and 991B respectively. Sensor 990 measures pressure in chamber 988. Sensor 986 measures pressure in chamber 975D. Port 991C has valve 992C to control a pressure relief or exhaust gas adjustable function. Port valves 992A and 992B control the bypass flow from cylinder chamber 988 to and from chamber 975D to provide an adjustable spring rate function and a lock out function. Port valves 985A and 985B control bypass flows from chamber 975D to and from chamber 983 by channels 979D and 979E respectively to provide another adjustable spring rate function and a lock out function. Numerous suspension system constructions are possible to utilize the control system of FIG. 1 capability of controlling multiple functions. Geometry adjustable frame structures and suspension functions are controllable individually, in series, in parallel, and in serial and parallel combination when devices as shown herein are implemented in the vehicle assembly.

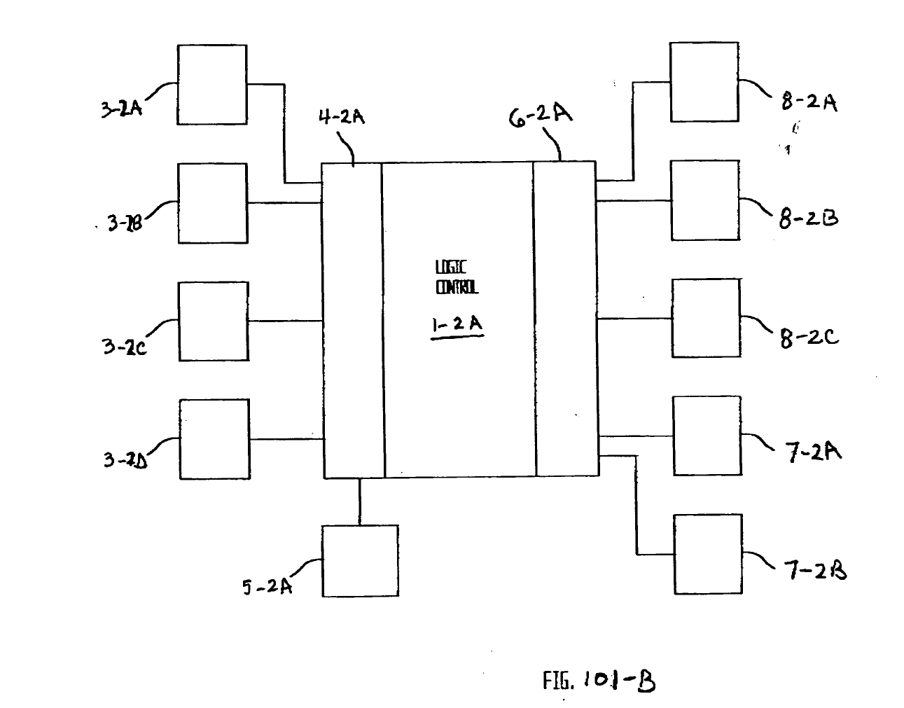

FIG.101-A depicts a logic control system wherein logic control 1-1A receives inputs 4-1A from sensors including; flow control sensor 3-1A, pressure sensor 3-1B, temperature sensor 3-1C, and viscosity sensor 3-1D and manual input 5-1A. Logic control 1-1A determines outputs 6-1A for dynamically controlled functions including; adjustable braking system 8-1A, adjustable frame geometry system 8-1B, adjustable suspension system 8-1C, adjustable transmission system 7-1A, and adjustable steering system 7-1B based on logic control parameters. Inputs 4-1A and outputs 6-1A are comprised of mechanical, hydraulic, pneumatic, electrical signals and combinations thereof. Manual input 5-1A includes selector valves, bias control valves, lock out valves, pressure relief valves, pneumatic push buttons, rotary valves, flow control valves, and timers. Logic control 1-1A operates independently, in sequence, in parallel, or in combinations thereof, with additional logic circuits and control systems. Logic control 1-1A enables logic control of multiple controllable functions for vehicle operation.

FIG. 101-B depicts a logic control system wherein logic control 1-2A receives inputs 4-2A from sensors including; flow control sensor 3-2A, pressure sensor 3-2B, temperature sensor 3-2C, and viscosity sensor 3-2D and manual inputs 5-2A. Logic control 1-2A determines outputs 6-2A for dynamically controlled functions adjustable spring rate 8-2A, adjustable damper rate 8-2B, adjustable spring travel length 8-2C, adjustable compression rate 7-2A, and adjustable rebound rate 7-2B based on logic control parameters. Manual input 5-2A includes selector valves, bias control valves, lock out valves, pressure relief valves, pneumatic push buttons, rotary valves, flow control valves, and timers. Logic control 1-2A operates independently, in sequence, in parallel, or in combinations thereof, with additional logic circuits and control systems. Logic control system 1-2A enables logic control specifically for adjustable suspension controlled functions to improve the ride characteristics of a vehicle.

Advantages and Benefits of an Improved Vehicle Systems and Method

Advantages

Improves vehicle characteristics through greater control of multiple or combined dynamic devices with controllable functions on a vehicle.

Eliminates the prior art limitations of vehicle to user contact point constraints.

Increases range of vehicle performance enhancements.

Enables control system to accept additional input variables.

Provides increased precision in device control from control outputs.

Increases the accuracy of combined attached device control functions.

Creates an increased range of selectable options for the user.

Allows for the integration of multiple vehicle coordination for group activity.

Enhances the effectiveness of existing vehicle safety systems.

Enables greater control of interaction and increased combinations of attached devices.

Benefits

The introduction of additional control parameters improves the control system's ability to tune the performance characteristics of the vehicle and to handle more variables in operating conditions beyond only surface irregularities. Operating conditions are possible to input as shift parameters, including but not limited to; weather conditions, group or individual conditions, ground type conditions, wet or dry surface conditions, training program conditions, speed of operation conditions, and many additional environmental conditions exist that influence the ride characteristics of a vehicle.

Example: A control parameter shift related to the user/payload is monitored, user has a free range of motion within the constraints of the contact points to the vehicle, and the vehicle has contact points to a regular or irregular surface. A control system based on control parameter shifts sends outputs to one or more of the vehicle's dynamically adjustable system controllable functions.

The additional control parameters increases the precision in applications controlling multiple attached devices, whether independently or cooperatively. The control combination of a vehicle braking system and a vehicle suspension system utilize this method to improve vehicle characteristics. When the two systems make independent changes in either system, the resulting changes in vehicle characteristics will influence the operating conditions of the independent systems. The control system is able to apply the parameter measurements to coordinate the two independent systems to improve the overall ride characteristics of the vehicle.

The control system parameters enable manual user inputs. The control system has the ability to be an interactive system from many sources. The base control program (BCP) may be interactively adjusted. The user can input a variable data shift into the BCP. A control parameter shift sensor on the vehicle can input data into the BCP. A control parameter shift sensor located off the vehicle can input data into the BCP via telemetry. A control parameter shift timer can input data into the BCP. Combinations of these types of inputs are also possible.

### DEFINITIONS AND NOTES

a) Transport: (v) to carry, move, or convey from one place to another.

b) Ride: (v) to be borne along or in a vehicle or other kind of conveyance.

c) Control: (n) A device for regulating or operating a machine or device

d) Control System: (n) A system that monitors inputs, analyzes data, calculates outputs, sends output signals (includes the combinations of software and hardware to achieve the above).

e) Operating System: (n) The collection of software that directs a machine's operations, controlling and scheduling the execution of other program(s) and functions, managing information storage, initiating input/output, and enabling communication resources. (Hardware dependent)

f) Hardware: (n) The mechanical devices or equipment required to conduct an activity.

Improved Vehicle and Method

What it is and does:

A vehicle having a device capable of receiving inputs from sensors creates output signals based on two or more control parameters to dynamically adjust two or more dynamic vehicle device functions to improve the ride characteristics of the vehicle.

Physically Needed:

Sensors—Measuring tool

Parameters—Measurable Condition

Control—Decision Maker

Devices—Vehicle device with controllable functions

Vehicle—with dynamic controllable function devices attached

Reference from EXISTING: C/G Specific Parameter

A vehicle for transporting a human body, said vehicle comprised of a dynamic attached system for operation, said vehicle having a center of gravity sensing device singly or in combination for producing signals indicative of the direction and rate of change in the center of gravity position and mass shift of said human body relative to said vehicle, a control system device responsive to said signals by controlling an output to said dynamic attached system to improve one or more ride characteristics of said vehicle.

EXISTING Method:

A method for improving one or more ride characteristics of a human body transport vehicle comprising the steps of:
a) sensing the direction of and rate of change in the center of gravity position and mass shift of said human body relative to said vehicle,
b) producing output control signals indicative of the direction and rate of change in the center of gravity position and mass shift of said human body relative to said vehicle; and
c) controlling one or more physical characteristics of said vehicle in response to said output control signals.

While the invention has been described in relation to preferred embodiments of the invention, it will be appreciated that other embodiments, adaptations and modifications of the invention will be apparent to those skilled in the art.

What is claimed is:

1. A vehicle for transporting a user and or a payload, said vehicle comprised of two or more dynamic attached controllable function means for operation, said vehicle having a plurality of parameter sensing devices for producing signals indicative of the change in said parameters, a control system device responsive to said signals by controlling output signals to said dynamic attached controllable function means for operation to improve one or more ride characteristics of said vehicle.

2. The vehicle defined in claim 1 wherein said control system converts said parameters sensing device inputs into output signals.

3. The vehicle defined in claim 1 wherein said parameter shift sensing devices are included: selected singly or in combinations thereof from accelerometers, strain gauges, single-axis gyroscopes, multi-axis gyroscopes, capacitive extentiometers, inclinometers, load cells, pressure gauges, flow gauges, inertial shift sensors, volumetric gage, viscosity gages, rotational gages, positional sensors, magnetic field sensors, optical sensors, laser sensors, sonar sensors, ultrasonic sensors, infrared sensors, velocity sensors, timer sensors, cycle counter sensors, tactile contact sensors, light emitting diode sensors, altimeters, temperature sensors, Hall's effect sensors, voice activated sensors, heart rate sensors, breathing rate sensors, body temperature sensors, transducer sensors, and satellite global positioning systems (GPS), wherein wired and wireless sensor systems are included and;
a) the parameter shift sensing devices may be mounted on said vehicle,
b) the parameter shift sensing devices may be mounted on said user and or payload,
c) the parameter shift sensing devices may be mounted off said vehicle within communication distance for the said devices by wireless communication.

4. The invention defined in claim 1 wherein said vehicle is user and or motor powered via electricity, internal combustion—including gasoline, hydrogen, and ethanol, solar, wind, steam, fuel cell, gravity, hydraulic, turbine engine, and combinations therein; including bicycles, mopeds, motorcycles, scooters, skateboards, tricycles, electric bicycles, all terrain recreational vehicles (ATV), snow bicycles, snowmobiles, unicycles, water sport vehicles, airplanes, and stationary bicycles.

5. The invention defined in claim 1 wherein said vehicle having vehicular system dynamic attached controllable function means, the said dynamic attached controllable function means receive output signals via mechanical, electrical, hydraulic, and pneumatic means from said control system.

6. The invention defined in claim 1 wherein said vehicle having parameter shifts sensing means signal output via mechanical, electrical, hydraulic, and pneumatic means to said control system.

7. The invention defined in claim 1 wherein said vehicle having a control system connected to the sensing means and processing the parameter shift direction and rate of shift inputs to produce predetermined corresponding output signals for said vehicular system dynamic attached controllable function means.

8. The invention in claim 1 wherein said vehicle uses an electronic circuit supplied by a power supply.

9. The invention in claim 1 wherein said vehicle having a control system capable of sensor input, manual input, and pre-programmed input (memory and removable storage devices).

10. The invention in claim 1 wherein said vehicle has two or more attached dynamic system control function means that includes: front suspension, rear suspension, front brake, rear brake, front drive gear, rear drive gear, adjustable structural assembly, energy absorption system, safety restraint device, crash avoidance system, data collection device, data display device, steering control, lean control, power output, power input control, warning light system, operating light system, imaging system, tilt adjustment system, acoustic output system, radio transmitter, infrared output, spring rate adjust system, damping rate adjust system, damping travel length adjust system, spring travel length adjust device, visual output device, drive ratio device, drive force control device, drive clutch device, braking system devices, power generation devices, power assist ratio devices, power storage devices, tactile feedback devices, adjustable structural ratio devices, and regenerative braking devices.

11. The control system of claim 1 wherein the conditions sensed include: user or payload mass shift, center of gravity of user or payload shift, velocity shift, terrain control loop shift, suspension control loop shift, pre-programmed baseline shift, angle of inclination of device shift, angle of inclination of the user shift, user contact point to vehicle shift, vehicle frame geometry shift, interactive dynamic function feedback loop shift, weather condition shift, length of operation shift, group or individual use shift, ground surface condition shift, physical training guideline shift, time shift; includes seconds, minutes, hours, day of week, and month, torque load shift, frame load shift, energy output shift, braking energy shift, wheel loading shift; as in cornering, vehicle geometry shift, ride height shift; suspension and/or vehicle geometry change, vibration shift, training program system shift, and light intensity shift; includes day, night, shade, dusk.

12. The invention in claim 1 wherein the control system includes control parameter bias signals from pre-programmed inputs, regional external inputs, user selection inputs, and timer inputs.

13. The invention in claim 1 wherein the control system includes control parameter bias input signals from stored user history data, stored user performance data, and stored route history data.

14. The invention in claim 1 wherein said control system includes a logic circuit.

15. The invention in claim 1 wherein the control system having an input to feed data to control said parameters during vehicle operation for user selectable bias control, for historical data capture, for performance bias, for racing course comparison evaluation, for product evaluation, for game data evaluation, and team training data capture.

16. The invention in claim 1 wherein said control system controls one or more secondary control systems and or logic control circuits directly, indirectly, sequentially, in parallel, or combinations thereof.

17. A method for improving one or more ride characteristics of a vehicle which includes a user and or a payload comprising the steps of:
a) sensing the change in one or more parameters relative to said vehicle,
b) producing output control signals indicative of the change in the parameters; and
c) controlling one or more physical characteristics of said vehicle in response to said output control signals.

18. A method for improving the ride characteristics for a vehicle transporting a user and or a payload comprising the steps of:
a) obtaining from a set of sensors signals denoting the parameters of said user and or payload in relation to said vehicle,
b) determining from said parameter signals a set of estimated parameter shift values in relation to said vehicle,
c) deriving output control signals from said set of parameter value signals, and
d) applying the output control signals to two or more vehicle system controllable functions to affect the ride characteristic of said vehicle.

19. In a wheeled vehicle, having an adjustable structural frame assembly, the improvement comprising:
a plurality of sensors for sensing various conditions affecting the ride characteristics of said wheeled vehicle, and producing signals corresponding thereto, a controller connected to receive said signals and produce control signals for said adjustable structural frame assembly to dynamically adjust the ride characteristics of said wheeled vehicle.

20. The wheeled vehicle of claim 19 wherein the conditions sensed include:
speed of travel, center of gravity of the user and/or payload and mass shift relative to said vehicle, level, up or down terrain, curves, terrain conditions (paved, gravel and/or washboard terrain), weather conditions (wind with or against, sun position).

21. The wheeled vehicle defined in claim 19 wherein said adjustable structural frame assembly includes means controlled by said controller for dynamically adjusting the geometry of said vehicle to adjust the ride characteristics thereof.

22. The wheeled vehicle defined in claim 19 including an adjustable suspension system and means for connecting said adjustable suspension system to said controller to dynamically adjust said adjustable suspension system and the ride characteristics of said vehicle.

23. The wheeled vehicle defined in claim 19 including an adjustable transmission and means for connecting said adjustable transmission to said controller to dynamically adjust said adjustable transmission and the ride characteristics of said vehicle.

24. The adjustable transmission defined in claim 23 wherein the adjustable transmission is adjustable via chain links, gear meshes, toothed belts, rotary shafts, toroidal fluid mechanism, pneumatic, hydraulic, and electrical means or combinations thereof.

25. In a wheeled vehicle, having an adjustable structural frame assembly, adjustable suspension system, the improvement comprising:
a plurality of sensors for sensing various conditions affecting the ride characteristics of said wheeled vehicle, and producing signals corresponding thereto, a controller connected to receive said signals and produce control signals for said adjustable structural frame assembly, and said adjustable suspension system to dynamically adjust the ride characteristics of said wheeled vehicle.

26. The wheeled vehicle of claim 25 wherein the conditions sensed include:
speed of travel, center of gravity of the user and/or payload and mass shift relative to said vehicle, level, up or down terrain, curves, terrain conditions (paved, gravel and/or washboard terrain), weather conditions (wind with or against, sun position).

27. The wheeled vehicle defined in claim 25 wherein said suspension system includes a spring having a dynamically adjustable spring rate and said controller controls said spring rate.

28. The spring defined in claim 27 is comprised of; metallic coil spring, non-metallic coil spring, spring washer stack, rubber, gas cylinder/piston assembly, microcellular urethane, a gas filled rubber bladder, and combinations thereof.

29. The wheeled vehicle defined in claim 25 wherein said suspension system includes a damper having a dynamically adjustable damping rate and said controller dynamically controls the damping rate of said adjustable rate damper.

30. The damper defined in claim 29 is comprised of; gas/fluid cylinder/piston assembly, gas/fluid cylinder/piston assembly with reservoir, gas/fluid cylinder/piston assembly with internal floating piston, gas/fluid cylinder/piston assembly reservoir and internal floating piston, open-bath cylinder assembly, and combinations thereof.

31. The wheeled vehicle defined in claim 25 wherein said suspension system includes a spring having a dynamically adjustable travel length and said controller dynamically controls said spring travel length.

32. The wheeled vehicle defined in claim 25 wherein said suspension system includes a damper having a dynamically adjustable damper length and said controller dynamically controls said damper travel length.

33. The wheeled vehicle defined in claim 25 wherein said suspension system includes a compression rate control having a compression rate control adjusting device dynamically controlled by said controller.

34. The wheeled vehicle defined in claim 25 wherein said suspension system includes a rebound rate control having a rebound rate control adjusting device dynamically controlled by said controller.

35. The wheeled vehicle defined in claim 25 wherein said adjustable structural frame assembly includes means controlled by said controller for dynamically adjusting the geometry of said vehicle to adjust the ride characteristics thereof.

36. The wheeled vehicle defined in claim 25 including an adjustable transmission and means for connecting said adjustable transmission to said controller to dynamically adjust said adjustable transmission and the ride characteristics of said vehicle.

37. In a wheeled vehicle, having an adjustable structural frame assembly, adjustable front and rear suspension systems, the improvement comprising: a plurality of sensors for sensing various conditions affecting the ride characteristics of said wheeled vehicle, and producing signals corresponding thereto, a controller connected to receive said signals and produce control signals for said adjustable structural frame assembly, and said adjustable front and rear suspension systems to dynamically adjust the ride characteristics of said wheeled vehicle.

38. The wheeled vehicle of claim 37 wherein the conditions sensed include:
speed of travel, center of gravity of the user and/or payload and mass shift relative to said vehicle, level, up or down terrain, curves, terrain conditions (paved, gravel and/or washboard terrain), weather conditions (wind with or against, sun position).

39. The wheeled vehicle defined in claim 37 wherein said suspension system includes a spring having a dynamically adjustable spring rate and said controller controls said spring rate.

40. The wheeled vehicle defined in claim 37 wherein said suspension system includes a damper having a dynamically adjustable damping rate and said controller dynamically controls the damping rate of said adjustable rate damper.

41. The wheeled vehicle defined in claim 37 wherein said suspension system includes a compression rate control having a compression rate control adjusting device dynamically controlled by said controller.

42. The wheeled vehicle defined in claim 37 wherein said suspension system includes a rebound rate control having a rebound rate control adjusting device dynamically controlled by said controller.

43. The wheeled vehicle defined in claim 37 wherein said suspension system includes a spring having a dynamically adjustable travel length and said controller dynamically controls said spring travel length.

44. The wheeled vehicle defined in claim 37 wherein said suspension system includes a damper having a dynamically adjustable damper length and said controller dynamically controls said damper travel length.

45. The wheeled vehicle defined in claim 37 wherein said adjustable structural frame assembly includes means controlled by said controller for dynamically adjusting the geometry of said vehicle to adjust the ride characteristics thereof.

46. The wheeled vehicle defined in claim 37 including an adjustable transmission and means for connecting said adjustable transmission to said controller to dynamically adjust said adjustable transmission and the ride characteristics of said vehicle.

47. In a two wheeled vehicle, having an adjustable structural frame assembly, the improvement comprising:
a plurality of sensors for sensing various conditions affecting the ride characteristics of said wheeled vehicle, and producing signals corresponding thereto, a controller connected to receive said signals and produce control signals for said adjustable structural frame assembly to dynamically adjust the ride characteristics of said two wheeled vehicle.

48. The two wheeled vehicle of claim 47 wherein the conditions sensed include:
speed of travel, center of gravity of the user and/or payload and mass shift relative to said vehicle, level, up or down terrain, curves, terrain conditions (paved, gravel and/or washboard terrain), weather conditions (wind with or against, sun position).

49. The two wheeled vehicle defined in claim 47 wherein said adjustable structural frame assembly includes means controlled by said controller for dynamically adjusting the geometry of said vehicle to adjust the ride characteristics thereof.

50. The two wheeled vehicle defined in claim 47 including an adjustable transmission and means for connecting said adjustable transmission to said controller to dynamically adjust said adjustable transmission and the ride characteristics of said vehicle.

51. The two wheeled vehicle defined in claim 47 including an adjustable suspension system and means for connecting said adjustable suspension system to said controller to dynamically adjust said adjustable suspension system and the ride characteristics of said vehicle.

52. In a two wheeled vehicle, having an adjustable structural frame assembly, adjustable front and rear suspension systems, the improvement comprising: a plurality of sensors for sensing various conditions affecting the ride characteristics of said two wheeled vehicle, and producing signals corresponding thereto, a controller connected to receive said signals and produce control signals for said adjustable structural assembly, and said adjustable front and rear suspension systems to dynamically adjust the ride characteristics of said two wheeled vehicle.

53. The two wheeled vehicle of claim 52 wherein the conditions sensed include:
speed of travel, center of gravity of the user and/or payload and mass shift relative to said vehicle, level, up or down terrain, curves, terrain conditions (paved, gravel and/or washboard terrain), weather conditions (wind with or against, sun position).

54. The two wheeled vehicle defined in claim 52 wherein said suspension system includes a spring having a dynamically adjustable spring rate and said controller controls said spring rate.

55. The two wheeled vehicle defined in claim 52 wherein said suspension system includes a damper having a dynamically adjustable damping rate and said controller dynamically controls the damping rate of said adjustable rate damper

56. The two wheeled vehicle defined in claim 52 wherein said suspension system includes a compression rate control having a compression rate control adjusting device dynamically controlled by said controller.

57. The two wheeled vehicle defined in claim 52 wherein said suspension system includes a rebound rate control having a rebound rate control adjusting device dynamically controlled by said controller.

58. The two wheeled vehicle defined in claim 52 wherein said suspension system includes a spring having a dynamically adjustable travel length and said controller dynamically controls said spring travel length.

59. The two wheeled vehicle defined in claim 52 wherein said suspension system includes a damper having a dynamically adjustable damper length and said controller dynamically controls said damper travel length.

60. The two wheeled vehicle defined in claim 52 wherein said adjustable structural frame assembly includes means controlled by said controller for dynamically adjusting the geometry of said vehicle to adjust the ride characteristics thereof.

61. The two wheeled vehicle defined in claim 52 including an adjustable transmission and means for connecting said adjustable transmission to said controller to dynamically adjust said adjustable transmission and the ride characteristics of said vehicle.

62. The two wheeled vehicle defined in claim 52 including means connected to said controller to manually input data into said controller for affecting the ride characteristics of said vehicle.

63. A vehicle for transporting a user and or a payload, said vehicle comprised of two or more dynamic attached function means for operation, said vehicle having a plurality of energy efficiency bandwidth parameter sensing devices for producing signals indicative of the change in said parameter, a control system device responsive to said signals by controlling output signals to said dynamic attached function means for operation to improve one or more ride characteristics of said vehicle.

64. The invention in claim 63 wherein the energy efficiency bandwidth parameter sensed includes:
speed of travel, center of gravity of the user and/or payload and mass shift relative to said vehicle, level, up or down terrain, curves, terrain conditions (paved, gravel and/or washboard terrain), weather conditions (wind with or against, sun position).

65. The invention in claim 63 wherein the dynamic attached function means for operation includes adjustable structural frame assembly, adjustable suspension, and adjustable drive ratio.

66. A vehicle for transporting a user and or a payload, said vehicle comprised of two or more dynamic attached controllable function means for operation, said vehicle having a plurality of parameter sensing devices for producing signals indicative of the change in said parameters, a logic control system device responsive to said signals by controlling output signals to said dynamic attached controllable function means to improve one or more ride characteristics of said vehicle.

67. The invention in claim 66 wherein said logic control system includes a logic circuit powered by the user and or payload to vehicle contact and vehicle to terrain contact forces.
